(19) United States
(12) Patent Application Publication
(10) Pub. No.: US 2013/0201806 A1
(43) Pub. Date: Aug. 8, 2013

(54) INFORMATION RECORDING MEDIUM, INFORMATION RECORDING APPARATUS AND METHOD, AND INFORMATION REPRODUCING APPARATUS AND METHOD

(71) Applicants: Masayoshi Yoshida, Sayama-shi (JP); Hideki Kobayashi, Kawagae-shi (JP); Takuya Shiroto, Yokohama-shi (JP)

(72) Inventors: Masayoshi Yoshida, Sayama-shi (JP); Hideki Kobayashi, Kawagae-shi (JP); Takuya Shiroto, Yokohama-shi (JP)

(73) Assignee: PIONEER CORPORATION, Kanagawa (JP)

(21) Appl. No.: 13/640,593

(22) PCT Filed: Apr. 13, 2010
(86) PCT No.: PCT/JP2010/056625

§ 371 Date: Oct. 22, 2012

(51) Int. Cl. G11B 7/007

(52) U.S. Cl. CPC G11B 7/0079
USPC 369/44.26; 369/275.3

(57) ABSTRACT

An information recording medium adopting a zone CAV method is provided with: a guide layer in which tracks are formed in advance; and a plurality of recording layers laminated on the guide layer. On the tracks, a plurality of guide areas, each of which has a physical structure for carrying guide information for guidance, are arranged discretely at arrangement intervals of predetermined distance or less which is set in advance in a track direction and are shifted between a plurality of tracks throughout the plurality of tracks which are adjacent to each other in a radial direction. On the tracks, moreover, a plurality of specific areas, each of which has a predetermined pattern, are respectively arranged in a same phase from an inner circumference to an outer circumference in the radial direction such that the predetermined pattern can be detected in a state in which tracking servo is open.

### TECHNICAL FIELD

The present invention relates to an information recording medium, such as an optical disc of a multilayer type or multilayer recording type, an information recording apparatus and method for recording information onto the information recording medium, and an information reproducing apparatus and method for reproducing the information from the information recording medium.

### BACKGROUND ART

In this type of information recording medium, a plurality of or multiple recording layers are laminated on a single guide layer in which tracks are formed in advance, and the guide layer is used to perform recording and reproduction in each recording layer (e.g. refer to patent documents 1 to 3).

Specifically, at the time of the recording and the reproduction, a first light beam for tracking (e.g. a guiding light beam or a servo light beam including red laser as in a DVD) is irradiated and focused on the guide layer through the recording layers. This enables the tracking for each recording layer. In other words, this enables focus servo for the guide layer and tracking servo using the tracks formed in advance in the guide layer.

In parallel with such a tracking operation, a second beam for information recording and reproduction in which a positional relation with the first beam is fixed or known (e.g. a main light beam including blue laser as in a Blu-ray) is irradiated typically in a form of concentrically overlapping the first beam by using the same optical pickup or through the same objective lens or in similar manners and is focused on one recording layer which is a recording or reproduction target. This enables the information recording and reproduction in each recording layer. In other words, this enables the focus servo for each recording layer and information writing or reading.

In addition, the recording and the reproduction of this type of information recording medium are performed while so-called “tilt correction” is performed on the optical pickup by a correction mechanism for correcting a disc tilt or simply tilt (typically, a slope or inclination of an optical disc surface). More generally, not only the tilt correction but also various processing, such as eccentricity correction of a disc, inclination correction of a disc surface, aberration correction of an optical system, phase difference correction of a light beam, distortion correction, light absorption correction, and setting of a strategy, are performed while the recording and the reproduction are performed.

### PRIOR ART DOCUMENT

### Patent Document

Patent document 1: Japanese Patent Application Laid Open No. Hei 4-301226
Patent document 2: Japanese Patent Application Laid Open No. 2003-67939
Patent document 3: International Publication WO2009/037773

### DISCLOSURE OF INVENTION

### Subject to be Solved by the Invention

However, in a technology disclosed in the patent documents, if a track pitch is narrowed with respect to a diameter of the first light beam to the extent that the first light beam is simultaneously irradiated on a plurality of tracks adjacent to each other in the guide layer, it is hard to perform a practically accurate tracking pull-in operation or a track jump operation in desired timing to a desired track. Alternatively, even if control information (e.g. servo marks, address information, etc.) is written in the tracks, it is hard to improve the track pitch and a recording linear density (a linear recording density, a pit pitch, or an information transfer rate) which allows the recording or reproduction in the recording layer, to the extent that it can be called “high-density recording”, which is an intended purpose in the information recording medium of the multilayer type.

In particular, if a zone constant angular velocity (CAV) method is adopted, an angular velocity increases in each of zones having different radial direction positions. Therefore, an arrangement relation of control information recorded in tracks in a guide layer, or an arrangement relation of patterns for detecting tilt errors, become arbitrary depending on a radial position.

Moreover, if concentric tracks are adopted, track jumps are particularly frequently performed. Alternatively, even if a spiral track is adopted, the track jumps are also performed, as occasion demands. Thus, it becomes extremely difficult to correspond to a high-density track pitch and a recording linear density for realizing high-density recording, as described above, regardless of the radial position. In other words, if the zone CAV method is adopted in a multilayer type information recording medium, there is such a technical problem that it is practically extremely difficult to perform the tracking servo, and further to accurately perform the track jump on the desired track and to accurately perform tracking servo pull-in, with high accuracy or with high resolution that can correspond to the high-density recording, which is an original purpose of the multilayer type.

Moreover, in particular, in the case of a zone CAV multilayer type optical disc, it is necessary to appropriately change various control in each layer and each zone. Thus, it is extremely important to perform a particular type of processing, such as tilt correction, with respect to each recording layer and each zone, as occasion demands, and particularly to perform the track jump on the desired track and the tracking servo pull-in with high reliability. Furthermore, it is more important to do so for the high-density recording and the high transfer rate.

In view of the aforementioned problems, it is therefore an object of the present invention to provide an information recording medium of a multilayer type which enables high-accuracy tracking servo and a track jump while increasing information recording density, an information recording apparatus and method for recording information onto such an information recording medium, and an information reproducing apparatus and method for reproducing the information from such an information recording medium.

### Means for Solving the Subject

In order to solve the above object, an information recording medium of the present invention is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open.

In order to solve the above object, a first information recording apparatus of the present invention is an information recording apparatus for recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer, and detecting the predetermined pattern and obtaining the carried guide information on the basis of the received first light; a first pull-in controlling device for controlling start or continuation of a pull-in operation of pulling in the tracking servo on the basis of one type of the detected predetermined pattern in the plurality of specific areas in the state in which the tracking servo is open; a second pull-in controlling device for controlling continuation or end of the pull-in operation on the basis of another type of the detected predetermined pattern in the plurality of specific areas in the state in which the tracking servo is open or is being pulled in; a tracking servo device for controlling the light irradiating device to perform the tracking servo on a desired track out of the plurality of tracks on the basis of the obtained guide information; and a data recording control device for controlling the light irradiating device to record the data by irradiating and focusing the second light beam on the one recording layer in a servo-closed state in which the tracking servo is performed.

In order to solve the above object, a second information recording apparatus of the present invention is an information recording apparatus for recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer, and detecting the predetermined pattern and obtaining the carried guide information on the basis of the received first light; a jump controlling device for controlling a track jump associated with the tracks on the basis of one type of the detected predetermined pattern in the plurality of specific areas in a servo-closed state in which the tracking servo is performed; and a data recording control device for controlling the light irradiating device to record the data by searching for a desired position on the plurality of tracks on the basis of the obtained guide information when the track jump is performed and by irradiating and focusing the second light beam on the one recording layer in the servo-closed state.

In order to solve the above object, a first information recording method of the present invention is an information recording method of recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording method recording the data by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer, and detecting the predetermined pattern and obtaining the carried guide information on the basis of the received first light; a first pull-in controlling process of controlling start or continuation of a pull-in operation of pulling in the tracking servo on the basis of one type of the detected predetermined pattern in the plurality of specific areas in the state in which the tracking servo is open; a second pull-in controlling process of controlling continuation or end of the pull-in operation on the basis of another type of the detected predetermined pattern in the plurality of specific areas in the state in which the tracking servo is open or is being pulled in; a tracking servo process of controlling the light irradiating device to perform the tracking servo on a desired track out of the plurality of tracks on the basis of the obtained guide information; and a data recording control process of controlling the light irradiating device to record the data by irradiating and focusing the second light beam on the one recording layer in a servo-closed state in which the tracking servo is performed.

In order to solve the above object, a second information recording method of the present invention is an information recording method of recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording method recording the data by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer, and detecting the predetermined pattern and obtaining the carried guide information on the basis of the received first light; a jump controlling process of controlling a track jump associated with the tracks on the basis of one type of the detected predetermined pattern in the plurality of specific areas in a servo-closed state in which the tracking servo is performed; and a data recording control process of controlling the light irradiating device to record the data by searching for a desired position on the plurality of tracks on the basis of the obtained guide information when the track jump is performed and by irradiating and focusing the second light beam on the one recording layer in the servo-closed state.

In order to solve the above object, a first information reproducing apparatus of the present invention is an information reproducing apparatus for reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer, and detecting the predetermined pattern and obtaining the carried guide information on the basis of the received first light; a first pull-in controlling device for controlling start or continuation of a pull-in operation of pulling in the tracking servo on the basis of one type of the detected predetermined pattern in the plurality of specific areas in the state in which the tracking servo is open; a second pull-in controlling device for controlling continuation or end of the pull-in operation on the basis of another type of the detected predetermined pattern in the plurality of specific areas in the state in which the tracking servo is open or is being pulled in; a tracking servo device for controlling the light irradiating device to perform the tracking servo on a desired track out of the plurality of tracks on the basis of the obtained guide information; and a data obtaining device for receiving second light based on the irradiated and focused second light beam from the one recording layer and obtaining the data on the basis of the received second light in a servo-closed state in which the tracking servo is performed.

In order to solve the above object, a second information reproducing apparatus of the present invention is an information reproducing apparatus for reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer, and detecting the predetermined pattern and obtaining the carried guide information on the basis of the received first light; a jump controlling device for controlling a track jump associated with the tracks on the basis of one type of the detected predetermined pattern in the plurality of specific areas in a servo-closed state in which the tracking servo is performed; and a data obtaining device for searching for a desired position on the plurality of tracks on the basis of the obtained guide information when the track jump is performed, receiving second light based on the irradiated and focused second light beam from the one recording layer, and obtaining the data on the basis of the received second light in the servo-closed state.

In order to solve the above object, a first information reproducing method of the present invention is an information reproducing method of reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing method reproducing the data by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer, and detecting the predetermined pattern and obtaining the carried guide information on the basis of the received first light; a first pull-in controlling process of controlling start or continuation of a pull-in operation of pulling in the tracking servo on the basis of one type of the detected predetermined pattern in the plurality of specific areas in the state in which the tracking servo is open; a second pull-in controlling process of controlling continuation or end of the pull-in operation on the basis of another type of the detected predetermined pattern in the plurality of specific areas in the state in which the tracking servo is open or is being pulled in; a tracking servo process of controlling the light irradiating device to perform the tracking servo on a desired track out of the plurality of tracks on the basis of the obtained guide information; and a data obtaining process of receiving second light based on the irradiated and focused second light beam from the one recording layer and obtaining the data on the basis of the received second light in a servo-closed state in which the tracking servo is performed.

In order to solve the above object, a second information reproducing method of the present invention is an information reproducing method of reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing method reproducing the data by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer, and detecting the predetermined pattern and obtaining the carried guide information on the basis of the received first light; a jump controlling process of controlling a track jump associated with the tracks on the basis of one type of the detected predetermined pattern in the plurality of specific areas in a servo-closed state in which the tracking servo is performed; and a data obtaining process of searching for a desired position on the plurality of tracks on the basis of the obtained guide information when the track jump is performed, receiving second light based on the irradiated and focused second light beam from the one recording layer, and obtaining the data on the basis of the received second light in the servo-closed state.

The operation and other advantages of the present invention will become more apparent from embodiments explained below.

### BRIEF DESCRIPTION OF DRAWINGS

FIG. 1 is a schematic perspective view illustrating a basic configuration of an information recording medium in a first example of the present invention.

FIG. 2 is a partially enlarged cross sectional view schematically illustrating: an objective lens for focusing a first beam for guiding and a second beam for recording (or reproduction); and the information recording medium in the example.

FIG. 3 is a partially enlarged perspective view illustrating a guide layer in the example.

FIG. 4 is a partially enlarged perspective view having the same concept as in FIG. 3 in a comparative example of the example.

FIG. 5 is a partially enlarged perspective view having the same concept as in FIG. 2 in the case of having one example of pre-pits in the example.

FIG. 6 is a partially enlarged perspective view having the same concept as in FIG. 2 in the case of having another example of the pre-pits in the example.

FIG. 7 is a partially enlarged plan view schematically illustrating tracks for low-density recording.

FIG. 8 is a partially enlarged plan view schematically illustrating tracks for high-density recording.

FIG. 9 is a conceptual diagram illustrating a configuration of the tracks with four areas arranged which are provided for the guide layer, and an outline structure in each of the four areas, in the example.

FIG. 10 is a partially enlarged plan view of the guide layer, schematically illustrating one example of a detailed structure of a specific area, which is one of the four areas illustrated in FIG. 9.

FIG. 11 is a schematic entire plan view of the guide layer, illustrating groups of tracks into each of which a plurality of tracks are grouped, center tracks located in the center thereof, and arrangement of the specific area, in the example.

FIG. 12 is a schematic entire plan view of the guide layer, illustrating zones divided in accordance with a zone CAV method, and one example of the arrangement of the specific area, in the example.

FIG. 13 is a schematic entire plan view of the guide layer, illustrating zones divided in accordance with the zone CAV method, and another example of the arrangement of the specific area, in the example.

FIG. 14 is a schematic plan view of the guide layer, illustrating one example of the arrangement of a servo area, a pattern area, and the specific area, which are three of the four areas provided in the guide layer, in the example.

FIG. 15 is a schematic diagram explaining generation and detection principles of a tracking error signal (particularly, a “zero cross signal”), in a relation between a pitch of groove tracks and a light spot.

FIG. 16 is a partially enlarged plan view of the guide layer, schematically illustrating another example of the detailed structure of the specific area, in the example.

FIG. 17 is a partially enlarged plan view of the guide layer, schematically illustrating another example of the detailed structure of the specific area, in the example.

FIG. 18 is a partially enlarged plan view of the guide layer, schematically illustrating another example of the detailed structure of the specific area, in the example.

FIG. 19 is a partially enlarged plan view of the guide layer, schematically illustrating another example of the detailed structure of the specific area, in the example.

FIG. 20 is a conceptual diagram illustrating a pre-format configuration example of a two layer use type in the example.

FIG. 21 is a conceptual view illustrating one configuration example of various data recorded in slots in the example.

FIG. 22 is a conceptual view illustrating another configuration example of various data recorded in the slots in the example.

FIG. 23 is a conceptual view illustrating one example of assignment of data in the slots in the example.

FIG. 24 is a conceptual view illustrating another configuration example of various data recorded in slots (“B Slots”) in the example.

FIG. 25 is a conceptual view illustrating another configuration example of various data recorded in slots (“A Slots”) in the example.

FIG. 26 is a schematic plan view illustrating track jumps performed on the inner circumferential side of concentric tracks TR formed in the guide layer in the example.

FIG. 27 is a schematic plan view illustrating track jumps performed on the outer circumferential side of the concentric tracks TR formed in the guide layer in the example.

FIG. 28 is a schematic plan view illustrating track jumps performed on the inner circumferential side of a spiral track TR formed in the guide layer in the example.

FIG. 29 is a schematic plan view illustrating track jumps performed on the outer circumferential side of the spiral TR formed in the guide layer in the example.

FIG. 30 is a block diagram illustrating an information recording/reproducing apparatus in the example.

FIG. 31 is a block diagram illustrating a configuration of a tilt detection system provided for the information recording/reproducing apparatus in FIG. 30.

FIG. 32 is a timing chart illustrating various signals used in the tilt detection system in FIG. 30.

FIG. 33 is a flowchart illustrating an information recording/reproducing method in the example.

FIG. 34 is a flowchart illustrating a recording method for a new disc in the example.

FIG. 35 is a flowchart illustrating one example of a reproducing method for a new disc in the example.

FIG. 36 is a flowchart illustrating one example of a tracking servo pull-in operation in the example.

FIG. 37 is a flowchart illustrating one example of a track jump operation in the example.

FIG. 38 is a block diagram illustrating a circuit part for performing tracking servo, of the information recording/reproducing apparatus in the example.

FIG. 39 is a characteristic diagram illustrating an operation of sampling a tracking error which is performed by a sampler included in the circuit part illustrated in FIG. 38.

FIG. 40 is a characteristic diagram illustrating phase rotation for defining an arrangement interval of two guide areas which are adjacent to each other along the track in the example.

FIG. 41 is a characteristic diagram illustrating frequency characteristics of a gain in the tracking servo for defining the arrangement interval of the two guide areas which are adjacent to each other along the track in the example.

FIG. 42 is an enlarged plan view schematically illustrating the specific area in one modified example.

FIG. 43 is an enlarged plan view schematically illustrating the specific area in another modified example.

FIG. 44 is an enlarged plan view schematically illustrating the specific area in another modified example.

FIG. 45 is an enlarged plan view schematically illustrating the specific area in another modified example.

FIG. 46 is an enlarged plan view schematically illustrating the specific area in another modified example.

FIG. 47 is a schematic perspective view having the same concept as in FIG. 1 and illustrating an optical disc in another modified example.

### MODE FOR CARRYING OUT THE INVENTION

Hereinafter, as the best mode for carrying out the invention, embodiments associated with a driving apparatus will be explained in order.

### (Information Recording Medium)

<1>

In order to solve the above object, an information recording medium of the present embodiment is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open.

According to the information recording medium in the embodiment, typically, by using the concentric or spiral tracks provided for the guide layer for guidance or tracking, it is possible to optically record information into a desired recording layer out of the plurality of recording layers laminated on or under the guide layer, for example, in the zone constant angular velocity (CAV) method along the tracks. Moreover, by using or without using the tracks for guidance, it is possible to optically reproduce the information from the desired recording layer which is already recorded, for example, in the zone CAV method.

Here, the “guide layer” typically means a layer for guiding or leading to a position in a recording surface of each recording layer (i.e. a position in the radial direction and a position in the track direction along the recording surface) by using a first light beam for guidance or tracking (hereinafter simply referred to as a “first light beam”), at least in information recording or writing into each recording layer. The “guide layer” is typically a layer in which the tracks, which are configured to generate a tracking error signal (or a wobble signal as a basis thereof, a pre-pit signal, or the like), are physically formed in advance.

Moreover, the “tracks” formed in the guide layer mean courses or paths which are tracked or followed by the first light beam. Typically, for example, the tracks are wobbled. In addition to or instead of this, the tracks are physically formed in advance in the guide layer or on the guide layer, as groove tracks or land tracks in which pits are formed. Incidentally, information tracks formed after the recording in the recording layer are clearly distinguished from the “tracks” formed in advance herein, in that the information tracks are established as the arrangement or alignment of information pits recorded in the recording surface which originally does not have any tracks.

At each of positions which will make the information tracks after the recording in the desired recording layer and which correspond to respective positions of the first light beam on the tracks in the guide layer guided as described above, typically, the information recording is performed by a second light beam for information recording or information writing (hereinafter simply referred to as a “second light beam”).

Incidentally, typically, it is enough to provide one guide layer for all the recording layers; however, a plurality of guide layers, such as two layers, may be provided and each of them may be used as occasion demands, or the roles thereof may be divided. In any case, the guide layer and the plurality of recording layers are provided, as layers which are separate from each other.

The plurality of recording layers are configured such that information can be recorded or further reproduced independently in each of the recording layers, such as, for example, 16 layers. Each of the plurality of recording layers preferably has as a simple structure as possible, such as straight grooves or straight lands or a mirror surface, in an unrecorded state. That is because it is preferable in manufacturing that alignment between the plurality of recording layers and alignment between the recording layers and the guide layer are almost or practically completely unnecessary. The structure of the recording layers is configured to perform the recording in various recording methods in which each of transmittance and reflectance in each recording layer is set to be included in a predetermined range, so that the light beam reaches one recording layer on the rear side or the guide layer, viewed from the irradiation side of the light beam.

More specifically, in the information recording, for example, the tracking error signal (or the wobble signal as the basis thereof and additionally the pre-pit signal) can be detected from reflected light obtained when the first light beam (e.g. red laser for forming a light spot with a relatively large diameter) is focused on the tracks which exist in the guide layer. In accordance with the tracking error signal, the tracking or the tracking servo can be performed as one type of a guide operation. The information recording is performed by focusing the second light beam (e.g. blue laser for generating alight spot with a relatively small diameter) on the desired recording layer on the upper layer or lower layer side of the tracks in a state in which the tracking is performed or the tracking servo is closed. In other words, in-plane positioning for the information recording is performed in the desired recording layer which is another layer in which the tracks or the like do not exist (e.g. in a mirror-surface state), on the basis of the positions of the tracks formed in advance in the guide layer. (Incidentally, focus is separately performed in focusing the light.)

Here, if an optical system for irradiating the first and second light beams is fixed in an optical pickup or the like, a positional relation between the light spots formed by the light beams is also fixed. Thus, performing the guide operation, such as the tracking servo, for the position of the first light beam (i.e. the position of the light spot on the tracks formed by the first light beam) means performing the guide operation even for the second light beam (i.e. the position of the light spot in the recording surface formed by the second light beam) with reproducibility. In other words, by using the first light beam on the tracks which exist in advance, it is possible to track or guide the second light beam in the recording surface in which the tracks do not exist in advance.

If such a recording method is adopted, there is almost or practically no need to perform the alignment in a direction along the recording surface between the tracks, between the guide layer and each of the recording layers which are laminated mutually, or between the plurality of recording layers. This is extremely useful in manufacturing.

On the other hand, in the information reproduction, in the same manner, the tracks may be used for guidance. Alternatively, in the information reproduction, the reproduction can be performed by performing the tracking operation on the information tracks after the recording, without using the guide layer for guidance (typically for tracking), by following the information which is already written in the recording layer.

On the tracks formed in the guide layer, there are disposed the plurality of guide areas each of which has the physical structure for carrying the guide information. Here, the “guide information” is information for guiding or leading or following the first light beam, and typically information for optically generating the tracking error signal (or the wobble signal as the basis thereof and additionally the pre-pit signal). Moreover, the guide information can be referred to as “mark information”, since the guide information becomes a mark for positioning the light beam for tracking.

The physical structure for carrying the guide information as described above is typically realized by the arrangement or alignment or the like of pre-pits on a surface without the grooves and lands (e.g. a mirror surface), a wobble and partial-notch structure, and a wobble and pre-pit structure (i.e. land pre-pits, groove pre-pits, etc.) formed on the side walls of or in the inside or outside of the groove tracks or land tracks. Here, the “physical structure” is different from a logical structure, i.e. a conceptual or virtual structure simply established by data, but means a structure which physically exists. The physical structure is already formed on the guide in the completion of the information recording medium.

As a result of studies by the present inventors, it has been found that a special purpose of allowing the guide operation to be performed, such as, for example, performing the tracking in a predetermined band, can be achieved even without continuously forming special mechanisms for detecting the guide information in the track direction, as in tracks of a prior or existing optical disc, even if it is necessary to allow the detection of the guide information in any track. In other words, as long as the arrangement interval (i.e. arrangement pitch) of the guide information corresponding to a time interval at which the guide information is detected is set to be less than a distance minimum required to enable the guide operation (e.g. to be less than or equal to the longest distance that allows the tracking servo to operate in the predetermined band). At the same time, regarding the plurality of tracks which are adjacent to each other, it has been found that the aforementioned purpose can be achieved even if such special mechanisms are not arranged in a respective plurality of positions or areas aligned in the radial direction, i.e. even if such special mechanism area not arranged (or aligned) regularly in one line in the radial direction.

Thus, in the present invention, the plurality of guide areas are mutually arranged discretely at arrangement intervals (i.e. arrangement pitch) of the predetermined distance or less which is set in advance in the track direction along the tracks (in other words, a tangential direction of the tracks) which are spiral or concentric. Here, the “predetermined distance” is typically a distance which is shorter by some margin than the longest distance that allows the function of the guidance or the guide operation, which is the tracking or the tracking operation in the predetermined band (e.g. the longest distance that allows the continuous or continual generation of a tracking signal at a frequency which enables the tracking operation to be performed stably in the predetermined band). Moreover, the “predetermined band” means a band unique to a data format or data standard in which the tracking operation is performed and which is determined by a relation with a band used in the information recording.

The predetermined distance as described above may be set by obtaining a limiting distance in which the guide operation (typically, the tracking operation in the predetermined band) functions and by determining an appropriate margin, with respect to the guide layer of a specific information recording medium, by experiments, experiences, simulations, or the like in advance. If the guide areas are discretely arranged at arrangement intervals (i.e. arrangement pitch) longer than the predetermined distance, then, the tracking error signal cannot be generated at a frequency which allows the stable tracking servo in the predetermined band; namely, the stable guide operation cannot be performed.

Incidentally, “discretely” means that the guide areas are not mutually continuous, viewed planarly on the recording surface of each recording layer and that there are an another planar area between the guide areas, such as the mirror surface, buffer areas, and areas other than the guide areas.

The plurality of guide areas are shifted between the plurality of tracks throughout the plurality of tracks which are adjacent to each other in the radial direction crossing the tracks (i.e. the direction of the radius). Here, the expression of “throughout the plurality of tracks” means throughout or straddling two or more tracks which are adjacent to each other, including areas occupying gaps of the tracks, viewed planarly on the recording surface of each recording layer. Moreover, the expression of “shifted between the plurality of tracks in the radial direction” means that the plurality of tracks are not in the same phase (e.g. angle on a disc), or positions corresponding to the same phase (e.g. angular positions on the disc) in the radial direction (i.e. the direction of the radius), or not on the same radius. At this time, the plurality of guide areas arranged respectively adjacently in the radial direction do not need to be separated completely (i.e. do not need to have gaps therebetween). Typically, it is enough to shift the phase in the radial direction to the extent that the light beam for tracking servo in the information recording or reproduction does not cover the plurality of tracks simultaneously (e.g. throughout five tracks). Alternatively, it is enough to shift the phase to the extent that the signal and information which can be read from the plurality of guide areas by the light beam can be distinguished from each other.

Thus, even if a track density is increased until the spot of the light beam straddles or covers two or more tracks or track portions which are adjacent to each other (e.g. until the spot covers five tracks), as long as the guide areas are shifted as described above in response to the increased track density, it is possible to avoid a situation in which the guide information cannot be detected due to the overlap of the guide information in both the track direction and the radial direction (or due to an influence of a signal component from another guide area as noise), i.e. due to the crosstalk of the detected guide information. As described above, even if the track density is increased, the guidance or the tracking can be performed, and typically, the original function of generating the tracking signal as the guide layer is guaranteed.

Therefore, it is possible to stably and continuously generate the guide information, such as the tracking error signal or the wobble signal as the basis thereof and additionally the pre-pit signal, for example, by sampling a push-pull signal obtained from the reflected light caused by the first light beam or the like, while narrowing the track pitch with respect to the diameter of the first light beam to the extent that the plurality of tracks which are adjacent to each other in the guide layer are simultaneously irradiated with the first light beam. In other words, it is possible to perform the stable guide operation, such as the tracking operation, in the predetermined band. Alternatively, if the guide information includes information for control (e.g. a servo mark, address information, etc.), this can be certainly read as information based on the reflected light caused by the first light beam or the like. In other words, it is possible to stably obtain pre-format information.

This works extremely useful, particularly in cases where the first light beam (e.g. red laser) has a larger beam diameter than that of the second light beam (e.g. blue laser) and in cases where a recording density in the information recording into one recording layer is increased nearly to the limit by effectively using the light spot of the second light beam which is relatively small (i.e. in accordance with the small size). In other words, if narrow-pitch tracks corresponding to a narrow-pitch recording area which will make the tracks after the recording in the recording layer are formed in advance in the guide layer, the light spot of the first light beam, which is naturally larger than such tracks, has a technical characteristic of being simultaneously irradiated throughout the plurality of tracks (e.g. many tracks such as five tracks). Thus, it is necessary to perform the guide operation, such as the tracking operation, corresponding to a narrow-pitch recording layer by using the first light beam for forming the relatively large light spot.

Incidentally, even in cases where the first light beam has a smaller beam diameter than that of the second light beam, or even in cases where their diameters are almost or completely the same, as long as the guide operation is appropriately performed when the diameter of the light beam is larger than the track pitch, the unique configuration of the embodiment as described above provides a proper operational effect.

As described above, regarding the tracks for guidance, the pitch thereof can be set as a narrow pitch (can be set on the same level with a narrow pitch of the information tracks which are suitable for the beam diameter of the second light beam and which are established by the recording in the recording layer) (i.e. a narrow pitch unsuitable for the first light beam) without damaging the guiding function, such as enabling the tracking servo in the predetermined band or reading the pre-format information.

In addition, in particular, since, for example, the zone CAV method is adopted, an angular velocity increases toward a zone, a writing position or a reading position on an inner circumferential side (in other words, the angular velocity decreases toward an outer circumferential side). Thus, for example, an arrangement relation of the guide information recorded in advance in the tracks in the guide layer is arbitrary in accordance with a radial position. For example, it is basically impossible to adopt the arrangement of aligning a particular length of information throughout the plurality of tracks in the radial direction, which is possible in a constant angular velocity (CAV) method. Then, if no measure is taken, for example, in the zone CAV method, the track portion inside the light spot is arbitrary in accordance with the radial position (i.e. even the particular length of information is shifted in the track direction in accordance with the position in the radial direction in any cases) in cases where the first light beam forms the light spot throughout the plurality of tracks, and it is extremely unstable to obtain the guide information in accordance with the radial position.

However, the guide areas are shifted between the plurality of tracks in the radial direction, consciously or positively as described above. Thus, regardless of the position in the radial direction (i.e. regardless of whether to be closer to the inner circumference or the outer circumference), it is possible to stably perform the guide operation, such as the tracking servo, in the predetermined band, in response to a high-density track pitch and a recording linear density for realizing high-density recording. Conversely, if the predetermined distance and the way to shift are defined in advance in accordance with the radial position on the premise that it is, for example, in the zone CAV method, then, there is no problem, for example, even in the zone CAV method.

Moreover, particularly in the embodiment, on the tracks, the plurality of specific areas, each of which has the predetermined pattern, are arranged, separately from the plurality of guide areas as described above. At least one portion of the plurality of specific areas are respectively arranged in the same phase from the inner circumference to the outer circumference in the radial direction such that the predetermined pattern owned by the specific area can be detected in the state in which the tracking servo is open, at least in the recording (or additionally, in the reproduction).

Namely, the “predetermined pattern” means a pattern that can be detected even in the state in which the tracking servo is open, in the condition that the plurality of specific areas are respectively arranged in the same phase from the inner circumference to the outer circumference in the radial direction. The predetermined pattern typically includes a portion provided with the groove track or the land track formed one by one on the plurality of tracks which are adjacent to each other in the radial direction.

In other words, the “predetermined pattern that can be detected even in the state in which the tracking servo is open” is formed in areas whose start positions are substantially aligned in the radial direction and whose end positions are substantially aligned in the radial direction at least in a certain range of area, such as, for example, each zone in the zone CAV. Moreover, one type of pattern (e.g. a first SYNC pattern) of the predetermined pattern is formed in a physical shape, such as marks, pits, or partial grooves whose start positions and end positions are substantially aligned in the radial direction and which are provided in at least one section or more. At the same time, the physical shape is formed in at least one track of adjacent tracks included in the beam diameter of the first light beam determined from λ/NA (i.e. wavelength/numerical aperture). Moreover, another type of pattern (e.g. a second SYNC pattern) having a different length along the track from that of the one type of pattern is formed on the end position side of the areas, in the physical shape in the same manner as the one type of pattern. The predetermined pattern that can be detected even in the state in which the tracking servo is open” typically means such a pattern.

Moreover, “in the same phase” or “being arranged in the same phase” means along the same radius or being arranged along the same radius without spacing out in the track direction. Thus, this in effect includes not only the case of literally being completely on the same radius or being arranged completely in line on the same radius, but also, for example, the case of being arranged with overlap of at least a slight width along the same radius (i.e. a width in the track direction) by a zone unit of the zone CAV, or the case of being arranged with overlap of a certain width, regardless of a slight shift in the track direction. Moreover, the “same phase from the inner circumference to the outer circumference in the radial direction” typically means an entire area from the innermost circumference to the outermost circumference, but may in effect exclude the innermost circumference, the outermost circumference, or some portion in the middle. In other words, it is possible to properly obtain the operation and effects of the present invention of enabling the tracking servo pull-in and the track jump described below, in a portion excluding some portion.

Moreover, regarding the plurality of specific areas, at least in one portion or a body portion thereof (e.g. a body portion 24-2 of a specific area 24 in an example described later), arrangement is performed in the same phase, i.e. on the plurality of tracks which cross the same radius and which are adjacent to each other, typically without skipping any track, as opposed to the case of the plurality of guide areas. In other words, the plurality of specific areas are typically arranged one by one (without skipping any track) on the plurality of tracks in the same phase. As described above, the expression of “being respectively arranged in the same phase” typically means “being arranged one by one on the plurality of tracks which are adjacent to each other in the same phase”.

Here, in general, in order to start, continue, or stop the tracking servo pull-in operation, it is necessary to detect a signal indicating that a light irradiation position (i.e. a writing position or a reading position of an optical pickup) crosses the plurality of tracks (e.g. a “zero cross signal”) even in the state in which the tracking servo is open. Even if the track jump is performed, in the same manner, it is necessary to detect the signal indicative of crossing the tracks. For example, even if it is tried to detect the signal indicative of crossing the tracks in the plurality of guide areas discretely arranged, basically, the signal can be obtained only at a ratio of one to several tracks because the grooves and the lands exist on the same radius at the ratio of one to several tracks (e.g. a ratio of one to seven tracks). In other words, in the arrangement as in the plurality of guide areas arranged with gaps in the radial direction, it is quite hard to perform the tracking servo pull-in operation and the track jump.

In the embodiment, however, the plurality of specific areas, each having the predetermined pattern, are arranged, as described above. Thus, if the predetermined pattern, which occupies at least one portion of the specific areas, is detected by displacing the light irradiation position in the radial direction so as to be displaced along the plurality of specific areas when the tracking servo pull-in is performed in the recording or reproduction of the information recording medium, then, it is possible to start, continue, and stop the tracking servo pull-in operation without any problem. In other words, in the relation with the tracking servo pull-in operation, if one portion of the specific areas is configured such that there is one or less groove or the like included in the beam diameter, then, a sufficient zero cross signal group to perform the servo pull-in operation can be obtained. Alternatively, if the predetermined pattern, which occupies at least one portion of the specific areas, is detected even in the state in which the tracking servo is closed, by displacing the light irradiation position in the radial direction so as to be displaced along the plurality of specific areas when the track jump is performed in the recording or reproduction of the information recording medium, then, it is possible to perform the track jump without any problem. Even in this case, in the relation with the track jump, if one portion of the specific areas is configured such that there is one or less groove or the like included in the beam diameter, then, a sufficient zero cross signal group to perform the track jump can be obtained. On the other hand, after the tracking servo pull-in operation is completed, or after the track jump is performed, or in the state in which the tracking servo remains closed, the tracking may be performed by using the guide areas other than the specific areas, as described above.

As a result, it is possible to improve the track pitch and the recording linear density (e.g. a linear recording density, a pit pitch, or an information transfer rate (i.e. recording linear density×moving speed)) which allow the recording or reproduction in the recording layer to the extent that it can be called the “high-density recording”, which is an intended purpose in the information recording medium of the multilayer type, while performing the tracking servo pull-in operation and the track jump operation by using the specific areas, as occasion demands, and while performing the tracking operation by using the guide areas, as occasion demands.

<2>

In an another aspect of the information recording medium of the present embodiment, the predetermined pattern is physically formed in the guide layer by combining grooves and lands in a predetermined rule.

According to this aspect, the predetermined pattern is disposed in the same phase, as a combination of the grooves and lands in the predetermined rule, at least in one portion of the predetermined pattern. Here, the “predetermined rule” is a rule or regulation set in advance as for the combination of the grooves and the lands, such as, for example, alternately arranging the grooves and the lands with a constant length or a regulated length in the track direction, and may include a rule as for notches, wobbles, and the like. If one portion of the specific areas is configured such that there is one or less groove or the like included in the beam diameter, then, a predetermined zero cross signal group can be obtained.

<3>

In an another aspect of the information recording medium of the present embodiment, the predetermined pattern has at least one of a wobble and pre-pit structure and a wobble and partial notch structure.

By virtue of such a configuration, the predetermined pattern in each of the specific areas has the physical structure including at least one of the wobble and pre-pit structure and the wobble and partial notch structure for carrying the guide information for guidance. Here, the “wobble and pre-pit structure” means a structure in which the wobbles and wobbled groove or land tracks are formed and in which the pre-pits are formed in the grooves or lands. Moreover, the “pre-pits” are convex or concave pits or phase pits formed to have a narrower width than a groove width or land width, on the tracks which are in or on the grooves or on or in the lands. In other words, the pre-pits may be land pre-pits or groove pre-pits.

On the other hand, the “wobble and partial-notch structure” means a structure in which the wobbles and the wobbled groove or land tracks are formed and in which notches equivalent with the groove width or land width are formed in the grooves or lands. There are listed a case where one portion of the land which exists between the adjacent grooves is notched, a case where one portion of the groove which exists between the adjacent lands is notched, and a case of a combination thereof. In other words, the physical structure may be configured to include broad-sense pre-pits which are the partial notches. Moreover, the broad-sense pre-pits may be broad-sense land pre-pits or broad-sense groove pre-pits. Furthermore, in addition to such a structure, the aforementioned narrow-sense pre-pits (i.e. pre-pits without the partial notch structure) can be formed together.

As described above, the tracks are established in advance in the guide layer as the groove tracks or land tracks which are wobbled and in which the pits are formed, or as the groove tracks or land tracks in which one portion of the lands or grooves is notched. Thus, the establishment is relatively easy, and eventually, the guide operation with high reliability and stability becomes possible.

Incidentally, the grooves and the lands which form the predetermined pattern may be at least partially straight grooves and straight lands. Moreover, pits, notches, and the like may be added to the straight grooves and the straight lands. The “straight groove or straight land” means a simple straight groove or a land between the grooves in which wobbles and pits and the like are not formed. Incidentally, the groove and the land are relatively uneven, and either can be concave or convex, as viewed in a direction of irradiating the first and second light beams. For example, a concavity based on a body substrate which constitutes the information recording medium is the groove, and a convexity is the land. In this case, the groove may be convex and the land may be concave, as viewed in the direction of irradiating the first and second light beams. Moreover, the “mirror surface” on which neither the groove tracks nor the land tracks are formed, means a plain surface in which information is not particularly embedded and is a surface with highest optical reflectance in the guide layer.

<4>

In an aspect related to the combination of the groove and the land as described above, the predetermined pattern comprises (i) a first SYNC pattern, (ii) a body portion having a combination of the grooves and the lands according to the predetermined rule, and (iii) a second SYNC pattern which is different from the first SYNC pattern, which are arranged along the track direction.

By virtue of such a configuration, for example, the start of the body portion can be detected in advance by using the first SYNC pattern in the recording or in the reproduction. And by performing this, it is possible to start or continue the tracking servo pull-in operation or the track jump operation, which are the important operations, in the condition that everything is ready, in the body portion. Moreover, for example, the end of the body portion can be detected without a delay by using the second SYNC pattern. And by performing this, it is possible to continue or stop the tracking servo pull-in operation or the track jump operation, which are the important operations, in the condition that everything is ready, in the body portion. Incidentally, preferably, throughout the plurality of specific areas, a plurality of first SYNC patterns are arranged in the same phase, and a plurality of second SYNC patterns are arranged in the same phase.

In addition, the “SYNC (Synchronization) pattern” means a pattern that enables a unique signal waveform to appear at predetermined frequency in the recording or in the reproduction. Each of first and second SYNC signals, which are signals detected in the specific areas, has a unique signal waveform, and the detection thereof thus can be performed, simply and certainly.

<5>

Moreover, in this case, the first SYNC pattern is defined to detect a presence of the body portion in response to detection of the first SYNC pattern, and the second SYNC pattern is defined to detect an end of the body portion in response to detection of the second SYNC pattern.

By virtue of such a configuration, by the detection of the first SYNC pattern which enables the unique signal waveform to appear, it is possible to specify the next arrival of the body portion, i.e. timing to start the detection of the signal generated in crossing the tracks in the body portion (in other words, timing to perform the tracking servo pull-in operation and the track jump operation) or the arrival of the timing. This makes it possible to start the tracking servo pull-in operation and the track jump operation, as occasion demands. Then, after the detection of the signal generated in crossing the tracks in the body portion (in other words, the tracking servo pull-in operation and the track jump operation) is performed continuously to some extent, the end of the body portion is detected by the detection of the second SYNC pattern which enables the unique signal waveform to appear. This makes it possible to stop the tracking servo pull-in operation and the track jump operation, as occasion demands. In this case, there is no problem if the tracking servo pull-in operation and the track jump are completed before the second SYNC signal is detected; however, even if not completed, the end of the specific area can be recognized by detecting the second SYNC signal. Thus, the current operation using the specific area is forcibly terminated, and another option can be performed without a delay, including performing the operation again in the next cycle.

Incidentally, the body portion and the first and second SYNC patterns may be configured such that a specific signal is generated in crossing the tracks, not only in the body portion but also in the predetermined pattern including at least one of the first and second SYNC patterns.

<6>

In another aspect of the information recording medium of the present embodiment, the information recording medium adopts a zone CAV method, and the tracks are concentric or spiral.

According to this aspect, since the zone CAV method is adopted, the track jump is frequently performed, specifically if the concentric tracks are adopted. Alternatively, the track jump is performed, as occasion demands, even if the spiral track is adopted. In the guide layer, however, there are arranged the specific areas having the predetermined pattern described above, and thus, the use of the specific areas enables the start, continuation, and stop of the tracking servo pull-in to be performed without any problem, and enables the track jump operation to be performed without any problem.

<7>

In another aspect of the information recording medium of the present embodiment, each of the plurality of specific areas is disposed at a position corresponding to immediately before a portion in which arrangement of ECCs of data to be recorded into each of said recording layers is aligned in the radial direction.

According to this aspect, the specific area is disposed at the position in the guide layer corresponding to immediately before the portion in which the arrangement of error correction codes (ECCs) of the data to be recorded into the recording layer is aligned in the radial direction, i.e. immediately before the portion regarding the track direction. Thus, in either case of performing the recording from the inner circumference to the outer circumference or from the outer circumference to the inner circumference, a position or timing to perform the track jump can be easily obtained. In the same manner, it is also possible to easily obtain changing timing or a changing position of the tracking servo pull-in operation whose target is the lands or the grooves. Incidentally, the expression of “immediately before” includes both meanings of in front without another area between the specific area and the portion, and in front without an area other than the buffer area and the mirror-surface area between the specific area and the portion (i.e. in front only via the buffer area and the mirror-surface).

<8>

In another aspect of the information recording medium of the present embodiment, the guide information includes at least one of first recording address information directed from an inner circumference to an outer circumference in the track direction, and second recording address information directed from the outer circumference to the inner circumference.

According to this aspect, the first recording address information and the second recording address information are recorded in the guide layer which is a single layer. Alternatively, the first recording address information and the second recording address information are recorded in each of the guide layers which are two layers (or more layers). Then, it is possible to properly and selectively use the recording layers, as a first recording layer in which the recording is performed in accordance with the first address information, and a second recording layer in which the recording is performed in accordance with the second address information. Thus, it becomes efficient or easy to perform the operation of recording information from the inner circumference to the outer circumference in one or more first recording layers, and the operation of recording information from the outer circumference to the inner circumference in one or more second recording layers.

Moreover, the reliability or stability of the recording operation can be increased remarkably by properly using the two types of address information. Thus, it is possible to realize the information recording medium that allows the recording, continuously bidirectionally, or arbitrarily or independently bidirectionally.

In particular, if it is set to perform the recording or reproduction from the inner circumference to the outer circumference in the first layer of the recording layers and to perform the recording or reproduction from the outer circumference to the inner circumference in the second layer of the recording layers, that is extremely useful when the recording or reproduction is performed continuously over the plurality of recording layers, because a time to change the recording or reproduction between the two layers is almost a time to perform a layer jump.

At this time, if the first recording address information is recorded in advance in at least one of two types of slots arranged by a first rule, and if the first recording address information is recorded in advance in at least one of the two types of slots arranged by a second rule which is different from the first rule, it is possible to certainly and stably detect the address information which is necessary at that time point while reducing an influence of the crosstalk.

<9>

In another aspect of the information recording medium of the present embodiment, the tracks are guide tracks for tracking servo, the physical structure allows generation of a signal for the tracking servo which constitutes at least one portion of the guide information, each of the plurality of guide areas is a servo area for generating the signal for the tracking servo,

the predetermined distance is set in advance to a distance in which the tracking servo can operate in a predetermined band, and the plurality of servo areas are arranged such that the plurality of servo areas are shifted between the plurality of tracks so as not to be irradiated with a light beam simultaneously, on the basis of a diameter of the light beam for the tracking servo.

According to this aspect, the guide layer is a layer in which the tracks configured to generate the tracking error signal or the like are formed in order to track the position in the recording surface of each recording layer by using the first light beam, at least in the information recording into each recording layer.

More specifically, in the information recording, it is possible to detect the tracking error signal or the like from the reflected light obtained when the first light beam is focused on the tracks which exist in the guide layer. In accordance with the tracking error signal, the tracking or the tracking servo can be performed as one type of the guide operation.

Here, particularly in the embodiment, the plurality of servo areas are arranged separately from each other within the distance which is set in advance and in which the tracking servo can operate in the predetermined band, in the track direction. In other words, two servo areas in tandem in the track direction are arranged separately within the longest distance that allows the tracking signal to be generated continuously or continually from the servo areas at the frequency which enables the tracking operation to be performed stably in the predetermined band

Moreover, the plurality of servo areas are arranged such that the plurality of servo areas are shifted between the plurality of tracks so as not to be irradiated with the light beam simultaneously, on the basis of the diameter of the first light beam for the tracking servo.

Thus, even if the track density is increased until the spot of the first light beam straddles or covers two or more tracks or track portions which are adjacent to each other, as long as the servo areas are shifted as described above in response to the increased track density, it is possible to avoid a situation in which the tracking error signal cannot be detected due to the overlap of the tracking error signal (or the wobble signal as the basis thereof) in both the track direction and the radial direction (or due to an influence of a tracking error signal component from another servo area as the noise of the crosstalk). In other words, even if the track density is increased, the tracking can be performed, and the original function of generating the tracking signal as the guide layer is guaranteed.

Therefore, it is possible to stably and continuously generate the tracking error signal, for example, by sampling the push-pull signal obtained from the reflected light caused by the first light beam or the like, or by sampling a phase difference signal in differential phase detection (DPD), or by similar actions, while narrowing the track pitch. In other words, it is possible to perform the stable guide operation, such as the tracking operation.

Moreover, the tracking in the state in which the tracking servo is closed is performed stably by using the guide areas, while the tracking servo pull-in operation and the track jump operation in the state in which the tracking servo is open can be performed stably.

Incidentally, in the embodiment, mainly the guide areas may adopt various aspects as described below.

### Embodiment Regarding Signal Detection Area

Preferably in the embodiment, a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks.

According to this aspect, each of the plurality of signal detection areas has the integrated predetermined pattern covering the plurality of track portions, which are adjacent to each other in the radial direction, such that the particular type of pattern signal can be detected in the center track portion. The “center track portion” is a track portion, at least located near the central portion in the radial direction, such as in the central portion, at the center, or on a center line in the radial direction, out of the plurality of track portions which are adjacent to each other in the radial direction in each of the signal detection areas. For example, if the plurality of track portions are odd-numbered, such as three, five, and seven, the track portion in the middle is preferably set as the center track portion.

On the other hand, the track portions other than the center track portion dare to be excluded from a pattern signal detection target, even when the center of a first light spot by the first light beam is thereon. In other words, even if some signal or noise caused by the predetermined pattern can be detected in the track portions other than the center track portion, such a signal or noise is not detected as noise, or is discarded as noise after being detected.

The plurality of signal detection areas are arranged, typically discretely in the track direction, and also discretely in the radial direction. Thus, even if the track density is increased until the spot of the light beam straddles or covers two or more tracks or track portions which are adjacent to each other (e.g. until the spot covers five tracks, seven tracks, and the like), it is possible to avoid a situation in which the pattern signal cannot be detected due to the crosstalk of the patter signal detected.

For example, if the predetermined pattern is formed typically in advance or the predetermined pattern is recorded at an arbitrary time point after starting to use it such that a tilt detection signal, such as a tilt error signal, can be generated as the pattern signal, there is a significant signal change in the pattern signal when a tilt occurs, which is extremely useful in practice.

Specifically, for example, in the case of a tilt in the radial direction, if the predetermined pattern, which is axially symmetrical to the center track as a center line, is formed to be planarly spread in a direction covering the plurality of tracks, it is possible to generate the tilt detection signal which is excellent in sensitivity, for the tilt in the radial direction. Alternatively, in the case of a tilt in the track direction (i.e. a tangential direction), if the predetermined pattern, which is axially symmetrical to a line segment perpendicular to the tracks as the center line, is formed to be planarly spread in the direction covering the plurality of tracks, it is possible to generate the tilt detection signal which is excellent in sensitivity, for the tilt in the track direction. Alternatively, in the case of a tilt in a diagonal direction, if the predetermined pattern, which is axially symmetrical to a line segment diagonally crossing the tracks as the center line, is formed to be planarly spread in the direction covering the plurality of tracks, it is possible to generate the tilt detection signal which is excellent in sensitivity, for the tilt in the diagonal direction.

The predetermined pattern may be configured such that various signals are detected as the pattern signal, such as an eccentricity signal for eccentricity correction of a disc, an inclination signal for inclination correction of a disc surface, an aberration signal for aberration correction of an optical system, a phase difference signal for phase difference correction of a light beam, a distortion signal for distortion correction, a light absorption signal for light absorption correction, and a strategy signal for setting of a strategy, in addition to the tilt detection signal for the tilt correction.

The predetermined pattern is configured by forming a plurality of pits or a plurality of small optically-specific portions in each portion of the plurality of tracks in a planar area having annual circular shape (i.e. a hollow type) or a solid shape (i.e. a filled type) in which an outer ring shape thereof is circular, rectangular, or the like, in a form of covering the plurality of tracks. In other words, the predetermined pattern is composed of a series or group of the plurality of pits, the plurality of small optically-specific portions, and the like.

Here, as a result of the studies by the present inventors, it has been found that a special purpose of enabling a particular type of processing based on the pattern signal, such as, for example, the tilt correction based on the tilt detection signal, can be achieved even without continuously forming the pattern signal, such as the tilt detection signal, on all the tracks, even though it is necessary to allow the detection of the pattern signal, such as the tilt detection signal, in any track. It is rather rare that the particular type of processing is performed, identically and continuously. In other words, it has been found that the above specific purpose can be achieved if the pattern signal, such as the tilt detection signal, is detected in accordance with frequency or a period in which the particular type of processing is performed, for example, if the tilt detection signal is detected once every time the tilt correction is maintained at a constant value (in other words, every period in which the tilt servo is locked).

Thus, on one hand, regarding the plurality of tracks which are adjacent to each other, if the pattern signal is detected every plurality of tracks, it is possible to perform predetermined processing based on the pattern signal, practically completely, almost completely, or properly. On the other hand, regarding an area along the tracks, if the pattern signal is detected at some intervals or at intervals of any phase (e.g. angles on a disc), it is possible to perform the predetermined processing based on the pattern signal, practically completely, almost completely, or properly. After all, practically, it is enough to obtain the pattern signal intermittently on every plurality of tracks, such as, for example, five tracks and seven tracks, in the center track portion which represents the tracks. Moreover, phase positions (e.g. angular positions on the disc) in which the pattern signals are detected may be or may not be aligned or arranged in order.

Thus, in the embodiment, with respect to the signal detection area, an opportunity in which the center of the light spot of the first light beam is on the center track portion is used as a detection opportunity for the pattern signal. The track portions other than the center track portion dare to be excluded from the opportunity to detect the pattern signal even if the center of the light spot by the first light beam is thereon.

This works extremely useful, particularly in cases where the first light beam (e.g. red laser) has a larger beam diameter than that of the second light beam (e.g. blue laser) and in cases where the recording density in the information recording into one recording layer is increased nearly to the limit by effectively using the light spot of the second light beam which is relatively small (i.e. in accordance with the small size). In other words, if the narrow-pitch tracks, corresponding to the narrow-pitch recording area which will become the tracks after the recording in the recording layer, are formed in advance in the guide layer, the light spot of the first light beam, which is naturally larger than such tracks, has a technical characteristic of being simultaneously irradiated throughout the plurality of tracks (e.g. many tracks such as five tracks and seven tracks).

Thus, it is extremely advantageous to detect the integrated predetermined pattern covering the plurality of track portions which are adjacent to each other in the radial direction, by using the first light beam which forms the relatively large light spot. It can be also said that the light spot larger than the track pitch, which easily causes demerits, is effectively used.

Incidentally, even in cases where the first light beam has a smaller beam diameter than that of the second light beam, or even in cases where their diameters are almost or completely the same, as long as the predetermined pattern is detected when the diameter of the light beam is larger than the track pitch, the unique configuration of the embodiment as described above provides a proper operational effect.

As described above, the plurality of signal detection areas, each of which has the predetermined pattern, are arranged in the tracks. Thus, degree of freedom of the arrangement of the particular type of pattern signal, such as the tilt detection signal, remarkably increases. Moreover, the plurality of signal detection areas can be arranged, independently of each other, i.e. discretely. Thus, the arrangement with the degree of freedom is also possible on the entire information recording medium. By providing a plurality of types of pattern signals in association with a particular plurality of types of processing, it is also possible to perform the plurality of types of processing, as occasion demands.

### Embodiment Related to Slots

Preferably in the embodiment, the plurality of guide areas are disposed in partial slots which are not adjacent to each other in the track direction and which are not adjacent to each other throughout the plurality of tracks in the radial direction, out of a plurality of slots. Typically, the plurality of guide areas are disposed in the partial slots, one by one.

Here, the “slot” is a logical section or division or a physical section or division obtained by dividing the track in the track direction. The slots are typically arranged continuously without gaps in the track direction and arranged without gaps in the radial direction or adjacently to each other. The slots, however, may be arranged with slight gaps in at least one of the track direction and the radial direction. In other words, the tracks are established from the arrangement or alignment of the plurality of slots formed to be arranged in the track direction in advance in the guide layer.

Since the guide areas are disposed in the plurality of slots which are not adjacent to each other in the track direction and which are not adjacent to each other throughout the plurality of tracks in the radial direction, it is possible to certainly reduce or eliminate the crosstalk between the guide information which can be detected from the plurality of guide areas. In addition, in the guide layer, it is sufficient to form the grooves, the lands, the pre-pits or the like, in the slots in which the guide areas are disposed, and it is unnecessary to form them continuously in the whole tracks. Moreover, the presence or absence of the slot (e.g. a difference between the slot and the mirror surface) can be distinguished physically and clearly and thus easily detected. This makes it easily possible to stably read the guide information. This is extremely useful in practice.

On the other hand, regarding the plurality of slots in each recording layer, as opposed to the case of the guide layer, individual recording areas for recording content data, user data, and the like may be disposed in all the slots that are continuous in both the track direction and the radial direction. Even any slots in the recording layer can correspond to the slots in which the guide areas are disposed in the guide layer, and thus, the tracking servo in the predetermined band can be performed indirectly to the recording layer. In other words, in the recording layer, the light spot formed by the second light beam allows information to be recorded into all the slots, at high density to the readable limit.

In addition, the plurality of specific areas are disposed in partial slots which are not adjacent to each other in the track direction and which are adjacent to each other throughout the plurality of tracks in the radial direction, out of the plurality of slots. In other words the plurality of specific areas are disposed inside a slot group arranged in the radial direction. Typically, the plurality of specific areas are disposed one by one in the partial slots which make such a slot group.

### (Information Recording Apparatus)

<10>

In order to solve the above object, a first information recording apparatus of the present embodiment is an information recording apparatus for recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer, and detecting the predetermined pattern and obtaining the carried guide information on the basis of the received first light; a first pull-in controlling device for controlling start or continuation of a pull-in operation of pulling in the tracking servo on the basis of one type of the detected predetermined pattern in the plurality of specific areas in the state in which the tracking servo is open; a second pull-in controlling device for controlling continuation or end of the pull-in operation on the basis of another type of the detected predetermined pattern in the plurality of specific areas in the state in which the tracking servo is open or is being pulled in; a tracking servo device for controlling the light irradiating device to perform the tracking servo on a desired track out of the plurality of tracks on the basis of the obtained guide information; and a data recording control device for controlling the light irradiating device to record the data by irradiating and focusing the second light beam on the one recording layer in a servo-closed state in which the tracking servo is performed.

According to the first information recording apparatus in the embodiment, the first light beam is irradiated and focused on the guide layer by the light irradiating device, which is, for example, an optical pickup including two types of semiconductor lasers. The first light beam may be a light beam with a relatively large spot diameter as in the red laser light beam, as described above. In other words, the first light beam may be a light beam with a large light flux which forms a large light spot irradiated throughout the plurality of tracks.

Then, the first light, such as reflected light, scattered light, refracted light, and transmitted light from the guide layer, based on the first light beam is received by a light receiving device. Here, the light receiving device includes, for example, a photodetector or a light receiving element such as a two-division or four-division charged coupled device (CCD), which is formed integrally with the light irradiating device and which shares an optical system such as an objective lens, at least partially. The light receiving device is configured to receive the first light in an optical path which is different from the optical paths for second light and the first and second light beams from the middle, via a prism, a dichroic mirror, a dichroic prism, and the like.

Here, in particular, if the tracking servo is open in an initial state, in the middle of, or before or after searching for a target position, the predetermined pattern owned by the specific areas is detected by the information obtaining device including, for example, a processor, an arithmetic circuit, a logical circuit, etc., on the basis of the first light received by the light receiving device.

Before or after, or in parallel with the detection, the start of the tracking servo pull-in operation is controlled by the first pull-in controlling device on the basis of the one type of the predetermined pattern detected by the information obtaining device (e.g. the first SYNC pattern detected in the state in which the tracking servo is open).

Specifically, the light irradiating device, such as an optical pickup, is displaced in the radial direction as a direction of crossing the tracks, for example, in response to the confirmation of a waveform of the one type of the predetermined pattern, by the tracking servo device, such as, for example, a tracking servo circuit, under the control of the first pull-in controlling device. For example, a tracking control actuator of the light irradiating device is controlled by feedback control or feed-forward control, and the light beam formed by the first light beam is displaced to cross the tracks.

Then, the light irradiating device is displaced in the radial direction to the side closer to a target track (i.e. a track in the guide layer corresponding to a radial position at which the recording is to be performed in the recording layer and which will make a recorded information track after the recording), on the basis of the predetermined pattern detected by the information obtaining device (e.g. the body portion having the combination of the grooves and the lands) in the state in which the tracking servo is open or is being pulled in, as described above. Moreover, the stop of the tracking servo pull-in operation is controlled by the second pull-in controlling device on the basis of the another type of the predetermined pattern detected by the information obtaining device (e.g. the second SYNC pattern detected in the state in which the tracking servo is open).

Specifically, the light irradiating device, such as an optical pickup, is stopped in the radial direction as the direction of crossing the tracks, for example, in response to the confirmation of a waveform of the another type of the predetermined pattern, by the tracking servo device, such as, for example, a tracking servo circuit, under the control of the second pull-in controlling device. For example, the tracking control actuator of the light irradiating device is controlled by feedback control or feed-forward control, and the light beam formed by the first light beam is stopped at a radial position in the vicinity of the target track. In this case, even if the tracking servo pull-in operation cannot be completed, the end of the specific area can be recognized by detecting the second SYNC signal. Thus, the current operation using the specific area is forcibly terminated, and another option can be performed without a delay, including performing the operation again in the next cycle.

Incidentally, the first and second pull-in controlling devices may be established as a single circuit.

As a result of the pull-in operation performed by the first and second pull-in controlling devices, the tracking servo pull-in is performed on the target track.

Then, the guide information carried by the physical structure of each of the guide areas is obtained by the information obtaining device including, for example, a processor, an arithmetic circuit, a logical circuit, etc., on the basis of the first light received by the light receiving device.

Then, the light irradiating device such as, for example, an optical pickup, is controlled by the tracking servo device, such as a tracking servo circuit, to perform the tracking servo in the predetermined band on the tracks or to close the tracking servo, on the basis of the obtained guide information. For example, an actuator for tracking control of the light irradiating device is controlled under feedback-control or feed-forward control, and the light beam formed by the first light beam tracks or follows on the tracks. Particularly at this time, in order to perform the tracking servo in the predetermined band, there is no need to provide the guide areas which allow the guide information to be generated in all the slots along the tracks. In other words, it is enough to arrange the slots including the guide areas, separately in both the track direction and the radial direction, in accordance with the predetermined band.

The second light beam, which is modulated in accordance with the information to be recorded, is irradiated and focused by the light irradiating device under the control by the data recording control device, such as, for example, a processor, in a state in which the tracking servo is performed in the predetermined band or the tracking servo is closed, as described above. The second light beam may be a light beam with a relatively small spot diameter, for example, as in the blue laser light beam as described above, aimed at the high density recording of the information recording. From the viewpoint of realizing high-density record information, the second light beam is desirably a smaller light flux.

Then, in the desired recording layer, the data is sequentially recorded into an area which will make the information tracks corresponding to the tracks in the guide layer. At this time, if the recording of the data into the recording layer is performed by a unit corresponding to the slot, such as an integral multiple of the slot, then, the recording operation becomes simple and stable.

As described above, it is possible to preferably record the information to be recorded, such as, for example, content information and user information, at high density into the recording layer of the information recording medium in the embodiment described above, while performing the tracking servo pull-in on the target track, as occasion demands.

<11>

In order to solve the above object, a second information recording apparatus of the present embodiment is an information recording apparatus for recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer, and detecting the predetermined pattern and obtaining the carried guide information on the basis of the received first light; a jump controlling device for controlling a track jump associated with the tracks on the basis of one type of the detected predetermined pattern in the plurality of specific areas in a servo-closed state in which the tracking servo is performed; and a data recording control device for controlling the light irradiating device to record the data by searching for a desired position on the plurality of tracks on the basis of the obtained guide information when the track jump is performed and by irradiating and focusing the second light beam on the one recording layer in the servo-closed state.

According to the second information recording apparatus in the embodiment, as in the first information recording apparatus described above, the first light beam is irradiated and focused by the light irradiating device, and the first light is received by the light receiving device.

Here, in particular, if the tracking servo is closed in the initial state, in the middle of, or before or after searching for the target position, the predetermined pattern owned by the specific areas is detected by the information obtaining device including, for example, a processor, an arithmetic circuit, a logical circuit, etc., on the basis of the first light received by the light receiving device.

Before or after, or in parallel with the detection, the track jump is controlled by the jump controlling device on the basis of the one type of the predetermined pattern detected by the information obtaining device (e.g. the first SYNC pattern detected in the state in which the tracking servo is not only servo-closed but also open, and the body portion having the combination of the grooves and the lands). At this time, the tracking servo is preferably held.

Specifically, the light irradiating device, such as an optical pickup, is displaced in the radial direction as the direction of crossing the tracks, for example, in response to the confirmation of the waveform of the one type of the predetermined pattern, by the tracking servo device, such as, for example, a tracking servo circuit, under the control of the jump controlling device. For example, the tracking control actuator of the light irradiating device is controlled by feedback control or feed-forward control, and the light beam formed by the first light beam is displaced to cross the tracks. Before or after, or in parallel with the displacement, the number of the tracks crossed is counted from a signal waveform corresponding to the detected predetermined pattern, by which the displacement to the target track is controlled by the jump controlling device.

As a result, the light receiving device performs the track jump in the radial direction so as to approach the target track, and eventually, the stop of the track jump is controlled by the jump controlling device. Specifically, the light irradiating device, such as an optical pickup, is stopped at a radial position in the vicinity of the target track in accordance with (i) the number of the tracks crossed, (ii) a track number of the target track, and (iii) a relation with a track number of the track from which the track jump is started, by the tracking servo device, such as a tracking servo circuit, under the control of the jump controlling device.

As a result of the jump operation performed by the jump controlling device as described above, the tracking servo pull-in can be performed on the target track.

Then, if the track jump is performed as described above, before or after, or in parallel with the track jump operation, the desired position on the plurality of tracks is searched for on the basis of the guide information obtained based on the first light, by the searching device including, for example, a processor, an arithmetic circuit, a logical circuit, etc. provided for the data recording control device. In other words, the target track is searched for. Moreover, in this case, at the searched desired position, as in the first information recording apparatus described above, the guide information is obtained by the information obtaining device, and the light irradiating device is controlled, for example, such that the tracking servo is performed or that the tracking servo is closed by the tracking servo device. Moreover, under the control of the data recording control device, the second light beam is irradiated and focused by the light irradiating device, and the data is sequentially recorded.

Alternatively, if the track jump is not performed, as in the first information recording apparatus described above, the guide information is obtained by the information obtaining device, and the light irradiating device is controlled, for example, such that the tracking servo is performed or the tracking servo is closed by the tracking servo device. Moreover, under the control of the data recording control device, the second light beam is irradiated and focused by the light irradiating device, and the data is sequentially recorded. Incidentally, the expression of “if the track jump is not performed” means a case where the track jump is not performed in the state in which the tracking servo is closed, and includes the current case where the track jump is performed before the tracking servo is closed.

As described above, it is possible to preferably record the information to be recorded, such as, for example, content information and user information, at high density into the recording layer of the information recording medium in the embodiment described above, while performing the track jump on the target track, as occasion demands.

### (Information Recording Method)

<12>

In order to solve the above object, a first information recording method of the present embodiment is an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording method recording the data by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer, and detecting the predetermined pattern and obtaining the carried guide information on the basis of the received first light; a first pull-in controlling process of controlling start or continuation of a pull-in operation of pulling in the tracking servo on the basis of one type of the detected predetermined pattern in the plurality of specific areas in the state in which the tracking servo is open; a second pull-in controlling process of controlling continuation or end of the pull-in operation on the basis of another type of the detected predetermined pattern in the plurality of specific areas in the state in which the tracking servo is open or is being pulled in; a tracking servo process of controlling the light irradiating device to perform the tracking servo on a desired track out of the plurality of tracks on the basis of the obtained guide information; and a data recording control process of controlling the light irradiating device to record the data by irradiating and focusing the second light beam on the one recording layer in a servo-closed state in which the tracking servo is performed.

According to the first information recording method in the embodiment, it acts in the same manner as in the first information recording apparatus in the embodiment described above, and eventually, it is possible to preferably record the information to be recorded, such as the content information and the user information, at high density into the recording layer of the information recording medium in the embodiment described above, while performing the tracking servo pull-in, as occasion demands.

<13>

In order to solve the above object, a second information recording method of the present embodiment is an information recording method of recording data onto an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information recording method recording the data by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer, and detecting the predetermined pattern and obtaining the carried guide information on the basis of the received first light; a jump controlling process of controlling a track jump associated with the tracks on the basis of one type of the detected predetermined pattern in the plurality of specific areas in a servo-closed state in which the tracking servo is performed; and a data recording control process of controlling the light irradiating device to record the data by searching for a desired position on the plurality of tracks on the basis of the obtained guide information when the track jump is performed and by irradiating and focusing the second light beam on the one recording layer in the servo-closed state.

According to the second information recording method in the embodiment, it acts in the same manner as in the second information recording apparatus in the embodiment described above, and eventually, it is possible to preferably record the information to be recorded, such as the content information and the user information, at high density into the recording layer of the information recording medium in the embodiment described above, while performing the track jump, as occasion demands.

### (Information Reproducing Apparatus)

<14>

In order to solve the above object, a first information reproducing apparatus of the present embodiment is an information reproducing apparatus for reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer, and detecting the predetermined pattern and obtaining the carried guide information on the basis of the received first light; a first pull-in controlling device for controlling start or continuation of a pull-in operation of pulling in the tracking servo on the basis of one type of the detected predetermined pattern in the plurality of specific areas in the state in which the tracking servo is open; a second pull-in controlling device for controlling continuation or end of the pull-in operation on the basis of another type of the detected predetermined pattern in the plurality of specific areas in the state in which the tracking servo is open or is being pulled in; a tracking servo device for controlling the light irradiating device to perform the tracking servo on a desired track out of the plurality of tracks on the basis of the obtained guide information; and a data obtaining device for receiving second light based on the irradiated and focused second light beam from the one recording layer and obtaining the data on the basis of the received second light in a servo-closed state in which the tracking servo is performed.

According to the first information reproducing apparatus in the embodiment, the first light beam is irradiated and focused on the guide layer by the light irradiating device.

Then, the first light based on the first light beam is received by the light receiving device.

Here, in particular, if the tracking servo is open, the predetermined pattern owned by the specific areas is detected by the information obtaining device on the basis of the first light received by the light receiving device.

Before or after, or in parallel with the detection, the start of the tracking servo pull-in operation is controlled by the first pull-in controlling device on the basis of the one type of the predetermined pattern detected by the information obtaining device.

Then, the light irradiating device is displaced in the radial direction to the side closer to the target track, on the basis of the predetermined pattern detected by the information obtaining device, in the state in which the tracking servo is open or is being pulled in. Moreover, the stop of the tracking servo pull-in operation is controlled by the second pull-in controlling device, on the basis of the another type of the predetermined pattern detected by the information obtaining device.

As a result of the pull-in operation performed by the first and second pull-in controlling devices, the tracking servo pull-in is performed on the target track.

Then, the guide information carried by the physical structure of each of the guide areas is obtained by the information obtaining device on the basis of the first light received by the light receiving device.

Then, the light irradiating device is controlled by the tracking servo device to perform the tracking servo in the predetermined band on the tracks or to close the tracking servo, on the basis of the obtained guide information.

The second light beam is irradiated and focused on the desired recording layer by the light irradiating device under the control by the data obtaining device, such as, for example, a processor, in a state in which the tracking servo is performed in the predetermined band or the tracking servo is closed as described above.

Then, in the desired recording layer, the recorded data is reproduced.

As described above, it is possible to reproduce the recorded information, such as, for example, the content information and the user information, at high density preferably from the recording layer of the information recording medium in the embodiment described above, while performing the tracking servo pull-in, as occasion demands.

Incidentally, it is also possible to reproduce the information from the information tracks while performing the tracking on the information tracks which are established as the arrangement or alignment of the recorded information, by using only the second light beam, without using the tracking by the guide layer, i.e. without using the first light beam. In other words, it is also possible to establish the information reproducing apparatus so as to properly use the light beam in accordance with a distinction between the recording and the reproduction, such as using only the second light beam in the information reproduction and using both the first and second light beams in the information recording. In the information reproduction, only the second light beam is used, and the reproduction can be thus performed with relatively low power consumption and simple control (i.e. in comparison with the case of using the first light beam in the reproduction). In particular, it is extremely useful in practice if the information reproducing apparatus is realized as an “information recording/reproducing apparatus” having a recording function of properly using the light beam between the information recording and the information reproduction.

<15>

In order to solve the above object, a second information reproducing apparatus of the present embodiment is an information reproducing apparatus for reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer, and detecting the predetermined pattern and obtaining the carried guide information on the basis of the received first light; a jump controlling device for controlling a track jump associated with the tracks on the basis of one type of the detected predetermined pattern in the plurality of specific areas in a servo-closed state in which the tracking servo is performed; and a data obtaining device for searching for a desired position on the plurality of tracks on the basis of the obtained guide information when the track jump is performed, receiving second light based on the irradiated and focused second light beam from the one recording layer, and obtaining the data on the basis of the received second light in the servo-closed state.

According to the second information reproducing apparatus in the embodiment, as in the first information reproducing apparatus described above, the first light beam is irradiated and focused by the light irradiating device, and the first light is received by the light receiving device.

Here, in particular, if the tracking servo is servo-closed, the predetermined pattern owned by the specific areas is detected by the information obtaining device on the basis of the first light received by the light receiving device.

Before or after, or in parallel with the detection, the track jump is controlled by the jump controlling device on the basis of the one type of the predetermined pattern detected by the information obtaining device.

As a result, the track jump is performed in the radial direction such that the light irradiating device approaches the target track, and eventually, the stop of the track jump is controlled by the jump controlling device. Moreover, in the state in which the tracking servo is performed in a predetermined band or in the state in which the tracking servo is closed, as described above, the second light beam is irradiated and focused on the desired recording layer by the light irradiating device, and the recorded information is reproduced from the desired recording layer.

As described above, it is possible to preferably reproduce the recorded information, such as the content information and the user information, at high density from the recording layer of the information recording medium in the embodiment described above, while performing the track jump, as occasion demands.

Incidentally, it is also possible to reproduce the information from the information tracks while performing the tracking on the information tracks which are established as the arrangement or alignment of the recorded information, by using only the second light beam, without using the tracking by the guide layer, i.e. without using the first light beam.

### (Information Reproducing Method)

<16>

In order to solve the above object, a first information reproducing method of the present embodiment is an information reproducing method of reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing method reproducing the data by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer, and detecting the predetermined pattern and obtaining the carried guide information on the basis of the received first light; a first pull-in controlling process of controlling start or continuation of a pull-in operation of pulling in the tracking servo on the basis of one type of the detected predetermined pattern in the plurality of specific areas in the state in which the tracking servo is open; a second pull-in controlling process of controlling continuation or end of the pull-in operation on the basis of another type of the detected predetermined pattern in the plurality of specific areas in the state in which the tracking servo is open or is being pulled in; a tracking servo process of controlling the light irradiating device to perform the tracking servo on a desired track out of the plurality of tracks on the basis of the obtained guide information; and a data obtaining process of receiving second light based on the irradiated and focused second light beam from the one recording layer and obtaining the data on the basis of the received second light in a servo-closed state in which the tracking servo is performed.

According to the first information reproducing method in the embodiment, it acts in the same manner as in the first information reproducing apparatus in the embodiment described above, and eventually, it is possible to preferably reproduce the recorded information, such as the content information and the user information, at high density from the recording layer of the information recording medium in the embodiment described above, while performing the tracking servo pull-in, as occasion demands.

<17>

In order to solve the above object, a second information reproducing method of the present embodiment is an information reproducing method of reproducing data from an information recording medium, the information recording medium is provided with: a guide layer in which concentric or spiral tracks are formed in advance; and a plurality of recording layers laminated on the guide layer, wherein on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open, the information reproducing method reproducing the data by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer, and detecting the predetermined pattern and obtaining the carried guide information on the basis of the received first light; a jump controlling process of controlling a track jump associated with the tracks on the basis of one type of the detected predetermined pattern in the plurality of specific areas in a servo-closed state in which the tracking servo is performed; and a data obtaining process of searching for a desired position on the plurality of tracks on the basis of the obtained guide information when the track jump is performed, receiving second light based on the irradiated and focused second light beam from the one recording layer, and obtaining the data on the basis of the received second light in the servo-closed state.

According to the second information reproducing method in the embodiment, it acts in the same manner as in the second information reproducing apparatus in the embodiment described above, and eventually, it is possible to preferably reproduce the recorded information, such as the content information and the user information, at high density from the recording layer of the information recording medium in the embodiment described above, while performing the track jump, as occasion demands.

The operation and other advantages in the embodiments will become more apparent from an example explained below.

As explained above, according to the information recording medium in the embodiment, it is provided with: the guide layer; and the plurality of recording layers, and the plurality of guide areas and the plurality of specific areas are disposed on the tracks. Thus, it is possible to improve the track pitch and the recording linear density which allow the recording or reproduction in the recording layer while performing the tracking servo pull-in and the track jump, as occasion demands.

According to the first information recording apparatus in the embodiment, it is provided with: the light irradiating device; the information obtaining device; the first and second pull-in controlling devices; the tracking servo device; and the data recording control device. According to the first information recording method in the embodiment, it is provided with: the information obtaining process; the first and second pull-in controlling processes; the tracking servo process; and the data recording control process. Thus, it is possible to preferably record the information to be recorded, such as the content information and the user information, at high density into the recording layer of the information recording medium in the embodiment described above, while performing the tracking servo pull-in, as occasion demands.

According to the second information recording apparatus in the embodiment, it is provided with: the light irradiating device; the information obtaining device; the jump controlling device; and the data recording control device. According to the second information recording method in the embodiment, it is provided with: the information obtaining process; the jump controlling process; and the data recording control process. Thus, it is possible to preferably record the information to be recorded, such as the content information and the user information, at high density into the recording layer of the information recording medium in the embodiment described above, while performing the track jump, as occasion demands.

According to the first information reproducing apparatus in the embodiment, it is provided with: the light irradiating device; the information obtaining device; the first and second pull-in controlling devices; the tracking servo device; and the data obtaining device. According to the first information reproducing method in the embodiment, it is provided with: the information obtaining process; the first and second pull-in controlling processes; the tracking servo process; and the data obtaining process. Thus, it is possible to preferably reproduce the recorded information at high density from the recording layer of the information recording medium in the embodiment described above, while performing the tracking servo pull-in, as occasion demands.

According to the second information reproducing apparatus in the embodiment, it is provided with: the light irradiating device; the information obtaining device; the jump controlling device; and the data obtaining device. According to the second information reproducing method in the embodiment, it is provided with: the information obtaining process; the jump controlling process; and the data obtaining process. Thus, it is possible to preferably reproduce the recorded information at high density from the recording layer of the information recording medium in the embodiment described above, while performing the track jump, as occasion demands.

### EXAMPLES

Hereinafter with reference to the drawings, various examples of the present invention will be explained. Incidentally, hereinafter, an explanation will be given to an example in which the information recording medium of the present invention is applied to an optical disc of a multilayer recording type.

### Example of Information Recording Medium

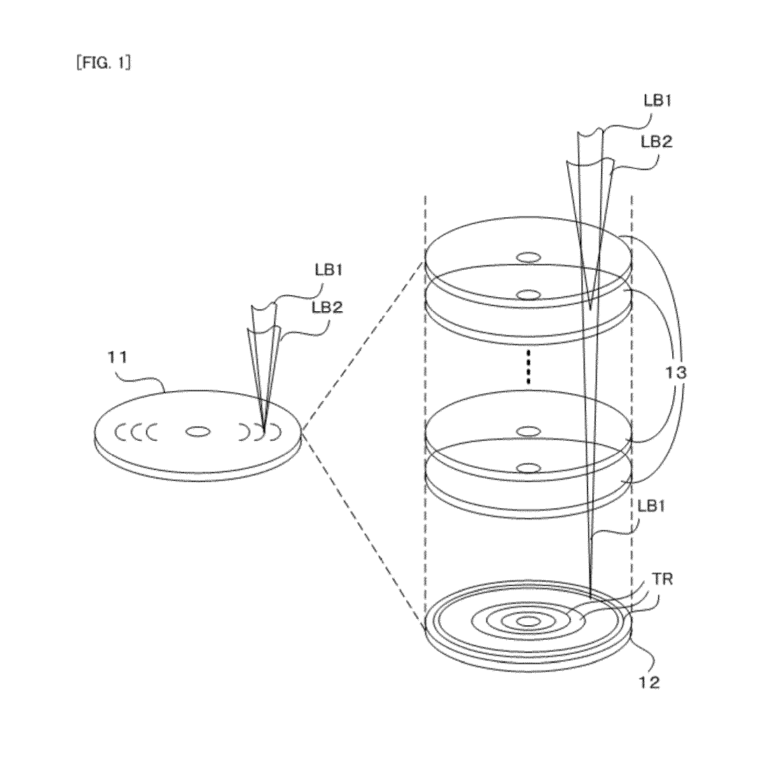

Firstly, with reference to FIG. 1 to FIG. 29, an explanation will be given to an example of the optical disc of a multilayer recording type as one example of the information recording medium of the present invention.

Firstly, with reference to FIG. 1 to FIG. 8, a basic configuration (mainly a physical structure) and a basic principle of an optical disc 11 in the example will be explained.

In FIG. 1, the optical disc 11 is of a multilayer recording layer type and is provided with a single guide layer 12 and a plurality of recording layers 13. FIG. 1 is a schematic perspective view in which visualization of each layer is facilitated by spacing out a plurality of layers which constitute one optical disc illustrated in the left half of the drawing, in their lamination direction (a vertical direction in FIG. 1) in the right half of the drawing.

The optical disc 11 is irradiated simultaneously with a first beam LB1 for tracking servo as one example of the “first light beam” of the present invention and a second beam LB2 for information recording as one example of the “second light beam” of the present invention, in recording. In reproduction, the optical disc 11 is irradiated simultaneously with the first beam LB1 and the second beam LB2 for information reproduction. Incidentally, in the information reproduction, the second beam LB2 can be also used as a single light beam for the tracking servo and for the information reproduction (i.e. the first beam LB1 is not used).

The optical disc 11 adopts the zone CAV method, and a tracking error signal (or a wobble signal as a basis thereof), address information (or a pre-pit signal as a basis thereof), and the like, which are recorded in advance in concentric tracks or a spiral track TR and which are detected in the information recording or reproduction, are arranged along the tracks in accordance with the zone CAV method. In FIG. 1, as illustrated in the right half of FIG. 1, the first beam LB1 is tracking-controlled to be focused on the guide layer 12 and to follow the tracks TR (i.e. guide tracks).

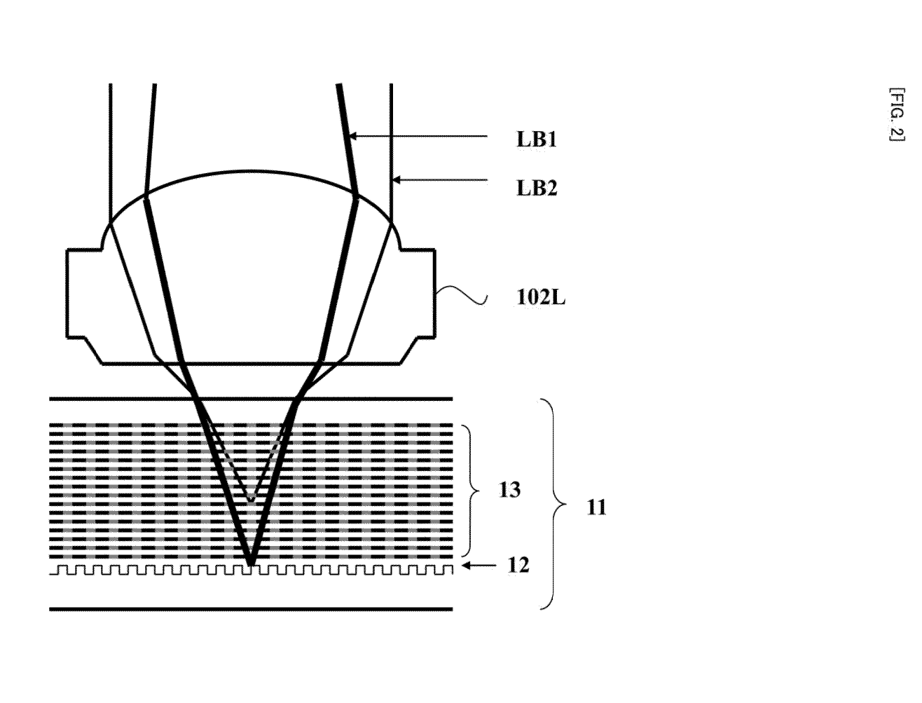

As illustrated in FIG. 2, the second beam LB2 is focused on one desired recording layer 13 which is a recording target or a reproduction target, out of the plurality of recording layers 13 laminated on the guide layer 12. The second beam LB2 is a blue laser beam with a relatively small diameter, for example, as in a Blu-ray (BR) disc. As opposed to this, the first beam LB1 is a red laser beam with a relatively large diameter, for example, as in a DVD. The diameter of a light spot formed by the first beam LB1 is, for example, several times as large as the diameter of a light spot formed by the second beam LB2.

The plurality of recording layers 13 are configured such that information can be optically recorded or further reproduced independently in each of the recording layers 13, such as, for example, 16 layers. More specifically, each of the plurality of recording layers 13 is made of a semitransparent thin film including a two-photon absorption material. For example, as the two-photon absorption material, it is possible to adopt a fluorescent type using a fluorescent material in which fluorescent intensity changes in an area in which two-photon absorption occurs, a refractive-index change type using a photorefractive material in which a refractive index changes due to electron localization, and the like. As the two-photon absorption material of the refractive-index change type, the use of a photochromic compound, a bis(alkylidene)cycloalkanone, or the like is highly expected.

As an optical disc structure using the two-photon absorption material, there are (i) a bulk type in which the entire optical disc 11 is made of the two-photon absorption material and (ii) a layered structure type in which the recording layers 13 made of the two-photon absorption material and spacer layers made of another transparent material are alternately laminated. The layered structure type has the advantage that focus servo control can be performed by using light reflected on an interface between one recording layer 13 and the spacer layer. The bulk type has the advantage that it has less multilayer film formation processes and production costs can be kept low.

As the material of the recording layers 13, there may be listed a material which reacts to at least one of intensity and wavelength of the second beam LB2, which allows the recording by changing optical properties, such as a refractive index, transmittance, absorptivity, and reflectance, and which is stable. For example, a translucent or semitransparent photoresponse material, such as a photopolymer which allows a photopolymerization reaction, an optical anisotropic material, a photorefractive material, a hole burning material, and a photochromic material which absorbs light to change an absorption spectrum can be listed. For example, as the recording layers 13, a phase-change material, the two-photon absorption material, and the like are used, each of which reacts to the second beam LB2 with a wavelength of λ2 but does not react to the first beam LB1 with λ1 (λ2<λ1).

Each of the plurality of recording layers 13 may be made of, for example, a dye material, in addition to the two-photon absorption material and the phase-change material described above. In each of the plurality of recording layers 13, the track TR is not formed in advance in an unrecorded state, and for example, the entire area is a mirror surface or a smooth plane.

The optical disc 11 having the plurality of recording layers 13 laminated on the guide layer 12 is irradiated with the first beam LB1 and the second beam LB2 having different diameters and focal depths, in a condition that the first beam LB1 and the second beam LB2 are almost coaxial or practically completely coaxial, via a common objective lens 102L provided for an optical pickup, at least in the information recording.

In FIG. 1 and FIG. 2, a tracking operation related to the second beam LB2 is performed indirectly by a tracking operation for the tracks TR of the guide layer 12 performed by the first beam LB1 (because there is no track on the recording layers 13 particularly in the recording). In other words, the first beam LB1 and the second beam LB2 are irradiated via a common optical system such as the objective lens 102L (in other words, an optical system in which a positional relation between the irradiated light beams is fixed). Thus, the positioning of the first beam LB1 in the surface of the optical disc 11 can be used as the positioning of the second beam LB2 in the surface of the optical disc 12 (i.e. in the recording surface of each recording layer 13) as it is.

On the tracks TR of the guide layer 12, a plurality of servo areas are arranged, each of which has a physical structure for carrying the tracking error signal (or a signal for generating a tracking error, such as the wobble signal as the basis thereof) and the pre-pit signal. Here, the tracking error signal and the pre-pit signal constitute one example of the “guide information for guidance” according to the present invention. The plurality of servo areas constitute one example of the “plurality of guide areas” according to the present invention.

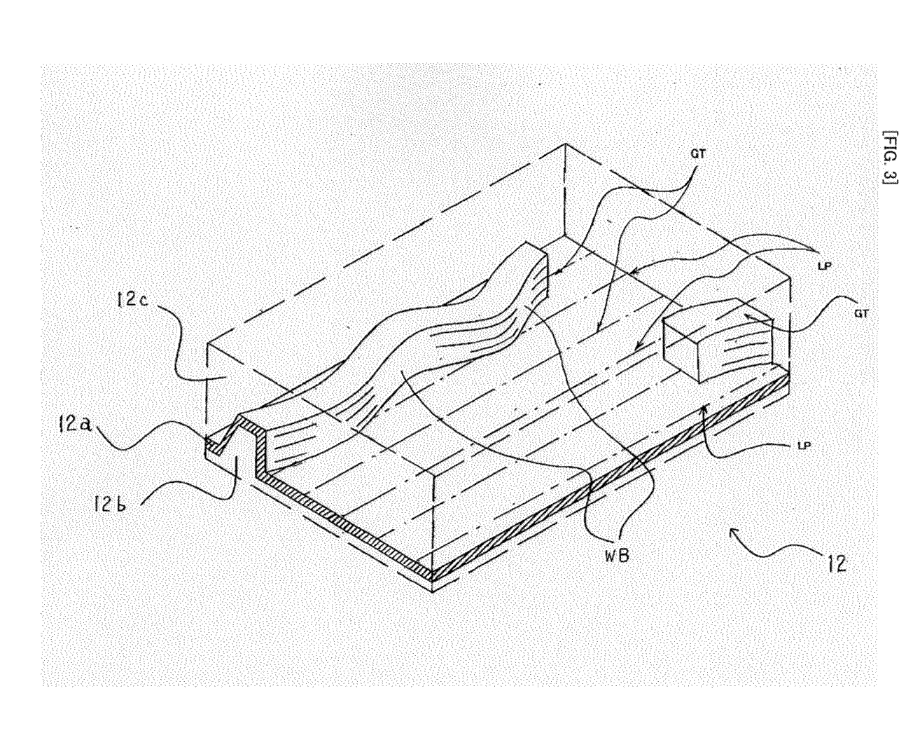

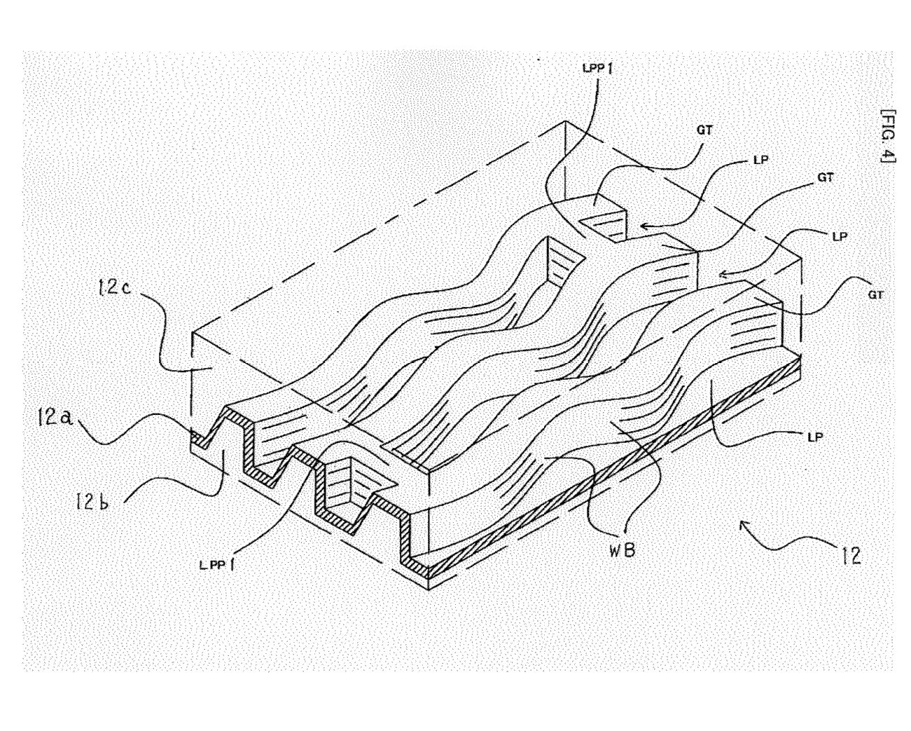

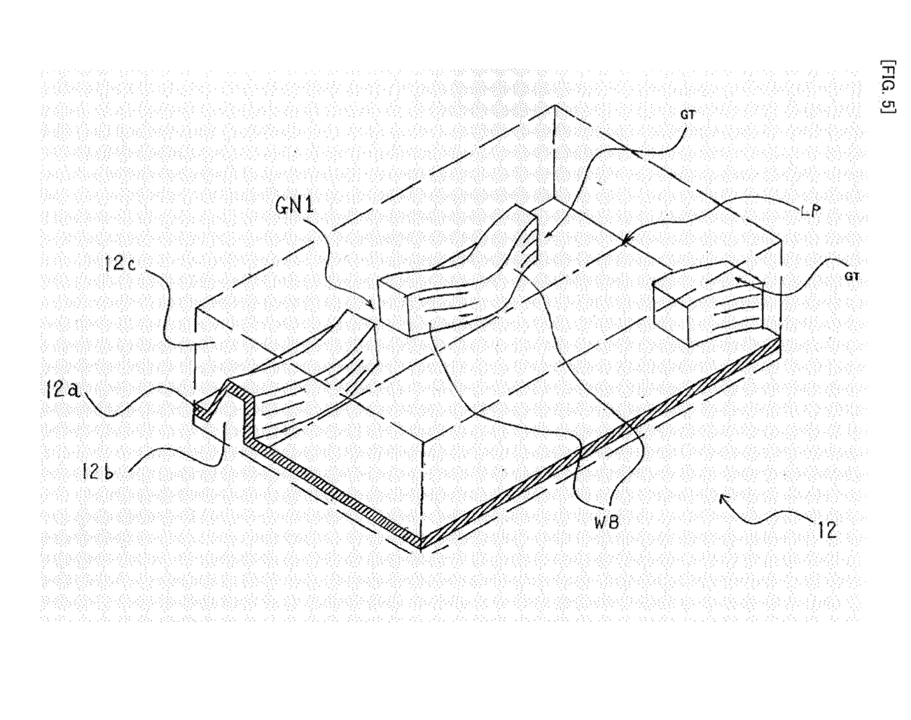

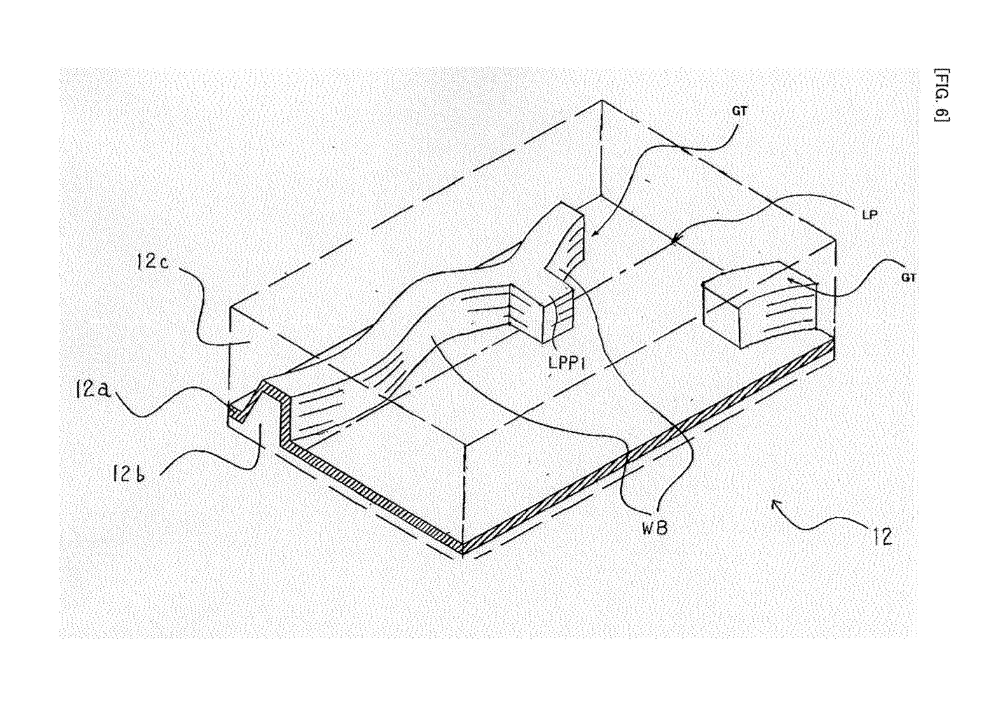

Now, with reference to FIG. 3 to FIG. 6, the physical structure of the guide layer 12 will be described in detail. Each of FIG. 3 to FIG. 6 enlarges an extracted track portion which is subject to wobbling in the guide layer 12. In particular, FIG. 3 illustrates a track portion which is simply subject to the wobbling in the example. FIG. 4 illustrates a track portion of the guide layer 12 in a comparative example in which grooves and lands or the like are formed without gaps throughout the entire area of each track. FIG. 5 illustrates a track portion which has a “wobble and partial-notch structure” in the example and which is subject to the wobbling. FIG. 6 illustrates a track portion which has a “wobble and narrowly defined land pre-pit” in the example and which is subject to the wobbling.

As illustrated in FIG. 3, in the guide layer 12, groove tracks GT corresponding to a specific example of the tracks TR in FIG. 1 are formed. The groove tracks GT are formed by that a reflective film 12a, which is a thin film made of, for example, a photorefractive material, is formed on a transparent film 12c as a base material with uneven grooves formed and is further buried under a transparent or opaque film 12b as a protective film. In the sense of the grooves formed in the transparent film 12c as the base material positioned on the upper side in FIG. 3, the groove tracks GT or grooves are formed in a convex shape toward the upper side in FIG. 3. Alternatively, on the other hand, the groove tracks GT are formed by that the reflective film 12a is formed on the transparent or opaque film 12b as the base material with the uneven grooves formed and is further buried under the film 12c as the protective film.

The groove tracks GT have wobbles WB on the side walls thereof. In other words, the groove tracks GT are formed such that the side walls thereof wobble in a track direction.

In FIG. 3, the grooves are provided only locally. Each of the groove tracks GT, illustrated by an alternate long and short dash line, is positioned at a track pitch corresponding to a track pitch of recorded information tracks constructed from record information owned by each recording layer 13 (refer to FIG. 1) after the recording. Here, a series of the record information on the recording layer 13 along the tracks TR, which is already recorded along the tracks TR of the guide layer 12, is hereinafter simply referred to as “recorded information tracks”, as occasion demands. The information recorded tracks can be said, physically, to be a series of portions along the tracks TR of the guide layer 12, such as a portion in which the fluorescent intensity changes, a portion in which the refractive index changes, a phase-change portion, and a dye-change portion, which is formed on the recording surface of the recording layer 13 by the irradiation of the second beam LB2 in the recording. In other words, even in the groove tracks GT having no grooves formed in FIG. 3, the grooves are formed at a frequency which allows the tracking error to occur at a predetermined frequency. In other words, at a radial position and a track-direction position which are not illustrated in FIG. 3, the grooves are appropriately formed on the groove tracks GT, and basically, there is no groove track GT that has no grooves formed throughout one cycle.

In FIG. 4, in the comparative example, grooves and lands are formed throughout the entire area in the track direction and in the radial direction at the track pitch corresponding to the track pitch of the recorded information tracks constructed from the record information owned by each recording layer 13 (refer to FIG. 1) after the recording. In the typical DVD, BR disc, or the like, the groove tracks GT are configured as in the comparative example in FIG. 4 even in the guide layer, because the recording layer also serves as the guide layer or because the recorded information tracks in the recording layer correspond to the guide tracks in the guide layer in a one-to-one manner.

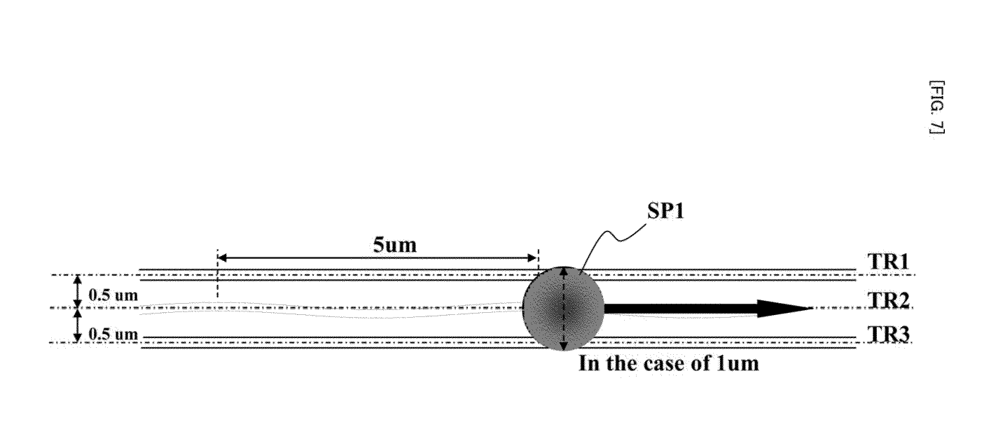

In contrast, in the specific example in FIG. 3, the grooves are not formed throughout the entire area in the track direction on the groove tracks GT. The grooves are not formed on the groove tracks GT which are adjacent to each other in the radial direction either. The quantitative explanation of such arrangement (more specifically, an arrangement interval in the track direction and the radial direction) and an operational effect due to the arrangement will be detailed later with reference to FIG. 7 to FIG. 21.

Incidentally, as illustrated in FIG. 5, groove notches GN1 having a partial-notch structure may be formed in the groove tracks provided in the guide layer 12. The notch is a mirror surface cut throughout one track width of the groove track.

Alternatively, as illustrated in FIG. 6, land pre-pits LPP1 may be formed in land parts LP. Incidentally, even in the comparative example in FIG. 4, the land pre-pits LPP1 are formed. The groove notches GN1 in FIG. 5 and LPP1 in FIG. 6 oppositely appear but have the same effect in reproducing the guide layer.

In addition, in FIG. 6, even in the land parts LP in which there are no pre-pits formed, the pre-pits may be formed as occasion demands.

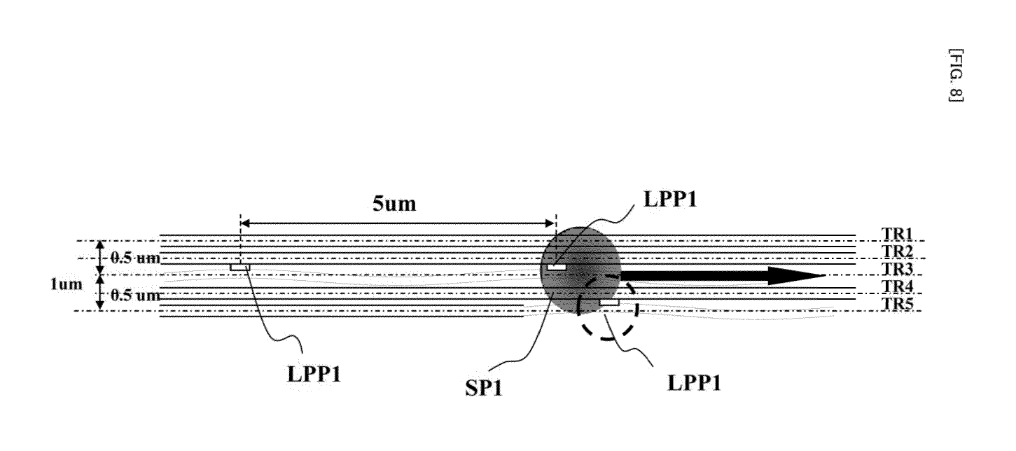

Now, with reference to FIG. 7 and FIG. 8, consideration is given to points to be noted in establishing the tracks TR having the physical structure in which the tracks TR of the guide layer 12 carry the tracking error signal (or the wobble signal as the basis thereof), as described above.

As illustrated in FIG. 7, it is assumed that low-density tracking is performed in which a light spot SP1 is not relatively large with respect to the track pitch. In this case, the light spot SP1 is about 1 μm in diameter (with respect to a track pitch of 0.5 μm) and has little or practically no influence as noise of signals on tracks TR1 and TR3 other than a track TR2 on which the light spot SP1 is focused and which is followed. In other words, even if the groove structure and the wobble structure (refer to FIG. 3), and further, the partial-notch structure (refer to FIG. 5) and the pre-pit structure (refer to FIG. 6) are provided for all the tracks TR1, TR2, TR3, and so on, without gaps in the radial direction and the track direction thereof, the crosstalk does not occur in the tracking error signal (or the wobble signal as the basis thereof). Thus, the tracking can be performed.

As illustrated in FIG. 8, as opposed to this, it is assumed that high-density tracking is performed in which the light spot SP1 is relatively large with respect to the track pitch. In this case, the light spot SP1 is about 1 μm in diameter (with respect to a track pitch of 0.25 μm) and has a significant influence as noise of signals on tracks TR1, TR2, TR4, and TR5 other than the track TR3 on which the light spot SP1 is focused and which is followed. In other words, if the groove structure, the wobble structure, and the like (refer to FIG. 3 to FIG. 6) are provided for all the tracks TR1, TR2, TR3, and so on, without gaps in the radial direction and the track direction thereof, the crosstalk significantly occurs in the tracking error signal. Thus, the tracking cannot be performed.

In particular, in the case of the zone CAV method as in the example, as opposed to the case of the CAV method, an address positional relation (an address difference) on the plurality of adjacent tracks TR changes depending on the radial position. Thus, even if the tracking is possible in one place, there is a significant possibility that the tracking is impossible in another place (i.e. in a position in which the degree of an approach of other signal generation areas is high, where the signal generation areas are adjacent in the radial direction).

The same is true in cases where the land pre-pits LPP1 adjacently exist, as illustrated in FIG. 8. In other words, with respect to the land pre-pits LPP1 provided on the track TR3 which is a tracking target, the pre-pit signal (i.e. a land pre-pit signal) recorded in the land per-pit signal LPP1 surrounded by a dashed line and provided in another track TR5 functions as noise. As a result, the land pre-pit LPP1 cannot be detected at any position, or the land pre-pit LPP1 cannot be detected at some radial-direction position or track-direction position. In other words, the address information or the like by the pre-pit signal cannot be detected. As described above, arrangement is required for reducing the crosstalk not only on the adjacent tracks but also on tracks which are separated by two tracks or more.

The situation as illustrated in FIG. 8 occurs naturally in cases where the first beam LB1 corresponding to the low-density recording (e.g. red laser as in the DVD) is used for the guide layer 12, the second beam LB2 corresponding to the high-density recording (e.g. blue laser as in the BR disc) is used for the recording layer 13 and the narrow-pitch tracks TR is formed in advance in the guide layer 12 such that the information recorded tracks have a narrow pitch after the recording. In other words, it can be said that this is a technical restriction which occurs naturally in cases where the first beam LB1 is used for the guide layer and the second beam LB2, which has a smaller diameter than that of the first beam, is used for the recording layer 13. If the tracks TR with a pitch corresponding to the first light beam LB1 are formed in the guide layer 12, the tracks TR are useless for performing the tracking for the high-density recording in the recording layer 13.

However, the special purpose of performing the tracking in a predetermined frequency band can be achieved without forming the wobble structure for detecting the tracking error signal and the pre-pit structure (refer to FIG. 3 to FIG. 6), on the tracks TR continuously in the track direction, even if it is necessary to generate the tracking error signal in any timing on any track TR. In other words, in the case of an arrangement interval (i.e. arrangement pitch) which is less than or equal to the longest distance that allows the tracking servo to operate in the predetermined frequency band, the wobble structure and the like (refer to FIG. 3 to FIG. 6) for generating the tracking error signal are not required to be formed in the entire area in the track direction on the tracks TR. Moreover, in terms of the plurality of tracks TR which are adjacent to each other, it is not necessary to align the wobble structure for generating the tracking error, in each of positions aligned in the radial direction (i.e. the same phase, or positions or areas providing the same phase, in other words, the same angle, or positions or areas providing the same angle on the optical disc 11) in order to achieve the special purpose.

In addition, for the special purpose of detecting not only the tracking error signal but also another control information for recording control or reproduction control, such as the address information by using the pre-pits such as the land pre-pits LPP1, it is not necessary to form the wobble structure, the pre-pit structure and the like (refer to FIG. 3 to FIG. 6) in the entire area in the track direction on the tracks TR. For example, even if some information is not recorded everywhere in the track direction and the radial direction in advance as if an unrecorded track were filled with stuffing bits, the control information can be detected.

Thus, in the example, in particular, in order to achieve the special purpose of enabling mainly the tracking, the plurality of servo areas are provided on the tracks TR, discretely, in both the track direction and the radial direction, as explained below.

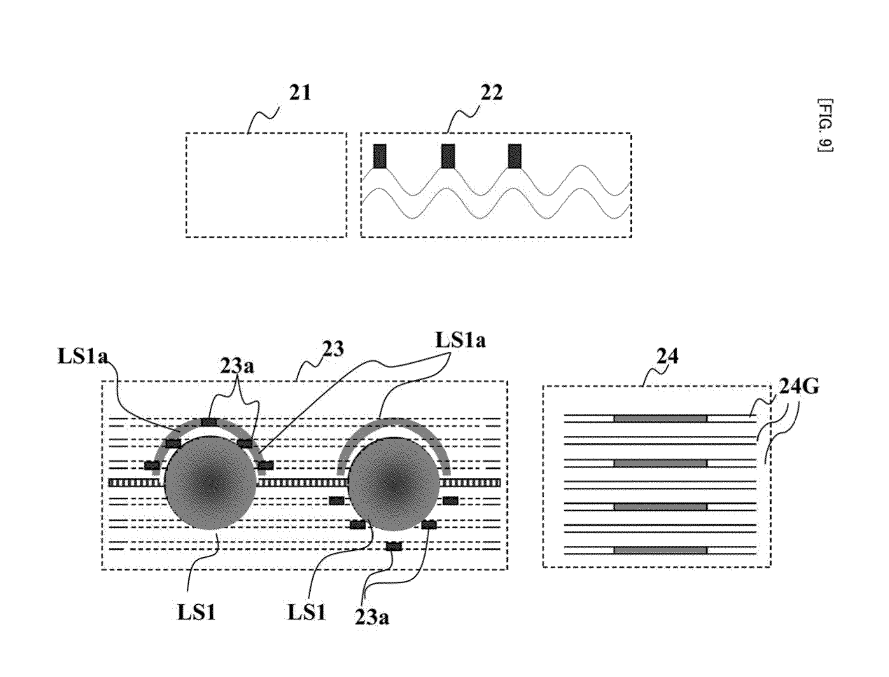

Next, with reference to FIG. 9 to FIG. 13, the physical configuration of four areas, which are a mirror-surface area 21, a servo area 22, a pattern area 23 as an “area 3”, and a specific area 24, in the guide layer 12 will be explained in detail.

As illustrated in FIG. 9, the mirror-surface areas 21 as an “area 1”, the servo area 22 as an “area 2” which is used as a “mark area” in which mark information for a detection pattern can be generated, the pattern area 23 as the “area 3” having a predetermined pattern 23a which allows a tilt detection signal to be generated, and the specific area 24 as an “area 4” having on tracks 24G a predetermined pattern which can be detected even in a state in which the tracking servo is open are disposed in the guide layer 12. Incidentally, FIG. 9 illustrates the four areas in two sections for convenience of explanation; however, the four areas may be arranged in line along the same track on the guide layer 12 in some cases.

Here, the mirror-surface area 21 may have a straight groove or a straight land formed. In this case, the mirror-surface area 21 can be referred to as a “groove area”. Alternatively, since the mirror-surface area 21 has a buffering function in reading the other servo area 22 and the other pattern area 23, the mirror-surface area 21 can be referred to as a “buffer area”. In this case, the mirror-surface area 21 is one example of the “buffer area” of the present invention.

In FIG. 9, the mirror-surface area 21, which is one example of the “buffer area” of the present invention, is, for example, an area having the straight groove. The mirror-surface area 21 is adjacently disposed in front of a head portion and behind a tail portion of each of a plurality of servo areas 22 in the track direction.

By the buffer function of the mirror-surface area 21, a preparation period for the detection of a signal from the servo area 22 is given in a servo system in the information recording or the like. In particular, the first beam LB1 can be moved into the servo area 22 in a tracking-on state in the information recording. In other words, the mirror-surface area 21 disposed on the head side of the servo area 22 gives an extremely effective preparation period to stably operate the tracking servo.

The servo area 22 is an area in which the wobble structure and the pre-pit structure are formed in advance, as illustrated in FIG. 3 to FIG. 6, i.e. an area in which the tracking error signal and the pre-pit signal can be detected. The servo areas 22 are mutually arranged discretely at arrangement intervals (i.e. arrangement pitch) of predetermined distance which is set in advance or distance that is less than the predetermined distance in the track direction (a horizontal direction in FIG. 9). Moreover, the plurality of servo areas 22 are disposed throughout the plurality of tracks TR which are adjacent to each other in the radial direction (i.e. a vertical direction in FIG. 9), such that the plurality of servo areas 22 are positively or actively shifted in the horizontal direction (i.e. in the track direction) between the plurality of tracks TR.

The mark information is disposed immediately before the pattern area 23 on a center track 23TR and indicates that the pattern area 23 is located immediately thereafter. Thus, in the recording or reproduction, if the mark information is firstly detected in the servo area 22, it is found that a pattern signal of the pattern area 23 will arrive later without a delay. Alternatively, the mark information indicates timing to sample the pattern area 23 located thereafter, or an address position of the pattern area 23 located thereafter directed from the inner circumference to the outer circumference, or from the outer circumference to the inner circumference, in the track direction, on the center track 23TR. Thus, in the recording or reproduction, if the mark information is firstly detected in the servo area 22, it is found in which timing or at which address position the pattern signal will arrive.

If the first light beam is not on the integrated one center track composed of a plurality of tracks, the wobble signal detected by using a push-pull signal is detected with offset in the pattern area 23. Thus, it can be recognized whether or not the first light beam is on the center track 23TR.

The pattern area 23, which is one example of the “signal detection area” of the present invention, has an integrated predetermined patterns 23a which covers seven tracks adjacent to each other in the radial direction (in the vertical direction in FIG. 9) such that a particular type of pattern signal can be detected, on the center track 23TR (the track illustrated by an alternate long and short dash line extending in the horizontal line in FIG. 9).

On the other hand, the track portion other than the center track 23TR dares to be excluded from a pattern signal detection target even when the center of a first light spot LS1 by the first light beam is directly on the track portion.

The pattern areas 23 are discretely arranged in the track direction (in the horizontal direction in FIG. 9) and are discretely arranged in the radial direction (in the vertical direction in FIG. 9). Thus, even if a track density is increased until the spot of the light beam covers the mutually adjacent seven tracks, it is possible to avoid a situation in which the pattern signal cannot be detected due to the crosstalk of the detected pattern signal.

As the pattern signal, the predetermined pattern 23a is prepared in advance such that the tilt detection signal, such as a tilt error signal, can be generated. Thus, a significant signal change in the tilt detection signal can be obtained when the tilt occurs.

The predetermined pattern 23a is formed of shortly notched grooves or lands which are locally concavo-convex, or short pits or embosses formed in groove tracks or land tracks, or a plurality of pieces of embossed pits. For example, if covering the seven tracks, the predetermined pattern 23a is provided with a set of five embossed pits on either side, i.e. a set of 10 embossed pits on both sides in total, or the like. The predetermined pattern 23a is formed to substantially fit an outer rim shape of the light spot LS1 and has a shape which is substantially along a bright ring LS1a if the bright ring LS1a is generated. The predetermined pattern 23a may be combined with the wobbles.

Incidentally, the predetermined pattern 23a in the pattern area 23 may be configured such that various signals are detected as the pattern signal, such as an eccentricity signal for eccentricity correction of a disc, an inclination signal for inclination correction of a disc surface, an aberration signal for aberration correction of an optical system, a phase difference signal for phase difference correction of a light beam, a distortion signal for distortion correction, a light absorption signal for light absorption correction, and a strategy signal for setting of a strategy, in addition to the tilt detection signal.

Here, a particular purpose of enabling tilt correction based on the tilt detection signal can be achieved without forming the tilt detection signal continuously on all the tracks TR, even though there is a need to make it possible to detect the tilt detection signal on any of the tracks TR. In other words, the particular purpose can be achieved if the tilt detection signal is detected in accordance with frequency or a period to perform the tilt correction, such as the tilt detection signal being detected once in each period in which tilt servo is locked.

Thus, on one hand, if the tilt detection signal can be obtained on every seven tracks in one GR, the tilt correction can be performed. On the other hand, in the case of an area along the track TR, if the tilt detection signal can be obtained at some intervals or at any phase (e.g. angles on a disc), the tilt correction can be performed. After all, it is enough to obtain the tilt detection signal intermittently on every seven tracks in one GR on the center track 23TR which represents the seven tracks.

In the example, the fact that the first beam LB1 (e.g. red laser) has a larger beam diameter than that of the second beam LB2 (e.g. blue laser) is extremely advantageous to detect the group of predetermined patterns 23a which covers the seven tracks TR which constitute one group GR, by using the first beam LB1.

In the pattern area 23 having the tilt detection pattern as described above, arrangement with degree of freedom is possible. In addition, by providing a pattern signal other than the tilt detection signal in response to processing other than the tilt correction, it is also possible to perform other processing in parallel with the tilt correction or as occasion demands.

Moreover, in the example, in particular, the servo area 22 carrying the mark information, which indicates that the pattern area 23 is located thereafter, is disposed in front of the pattern area 23 on the center track 23TR in the track direction. The mark information is information reproduced by using the wobble signal and the pre-pit signal or the like corresponding to the wobbles and the pre-pits or the like which are discretely formed in the servo area 22.

Thus, the tilt detection signal can be read, easily and certainly, on the basis of the arrival of the mark information. For example, it is possible to start preparation for starting to detect the tilt detection signal after the detection of the mark information, or further preparation for starting the tilt correction based on the tilt detection signal. For example, by defining in advance a phase relation and an interval between the tilt detection signal and the mark information, it is possible to easily specify sampling timing to detect the tilt detection signal from the mark information. Alternatively, by providing the mark information with the address position at which the tilt detection signal is recorded, it is possible to easily specify the sampling timing to detect the tilt detection signal.

The specific area 24 is disposed in the same phase from the inner circumference to the outer circumference in the radial direction such that a predetermined pattern of the specific area 24 can be detected in the state in which the tracking servo is open, in the recording or reproduction of the optical disc 11.

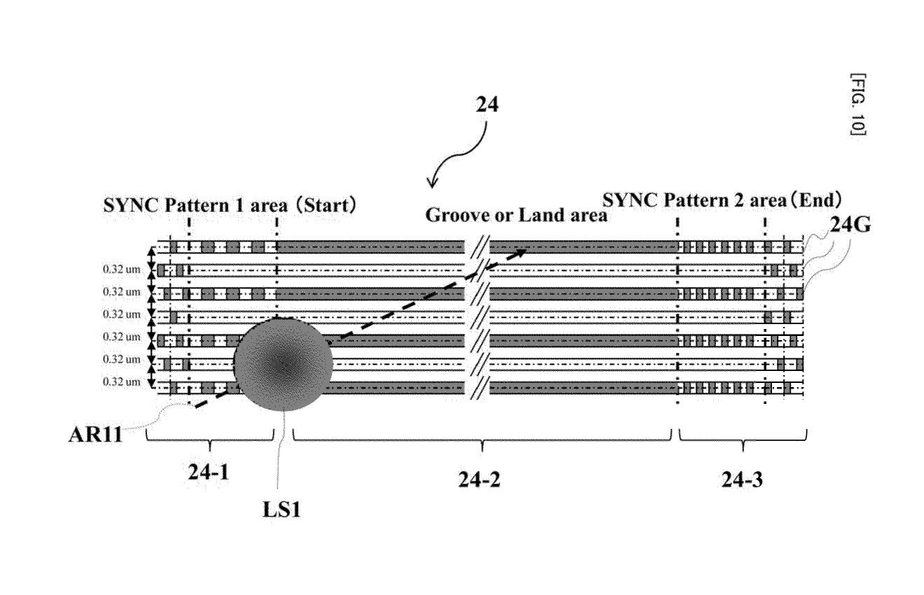

As illustrated in FIG. 10, the specific area 24 is physically formed in the guide layer 12 by combining the grooves and the lands in a predetermined rule on the groove tracks 24G. The specific area 24 includes (i) a first SYNC pattern area 24-1 having a first SYNC pattern as one example of the “one type” of the predetermined pattern, (ii) a body area 24-2 in which one example of the “body portion” of the predetermined pattern is disposed, and (iii) a second SYNC pattern area 24-3 having a second SYNC pattern as one example of the “another type” of the predetermined pattern, which are arranged in the track direction (a horizontal direction in FIG. 10).

Each of the first and second SYNC patterns has at least one of the wobble and pre-pit structure, and the wobble and partial-notch structure (refer to FIG. 3 to FIG. 6), has a unique pattern which can be distinguished from each other, and has mutually different lengths in the track direction. The body portion of the predetermined pattern has a combination in which the straight grooves or the straight lands are alternately simply arranged.

As detailed later, the pattern in the specific area 24 can be detected in the state in which the tracking servo is open in the recording or reproduction; however, the pattern can be also detected even in a state in which the tracking servo is servo-closed. The detection of the pattern in the open state enables a tracking servo pull-in operation to be preferably performed. The detection of the pattern in the servo-closed state enables a track jump operation to be more preferably performed.

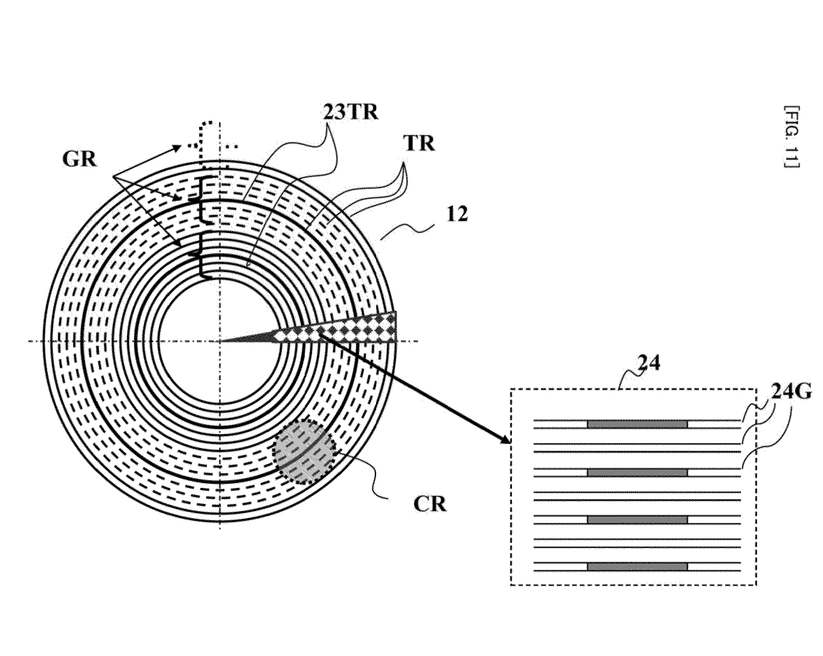

As illustrated in FIG. 11, the concentric or spiral tracks TR including the four areas on the guide layer 12 as described above are grouped in units of a plurality of groups GR, and the track located in the center of each group is determined to be the center track 23TR. On the basis of the position of the center track 23TR determined in this manner, in particular, the predetermined pattern of the pattern area 23 is determined. Moreover, the specific area 24 is disposed in the same phase (in a long, narrow fan-shaped area extending from the center to the right side of the disc in FIG. 11). The specific area 24 is an area including the plurality of groove tracks 24G adjacent to each other.

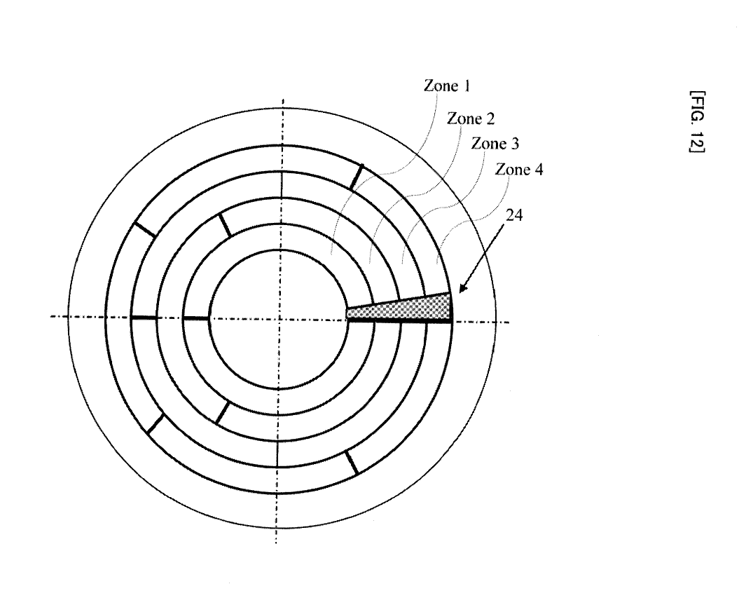

As illustrated in FIG. 12, in one example of the guide layer 12, a track-formed surface on the guide layer 12 on which the concentric or spiral tracks TR are formed as configured above is divided in accordance with the zone CAV method. In other words, long and narrow areas along circumferences in substantially the same radial positions are assigned as a zone 1, a zone 2, a zone 3, and so on. The specific area 24 is disposed to cover or connect to the zone 1 and the other zones which are adjacent to each other.

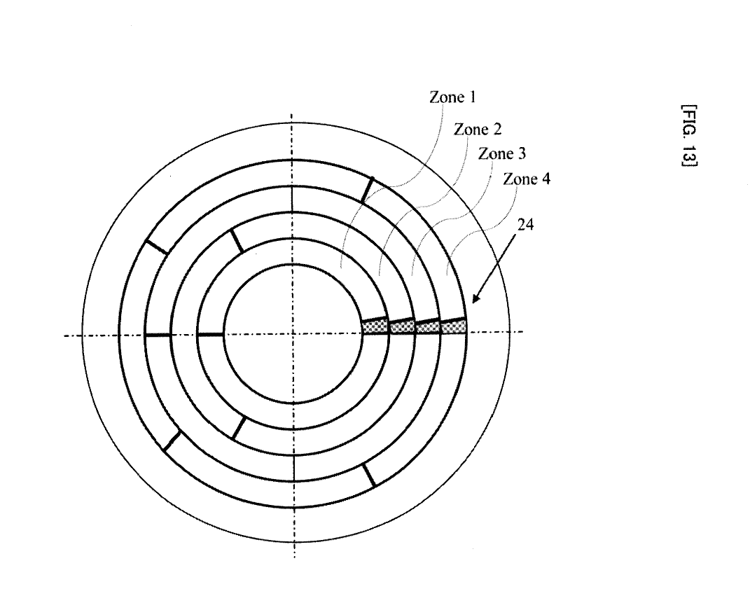

As illustrated in FIG. 13, in another example of the guide layer 12, the specific area 24 is disposed to cover or connect to the zone 1 and the other zones which are adjacent to each other. In particular, one of its contour lines (a contour line on the upper side in FIG. 13) is not linear, and there is a slight difference in level in each zone.

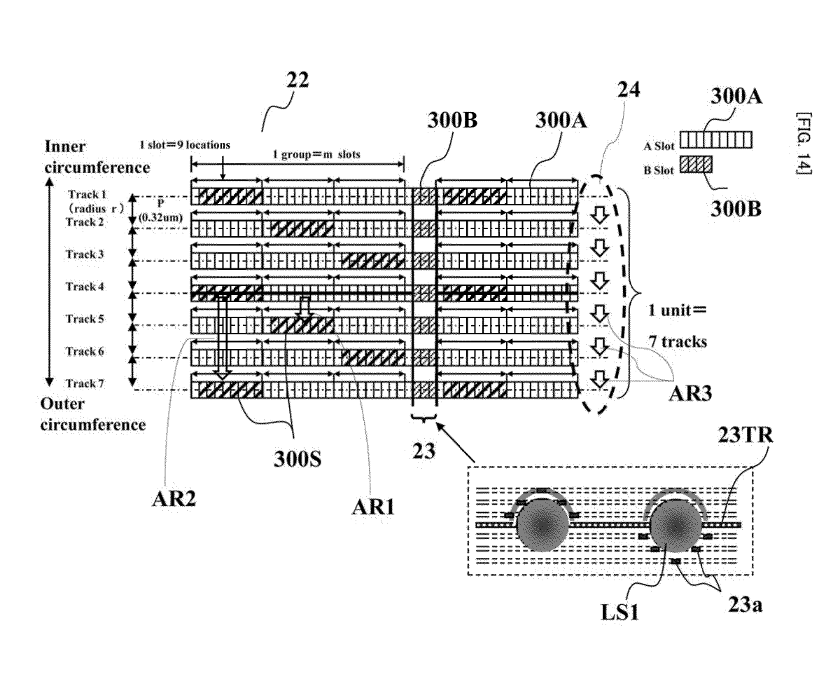

FIG. 14 illustrates a specific configuration example when data is arranged in the servo area 22, the pattern area 23, and the specific area 24, which are three of the four areas provided in the guide layer 12.

In FIG. 14, in the servo area 22, the wobbles are formed in units of slots, as the mark information. Sample servo marks 300S are also formed in units of slots, discretely in the track direction (in a horizontal direction in FIG. 14) and at intervals of two tracks in the radial direction (in a vertical direction in FIG. 13) in respective tracks TR (Track 1 to Track 7) in a form of being widely distributed in a left-side area in FIG. 14 in the servo area 22 (the servo area 22 also used as a servo area). In the servo area 22, slots 300A are arranged in the form that the sample servo marks 300S are widely distributed according to a predetermined rule, as described above. In the pattern area 23, slots 300B are arranged in a form of aligning substantially in the radial direction.

In the pattern area 23, the tilt detection pattern is formed by a slot unit as the pattern signal in the slot 300B. In the pattern area 23, one pattern is established in a form of covering the seven tracks, as the tilt detection pattern. As illustrated as the pattern area 23 in a rectangle at the lower right of the drawing, in this example, a pattern which fits an upper half on the outer rim of the light spot LS1 (i.e. the bright ring LS1a) is formed immediately after the servo area 22, and subsequently, at a slight distance therefrom, a pattern which fits a lower half on the outer ring of the light spot LS1 (i.e. the bright ring LS1a) is formed. One tilt detection pattern is established from the two patterns.

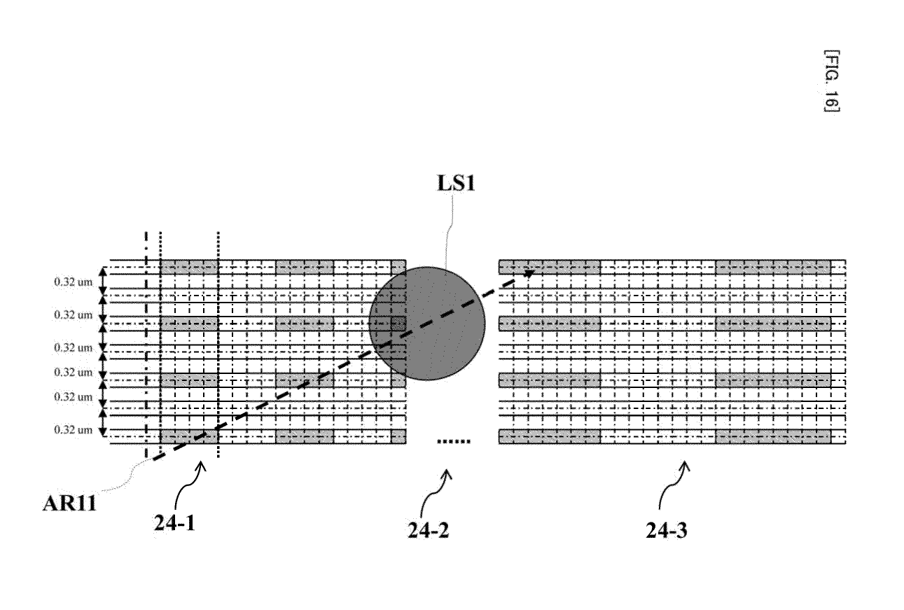

In the specific area 24, a physical structure for forming the predetermined pattern detailed later (refer to FIG. 16 to FIG. 19) is formed one by one in the plurality of tracks.

In FIG. 14, if the track jump or the tracking servo pull-in is performed in the servo area 22, a one-track jump can be performed between the tracks illustrated by an arrow AR1, and the tracking servo pull-in to this jump destination can be also performed. In the place illustrated by an arrow AR2, a three-track jump can be performed; however, the one-track jump cannot be performed. In other words, in the latter case, the track jump and the tracking servo pull-in in the normal sense cannot be performed. In contrast, in the specific area 24, as illustrated by arrows AR3, the one-track jump can be performed in any position. Thus, the track jump and the tracking servo pull-in in the normal sense can be performed without any problem.

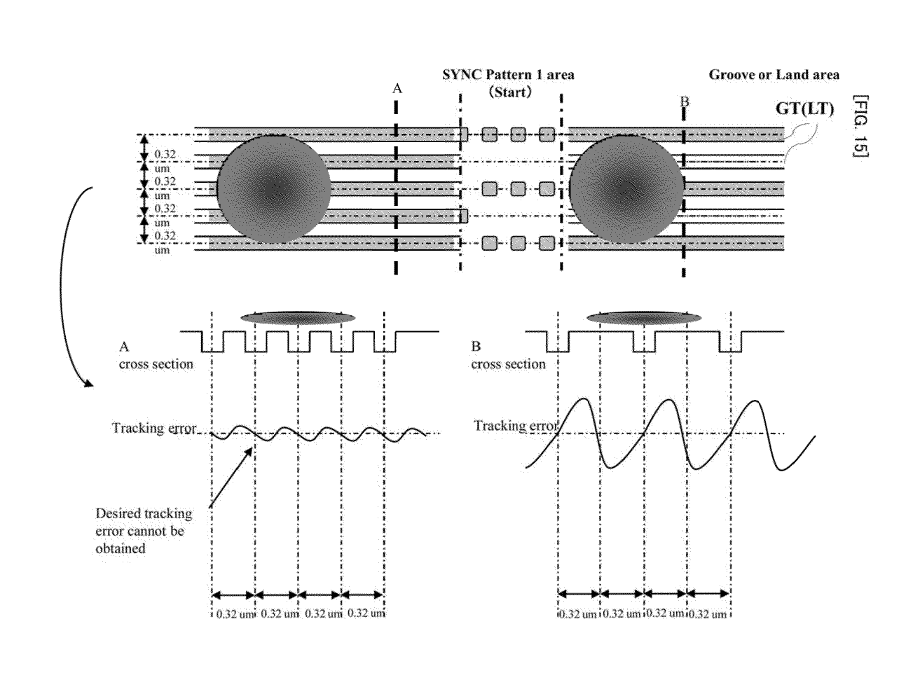

Hereinafter, this point will be explained in detail with reference to FIG. 15 to FIG. 19.

In FIG. 15, in the case of a comparative example illustrated in the left half of the drawing, due to high-density tracks in which the light spot is simultaneously irradiated on five tracks, even if the light spot is displaced in the radial direction (a vertical direction in FIG. 15), the tracking error signal having an amplitude suitable for the tracking servo pull-in or the track jump cannot be obtained from an uneven A cross section. Namely, even if such a configuration is adopted, it is not useful for the tracking servo pull-in and the track jump.

In FIG. 15, in the case of the example illustrated in the right half of the drawing, due to low-density tracks in which the light spot is simultaneously irradiated on three tracks, if the light spot is displaced in the radial direction (the vertical direction in FIG. 15), the tracking error signal having an amplitude suitable for the tracking servo pull-in or the track jump cannot be obtained from an uneven B cross section. In this case, the SYNC patterns and the grooves are provided only in the groove tracks GT, and the land tracks LT are left as the mirror surface. Thus, as a whole, intermittent grooves are established.

Thus, in the example, not the pattern as illustrated on the left side of the drawing but the pattern as illustrated in the right half of the drawing are adopted as the body portion of the predetermined pattern in the specific area 24. Incidentally, FIG. 15 illustrates in the center thereof that the first SYNC pattern area is used as a signal indicating the start of the body portion of the pattern.

Next, in FIG. 16 to FIG. 19, various specific examples of the first and second SYNC patterns will be illustrated, each of which distinguishably indicates that a desired tracking error signal can be generated and that such an area starts and ends, as in the example in the right half of FIG. 15. In FIG. 16 to FIG. 19, the first SYNC pattern area 24-1, the body area 24-2, and the second SYNC pattern area 24-3, which are arranged in the track direction, are illustrated, and dark-color portions on the tracks in the drawings are uneven such as the grooves or the lands in comparison with the other portions.

In the specific example illustrated in FIG. 16, from the inner circumference to the outermost circumference, the “SYNC patterns” are provided every two track in the main area 24-2. In the first SYNC pattern area 24-1 and the second SYNC pattern area 24-3, the “SYNC patterns” are formed of the intermittent grooves or pits, and are formed such that positions of the SYNC patterns are substantially aligned in the radial direction. A “SYNC pattern 1” in the first SYNC pattern area 24-1 and a “SYNC pattern 2” in the second SYNC pattern area 24-3 are formed to have mutually different lengths.

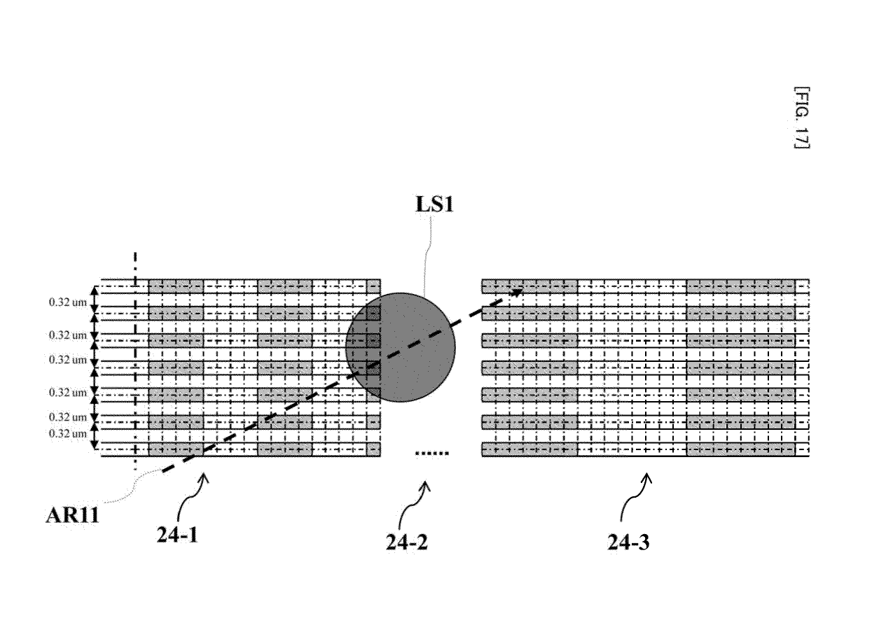

In the specific example illustrated in FIG. 17, from the inner circumference to the outermost circumference, the “SYNC patterns” are provided on all the tracks in the main area 24-2. In the first SYNC pattern area 24-1 and the second SYNC pattern area 24-3, the “SYNC patterns” are formed of the intermittent grooves or pits, and are formed such that the positions of the SYNC patterns are substantially aligned in the radial direction. The “SYNC pattern 1” in the first SYNC pattern area 24-1 and the “SYNC pattern 2” in the second SYNC pattern area 24-3 are formed to have mutually different lengths.

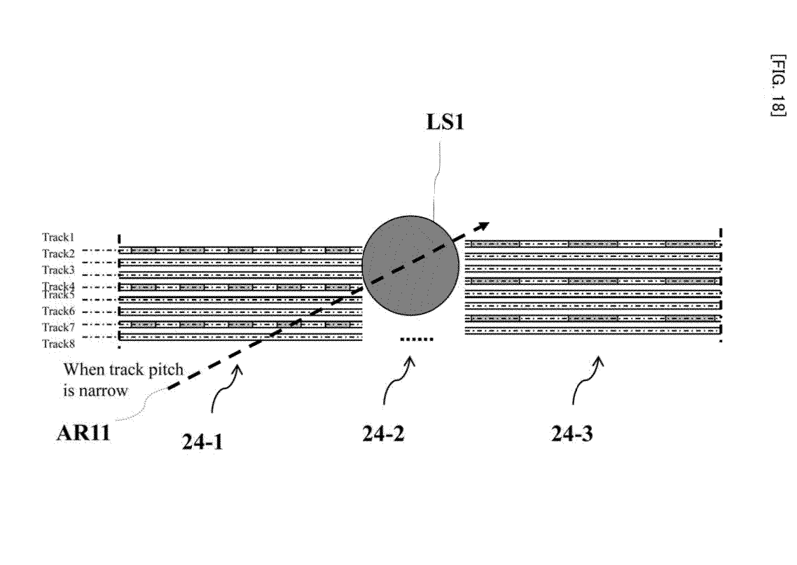

In the specific example illustrated in FIG. 18, from the inner circumference to the outermost circumference, the “SYNC patterns” are provided every three tracks in the main area 24-2. In the first SYNC pattern area 24-1 and the second SYNC pattern area 24-3, the “SYNC patterns” are formed of the intermittent grooves or pits, and are formed such that positions of the SYNC patterns are substantially aligned in the radial direction. The “SYNC pattern 1” in the first SYNC pattern area 24-1 and the “SYNC pattern 2” in the second SYNC pattern area 24-3 are formed to have mutually different lengths. Incidentally, in this example, the track pitch is set to be smaller than the track pitch in the other specific examples.

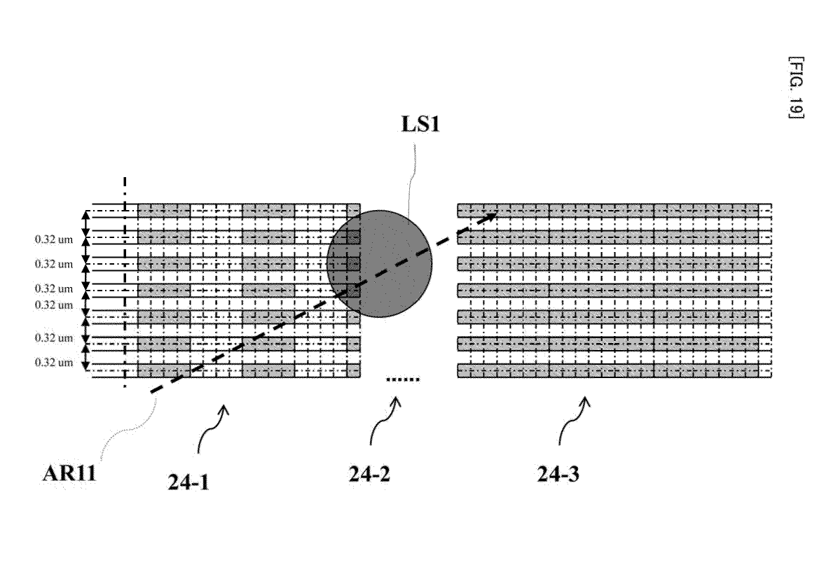

In the specific example illustrated in FIG. 19, from the inner circumference to the outermost circumference, the “SYNC patterns” are provided on all the tracks in the main area 24-2. In the first SYNC pattern area 24-1 and the second SYNC pattern area 24-3, the “SYNC patterns” are formed of the intermittent grooves or pits, and are formed such that the positions of the SYNC patterns are substantially aligned in the radial direction. The “SYNC pattern 1” in the first SYNC pattern area 24-1 is formed as a repetitive pattern of a predetermined length. In contrast, the “SYNC pattern 2” in the second SYNC pattern area 24-3 is formed as a continuous groove structure of a predetermined length.

In the example, as illustrated in FIG. 10 and FIG. 16 to FIG. 19, the specific area 24 has the pattern that can be detected even in the state in which the tracking servo is open. In other words, the tracking error signal, which is obtained when the light spot LS 1 moves as illustrated by an arrow AR11 in the state in which the tracking servo is open, has a sufficient amplitude to perform the tracking servo pull-in and the track jump (refer to FIG. 15).

More specifically, the specific pattern 24 is formed in areas whose start positions on the optical disc 11 are substantially aligned in the radial direction and whose end positions are substantially aligned in the radial direction at least in a certain range of area, such as, for example, each zone in the zone CAV (refer to FIG. 11 to FIG. 13). The first SYNC pattern of the predetermined pattern is formed in a physical shape, such as marks, pits, or partial grooves whose start positions and end positions are substantially aligned in the radial direction and which are provided in at least one section or more. In the first SYNC pattern, the physical shape is formed in at least one track in the first SYNC pattern area 24-1 (i.e. the start position side of the specific area 24). Moreover, the physical shape is formed in at least one track of the adjacent tracks 24G included in the diameter of the light spot LS1 determined from λ/NA (i.e. wavelength/numerical aperture) of the first beam LS1.

Moreover, the second SYNC pattern having a different length along the track from that of the first SYNC pattern is formed in the second SYNC pattern area 24-3 (i.e. on the end portion side of the specific area 24) in the physical shape in the same manner as the first SYNC pattern.

In the body area 24-2 located between the first and second SYNC areas 24-1 and 24-3, the body portion of the predetermined pattern, in which the grooves or the lands are alternately arranged on all the tracks or every other or two tracks or the like, is formed along the tracks 24G to cover the plurality of tracks which are adjacent to each other.

Moreover, in the first SYNC pattern area 24-1 of the specific area 24, a unique first SYNC pattern signal defined in advance to indicate the start of the specific area 24 is detected when the light spot LS1 crosses the tracks 24G along the arrow AR11 even in the state in which the tracking servo is open. On the other hand, in the second SYNC pattern area 24-3 of the specific area 24, a unique second SYNC pattern signal defined in advance to indicate the end of the specific area 24 is detected when the light spot LS1 crosses the tracks 24G along the arrow AR11 even in the state in which the tracking servo is open.

As described above, the specific area 24 is provided in the guide layer 12. Thus, as detailed later, if the tracking servo pull-in is performed in the recording or reproduction of the optical disc 11, it is possible to start, continue, and stop the tracking servo pull-in operation without any problem by displacing the light spot LS1 in the radial direction so as to be displaced along the specific area 24. It is also possible to perform the start, continuation, and stop the track jump without any problem.

Incidentally, in the state in which the tracking servo is closed, continuous error detection and the track jump can be performed in the specific area 24. Namely, by using this portion, if the first SYNC pattern is normally detected even in the state in which the tracking servo is closed, it can be recognized that an area after the end of the detection of the first SYNC pattern is the groove area, and groove tracking is thus possible. Moreover, if the second SYNC pattern is detected, it can be recognized that a data recording area starts from the end of the detection of the second SYNC pattern.

Furthermore, due to the first SYNC pattern and the second SYNC pattern provided only in the tracks having the grooves, it is possible to distinguish whether the grooves are tracked or the lands are tracked, by detecting a RF signal (sum signal) in the detection of the first SYNC pattern, which remarkably improves robustness.

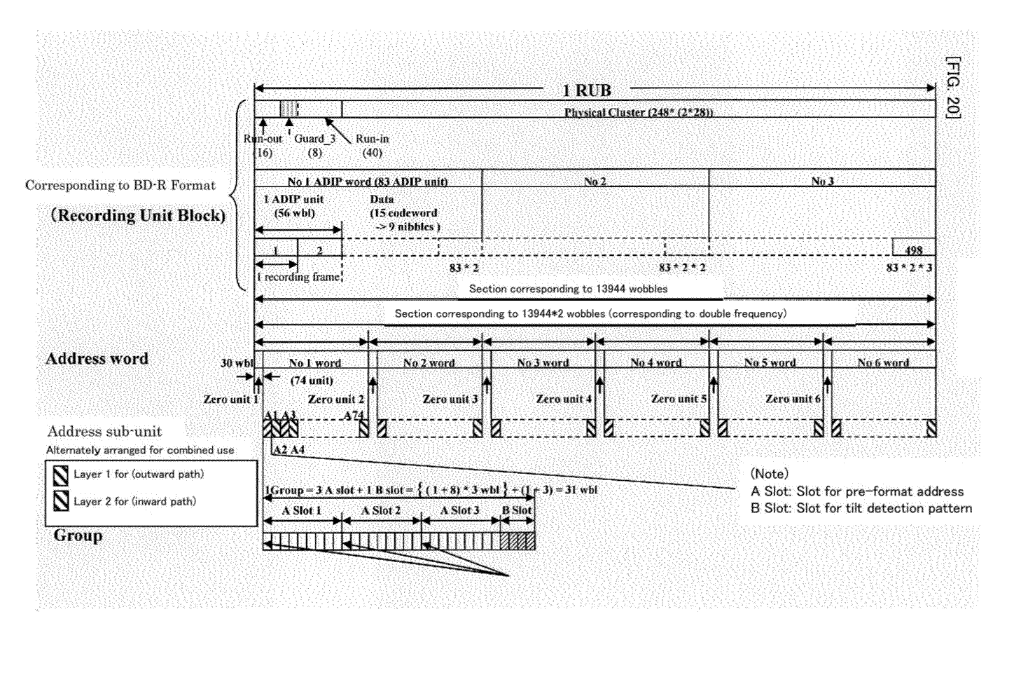

Next, with reference to FIG. 20 to FIG. 25, a specific data configuration of the servo area 22 and the pattern area 23 in the guide layer 12 (refer to FIG. 9) will be explained in detail.

Incidentally, in this example, signals recorded in the servo area 22 and the pattern area 23 are provided in units of slots. Here, the “slot” is a logical section or division or a physical section or division obtained by dividing the track TR in the track direction. The slots are typically arranged continuously without gaps in the track direction and arranged without gaps in the radial direction or adjacently to each other. In this case, since control such as the tracking servo and the tilt servo is performed indirectly in the guide layer 12, the control becomes easy to be performed if a data format in the recording layer 13 is set to have a constant relation with the slot.

FIG. 20 illustrates one configuration example of a pre-format in the servo area 22 and the pattern area 23 in the guide layer 12.

In FIG. 20, the pre-format configuration is configured to be commonly used for two layers of the recording layers 13 (i.e. a recording layer for an outward path and a recording layer for an inward path). Thus, the recording layer for the outward path has a three-address configuration, and the recording layer for the inward path has a three-address configuration. Moreover, there is provided the pattern area 23 for the tilt detection.

More specifically, one RUB is configured to correspond to the format of a BD-R (Blue ray Disc-Recordable: a Blue ray disc in which recording can be performed once).

Specifically, one RUB physically includes (248×(2×28)) physical clusters and logically includes three ADIP words (ADIP words NO. 1 to NO. 3).

One ADIP word consists of 83 ADIP units. One ADIP unit consists of 56 wobbles (wbl), which corresponds to two recording frames. The data to be recorded has a unit of 15 code words, i.e. nine nibbles. Therefore, one RUB is a section corresponding to 13944 wobbles.

Each of six address words (i.e. No. 1 to No. 6) included in one RUB has 74 address mark sub-units (servo mark sub-units) (i.e. A1 to A74). At the head of each servo mark word, a zero unit, which is 30 wbl, is disposed.

Moreover, each servo mark sub-unit consists of four slots. The first three slots (A Slots) are assigned to a slot for a servo mark (i.e. a “slot for a pre-format address”). The following one slot (B Slot) is assigned to a slot for the tilt detection (i.e. a slot for the tilt detection pattern). In other words, one servo mark sub-unit corresponds to the four slots in total, which are the three A Slots and the one B Slot, and thus includes {(1+8)×3}+(1+3)=31 wbl in total.

Thus, in the example, the length of one RUB is 2{(31×74)×3+(30×3)}=13944 wbl. Moreover, in the example, a length D of one wobble disposed at the head of each slot is set such that D=1 wbl>1.2 μm (the maximum diameter of the light spot).

As described above, in terms of a pre-address configuration example, six-address configuration is adopted for one RUB, and each address includes 70 units. It also includes address data (37 bits) and is (1 Slot Data)×37 Units=2 bits×37 Units=74 bits.

Incidentally, regarding the configuration of an ECC block, for example, by using 72 bits (=8 bits×9) out of 74 bits, 4 Bytes is used as an ECC code as 5 Bytes raw data.

For example, regarding codes C₀, . . . , C₉ (Parity C₅, . . . , C₈), a Reed-Solomon code is generated in the following manner.

$$\begin{matrix}\begin{matrix}Parity A ( X ) = {\sum }_{J = 5}^{9} {C}_{j} \cdot {X}^{9 - j} \\ = \{ I ( X ) \cdot X \} mod \{ {G}_{E} ( X ) \}\end{matrix} & [ Equation 1 ] \\ {I}_{j} ( X ) = {\sum }_{J = 0}^{4} {C}_{j} \cdot {X}^{4 - j} & [ Equation 2 ] \\ {G}_{E} ( X ) = {\prod }_{k = 0}^{4} ( X + {α}^{k} ) & [ Equation 3 ]\end{matrix}$$

Here, α is a primitive element.

Gₚ(x)=X⁸+X⁴+X³+X²+1

According to the configuration example in one RUB unit as described above, if the recording data format in another recording layer 13 complies with, for example, a BD-R format, the cycle of the wobbles provided for the servo area 22 has a predetermined integral ratio relation with a constituent unit of the data format in one recording layer. A section of the pattern area 23 and a position to be disposed thereof are also set to have a predetermined relation with the cycle of the wobbles. Thus, the predetermined position of the pattern area 23 can be specified from the wobble signal detected from the mark area of the servo area 22. Thus, a recording/reproducing apparatus described later can easily prepare timing to sample a specific parameter detection error.

In particular, even if a measure is taken to solve a new problem caused by that the first beam LB1 for reading the guide layer 12 is for lower-density than a reading beam for the BD-R format, data such as a pre-address required as a pre-format for recording can be formed by a desired information amount. Since a buffer area D (i.e. one portion of the mirror-surface area 21) for removing an influence by the beam diameter and the four slots are provided in one unit, and it is thus possible to remove an influence of the servo area 22 and the pattern area 23, which are disposed in adjacent tracks, when obtaining the pre-format data. It is also possible to remove the influence by the beam diameter of a pickup 102, thereby stably obtain the pre-format information.

In the example, in particular, the address sub-units A1 to A74 are alternately assigned to the outward path (i.e. for the recording layer for the outward path) and to the inward path (i.e. for the recording layer for the inward path).

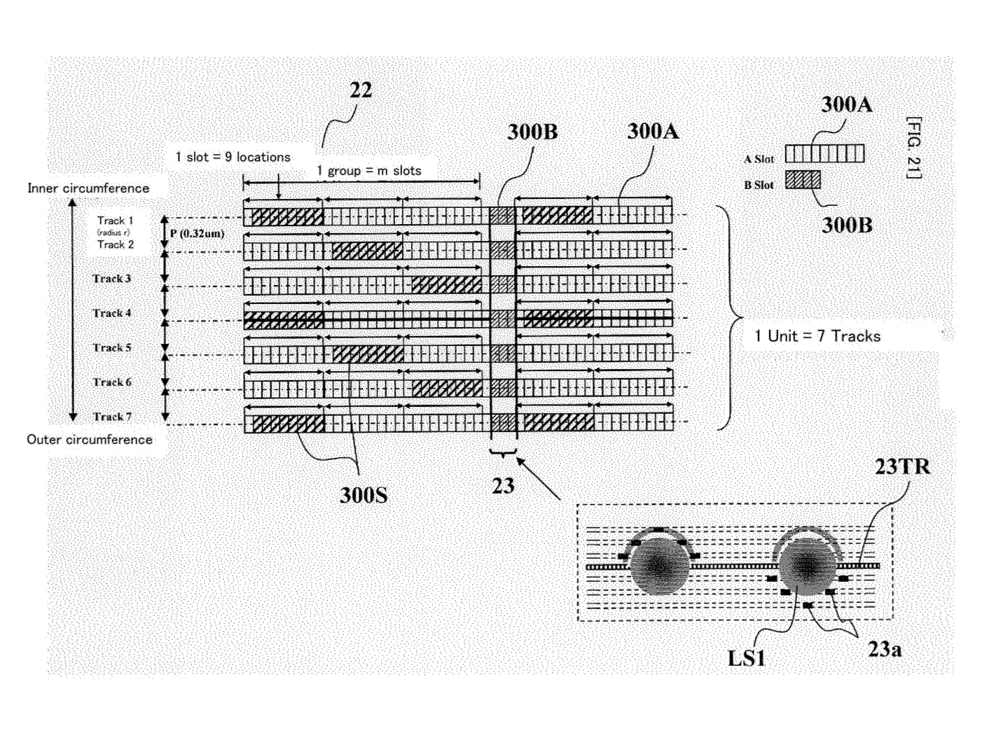

FIG. 21 illustrates a configuration example of a slot 300A (i.e. “A Slot”).

In FIG. 21, the slot 300A consists of nine locations. Out of the nine locations, the first one location is assigned to a buffer area for avoiding an influence caused by a beam size or the like. The remaining eight locations are assigned to an area for disposing a physical shape (area 2) for the following purposes; namely, to generate a sample error signal for the tracking servo, and to constitute one portion of pre-format address data. One group consists of m slots (m=3 in the example).

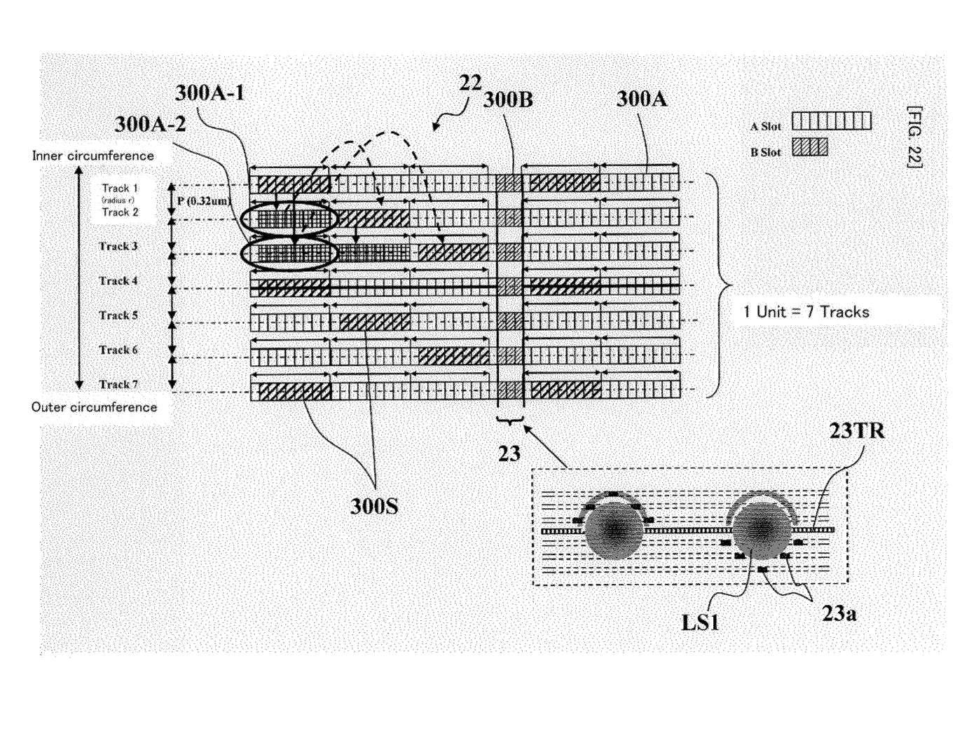

For example, the value of m is determined from a predetermined condition. The servo area 22 is disposed at least in any one of the slots in one group. A condition for the arrangement (including the determination of the value of m) of the slots 300A (i.e. “A Slots”) will be explained later with reference to FIG. 22.

In FIG. 21, in the servo areas 22, the wobbles are formed in units of slots, as the mark information. Sample servo marks 300S are also formed in units of slots, discretely in the track direction (in a horizontal direction in FIG. 21) and at intervals of two tracks in the radial direction (in a vertical direction in FIG. 21) in respective tracks TR (Track 1 to Track 7) in a form of being widely distributed in a left-side area in FIG. 21 in the servo area 22 (the servo area 22 also used as a servo area).

In the servo area 22, the slots 300A (i.e. “A Slots (refer to FIG. 11)”) are arranged in the form that the sample servo marks 300S are widely distributed according to a predetermined rule, as described above. In the pattern area 23, slots 300B (i.e. “B Slots”) are arranged in a form of aligning substantially in the radial direction. Before or after the pattern area 23, three wobbles are ensured as an overlap area 400.

In the example, the length in the track direction of the tilt detection signal on the track TR and the length in the track direction of the constituent unit, such as an ECC block, a recording unit block (RUB), and an ADIP unit, in the format of data which is recorded into each of the recording layers 13 may be configured to have a predetermined integral ratio. In this manner, it becomes easy to maintain the frequency of generating the tilt detection signal and the cycle of recording the data into the recording layer 13 at a position in the recording surface corresponding to the track TR, in a constant relation, regardless of the radial position or the track position. In particular, if the zone CAV method is adopted, the tilt correction can be stably performed on the basis of the detected tilt detection signal at any radial position, even though an angular velocity varies depending on the radial position. Moreover, even if the zone CAV method is adopted, the stable tilt correction can be performed on the basis of the detected tilt detection signal without any problem in each zone.

In FIG. 21, in the pattern area 23, the tilt detection pattern is formed by a slot unit as the pattern signal in the slot 300B. In the pattern area 23, one pattern is established in a form of covering the seven tracks, as the tilt detection pattern. As illustrated as the pattern area 23 in a rectangle at the lower right of the drawing, in this example, a pattern which fits an upper half on the outer rim of the light spot LS1 (i.e. the bright ring LS1a) is formed immediately after the servo area 22, and subsequently, at a slight distance therefrom, a pattern which fits a lower half on the outer ring of the light spot LS1 (i.e. the bright ring LS1a) is formed. One tilt detection pattern is established from the two patterns.

Now, with reference to FIG. 22, the condition for the arrangement (including the determination of the value of m) of the slots 300A will be explained.

As illustrated in FIG. 22, in the determination condition for m (wherein m is the number of the slots that constitute one group), firstly, the number of tracks “n” in which the reading is possibly simultaneously performed is determined from (1) the beam size and (2) the track pitch for recording in the recording layer 13, and then, m is determined to be m=(n−1)/2.

At this time, as the arrangement condition for the servo area 22, the slot 300A is disposed in at least one of “Slot 1” to “Slot m+1” so as not to overlap, in the radial direction, the servo areas 22 which are already arranged one track before (an inner-side adjacent track), two tracks before (an inner-side adjacent track of the track one track before), . . . , and m tracks before.

In the example, n=5 and m=2. Thus, the slot 300A is disposed in any of “Slot 1” to “Slot 3”. For example, regarding a slot 300A-1, as illustrated by a dashed-line arrow therefrom, it may be adaptively arranged from the “Slot 1” to “Slot 2”. For example, regarding a slot 300A-2, as illustrated by a dashed-line arrow therefrom, it may be adaptively arranged from the “Slot 1” to “Slot 3”.

By arranging the slots 300A and the slots 300B in the relation as illustrated in FIG. 21 and FIG. 22, there is no longer any influence by the format in which the arrangement is performed in mutually different conditions. Thus, the two types of slots can be used for making and recording the data, as occasion demands, in response to their respective purposes.

In the pattern area 23, a predetermined specific parameter detection pattern for the pattern area 23 is formed such that a predetermined tilt error can be detected on the center track 23TR, with the seven tracks grouped in one group GR (refer to FIG. 21). Thus, by tracking or following the center track 23TR of the pattern area 23, it is possible to detect the predetermined specific parameter detection pattern at that position.

In FIG. 21, in grouping a plurality of tracks into one group GR, the number of the tracks is seven in the example, as a result of determination in view of the track pitch, the beam diameter of the first beam LB1, expanse of the first beam LB1 on a guide layer surface in cases where the disc is tilted or inclined with respect to the pickup, and the like. The tilt detection pattern formed in the pattern area 23 is detected bilaterally symmetrically to the tracks TR. Thus, generally, the tracks are odd-numbered.

As described above, the servo area 22 is disposed immediately before the center track TR in which the specific parameter detection error can be detected by the specific parameter detection pattern from among the seven tracks TR which belong to the pattern area 23, and it is thus possible to recognize that the first beam LB1 as a reading beam is located on the center track TR in which the specific parameter detection error can be detected. Therefore, it is possible to easily prepare the sample timing of detecting the specific parameter detection error.

On the other hand, if the first beam LB1 is not on the center track TR in one pattern area 23 composed of the plurality of tracks, the wobble signal detected by using the push-pull signal is detected with offset. Thus, it is possible to recognize that the first light beam is not on the center track TR.

In addition, in the example, the sample servo marks 300S are arranged in the separated slots in both the track direction and the radial direction (refer to FIG. 21). Thus, when the data is recorded into one recording layer 13 while the tracks TR of the guide layer 12 are tracked or followed by the first beam LB1, it is possible to stably and continuously generate the tracking error signal by sampling the push-pull signal or by sampling the phase difference signal in differential phase detection (DPD). For example, if a high-frequency component of the push-pull signal, which is a difference between left and right partition detectors, is removed by a low pass filter (LPF), a wobble component and an unnecessary high-frequency noise component can be removed. Here, by sampling the tracking error signal including an eccentric component from the inner circumference to the outer circumference, the tracking error signal can be obtained continuously and it can be used as the tracking error signal in performing the recording into the recording layer 13.

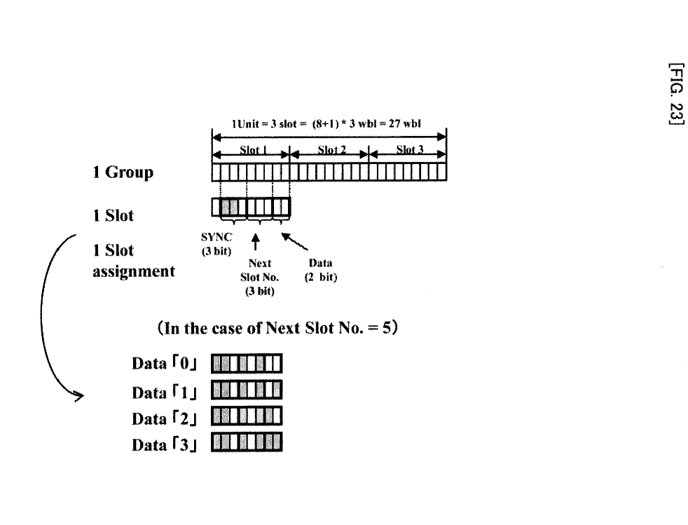

As illustrated in FIG. 23, in one example of the assignment of data in one slot, the first two or three bits out of nine bits in each slot are assigned to a SYNC signal (i.e. a sync signal capable of detecting the tracking error signal). The subsequent three bits are assigned to a slot number (Slot NO.), and the subsequent two bits are assigned to the data (i.e. control data, address data, etc.). For example, the two-bit data allows each of data values (Data) “0” to “3” to be expressed as bit arrangement as illustrated in the lower half of the drawing (if the following slot number is “5”).

Incidentally, regarding the configuration of the ECC block, for example, by using 192 bits (=8 bits×24) out of 206 bits, 12 Bytes raw data+12 Bytes is used as an ECC code.

Incidentally, in the example, one wobble is regarded as 69×2=138 channel bits. The first one wobble (in other words, one bit) of each slot may be assigned to the mirror-surface area 21 (refer to FIG. 9).

Next, with reference to FIG. 24, a configuration example of the slot 300B (i.e. “B Slot”) will be explained.

In FIG. 24, one slot B consists of four locations. The first one location is a buffer area for avoiding the influence caused by the beam size or the like. The remaining three locations are an area for disposing the tilt detection pattern. One unit consists of k tracks.

Here, regarding a determination condition for “k”, “k” may be determined from the beam size, the track pitch for performing the recording into the recording layer, and the track in which amount of return light is influenced by the tilt. In the example, k=7. Regarding an arrangement condition of the pattern area 23, with respect to the slot 300A (i.e. “A Slot”).

the B Slot is disposed at a predetermined ratio (e.g. an arrangement ratio of A:B is 9:4 in the example).

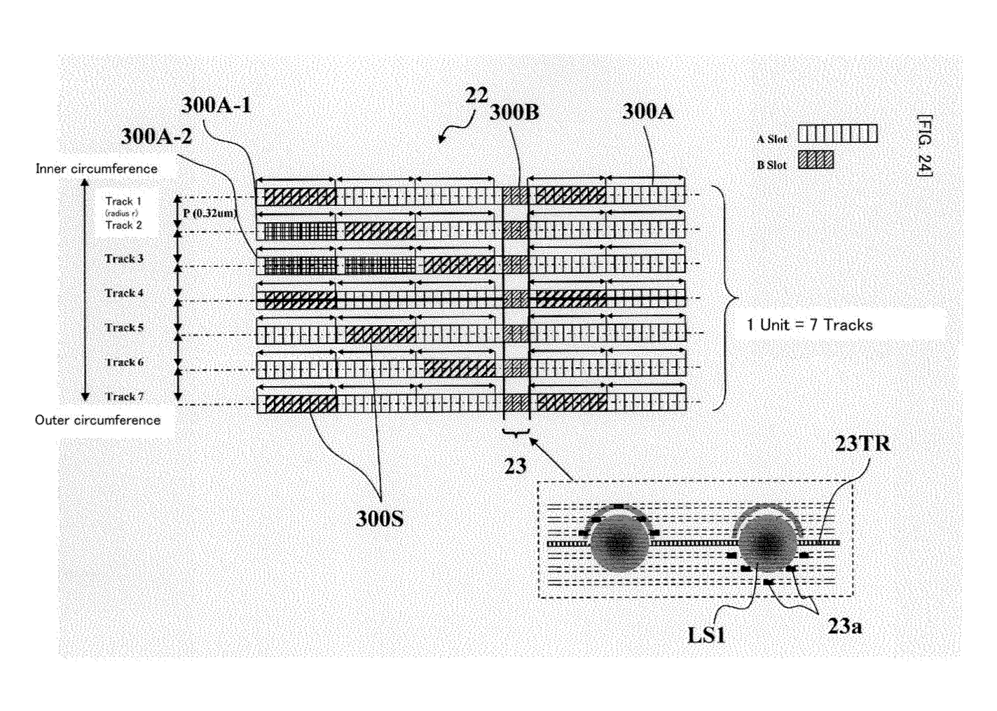

With reference to FIG. 25, the pre-address configuration will be further explained. FIG. 25 illustrates a configuration example of the slot A (configuration for both the outward path and the inward path).

In FIG. 25, the left side in the drawing of the slots 300B arranged in the pattern area 23 is address arrangement for the outward path, and the sample servo marks 300S in this area are, for example, outward path addresses for the first layer of the recording layers 13. In contrast, the right side in the drawing of the slots 300B is address for the inward path, and the sample servo marks 300S in this area are, for example, outward and inward addresses for the second layer of the recording layers 13. The slots or record information used for both the outward path and the inward path are alternately arranged because they are used for the two purposes.

As the pre-address configuration for the outward path and the inward path, the pre-address corresponding to one RUB has a six-address configuration, including a three-address configuration for the outward path and a three-address configuration for the inward path. Each address consists of (74/2)=37 sub-units. The address data is (1 Slot Data)×(37 sub-units)=2 bits×37=74 bits. If the ECC configuration is configured as described above, it can be configured separately for the outward path and for the inward path.

As described above, according to the pre-address configuration example in the example, the tracks are concentric or spiral, and the outward path addresses and the inward path addresses are alternately arranged as the CAV method in the zone. Thus, in one format, a pre-format for outward path recording and a pre-format for inward path recording can be used in one guide layer.

For example, if the recording is performed from the inner circumference to the outer circumference, only the pre-format portion for the outward path is obtained as the address, while the pre-format address portions for the outward path and the inward path are used for tracking signal detection. In the recording, in the case of the concentric tracks, the recording is performed with a one-track jump. Alternatively, in the case of the spiral track, the recording is performed continuously. If the recording is performed from the outer circumference to the inner circumference, only the pre-format portion for the inward path is obtained as the address, while the pre-format address portions for the outward path and the inward path are used for the tracking signal detection. In the recording, in the case of the concentric tracks, the recording is performed with a one-track jump. Alternatively, in the case of the spiral track, the recording is performed with a two-track jump.

As explained above in detail with reference to FIG. 1 to FIG. 25, according to the track formation method in the example (refer to FIG. 9), if the tracks TR in the guide layer 12 are formed by using, for example, the sample servo marks (refer to FIG. 21, etc.) discretely arranged in positions corresponding to recorded information tracks such that the recorded information tracks in the recording layer 13 are spirally formed, continuously from the inner circumference to the outer circumference, the servo area 22 and the pattern area 23 are discretely formed in predetermined positions or at predetermined intervals. Thus, the detection of the specific parameter detection error by a recording/reproducing apparatus described later can be performed in any position of the entire surface of the optical disc 11. As a result, it is possible to perform high-accuracy tilt detection and high-accuracy tilt correction by stably and efficiently obtaining the tilt detection signal in the guide layer 12 which is different from the recording layer 13 while improving the track pitch and the recording linear density (e.g. a linear recording density, a pit pitch, or an information transfer rate (i.e. recording linear density×moving speed)) which allow the recording or reproduction in each recording layer 13 to the extent that it can be called the “high-density recording”, which is an intended purpose in the optical disc 11 of the multilayer type.

Particularly in the example illustrated in FIG. 20 to FIG. 25, the sample servo marks 300S are disposed in the slots separated in both the track direction and the radial direction. Thus, when the data is recorded into one recording layer 13 while the tracks TR of the guide layer 12 are tracked or followed by the first beam LB1, it is possible to stably and continuously generate the tracking error signal by sampling a push-pull signal or by sampling a phase difference signal in differential phase detection (DPD). For example, if a high-frequency component of the push-pull signal, which is a difference between left and right partition detectors, is removed by a low pass filter (LPF), a wobble component and an unnecessary high-frequency noise component can be removed. Here, by sampling the tracking error signal including an eccentric component from the inner circumference to the outer circumference, the tracking error signal can be obtained continuously and it can be used as the tracking error signal in performing the recording into the recording layer 13.

In particular, as illustrated in FIG. 20, in the example, the SYNC, the data, and the like are assigned to the bits in each slot, and the pre-pits are formed or not formed for one wobble wave, and partial information required for a pre-format address configuration as the servo area 22 or the sample servo mark 300S can be appropriately disposed in the desired slot. The pre-pit is to judge presence/absence, and the data is not recorded into the guide layer 12 in the optical disc 11 as in the example, and it is thus enough to detect the LPP in the initial state. This facilitates the detection of the pre-pit signal on a recording apparatus or reproducing apparatus detailed later.

Particularly in the example illustrated in FIG. 20 and FIG. 21, one slot including the servo area 22 or the sample servo mark 300S is appropriately disposed not to overlap another slots including the servo areas 22 or the sample servo marks 300S disposed not only on the adjacent track which is one track before but also on two tracks before. Thus, even if the first beam LB1 (e.g. red laser) for reading the guide layer 12 is for lower-density than the second beam LB2 for the BD-R format, it is possible to avoid the influence by the servo areas 22 disposed on the plurality of adjacent tracks TR in detecting the wobbles and the pre-pits. Thus, the good pre-format data can be obtained.

Incidentally, in the example, the servo area 22 means an area in which the mark information is disposed, and the mark area is also used as the “guide area” or the “servo area” in the present invention. In other words, information for the tracking servo, such as the guide information or the sample servo mark, is also recorded in the servo area 22. In this sense, the servo area 22 can be also referred to as the “servo area 22”. The servo area 22 is an area having the two functions because both the mark information and the guide information are mixedly disposed.

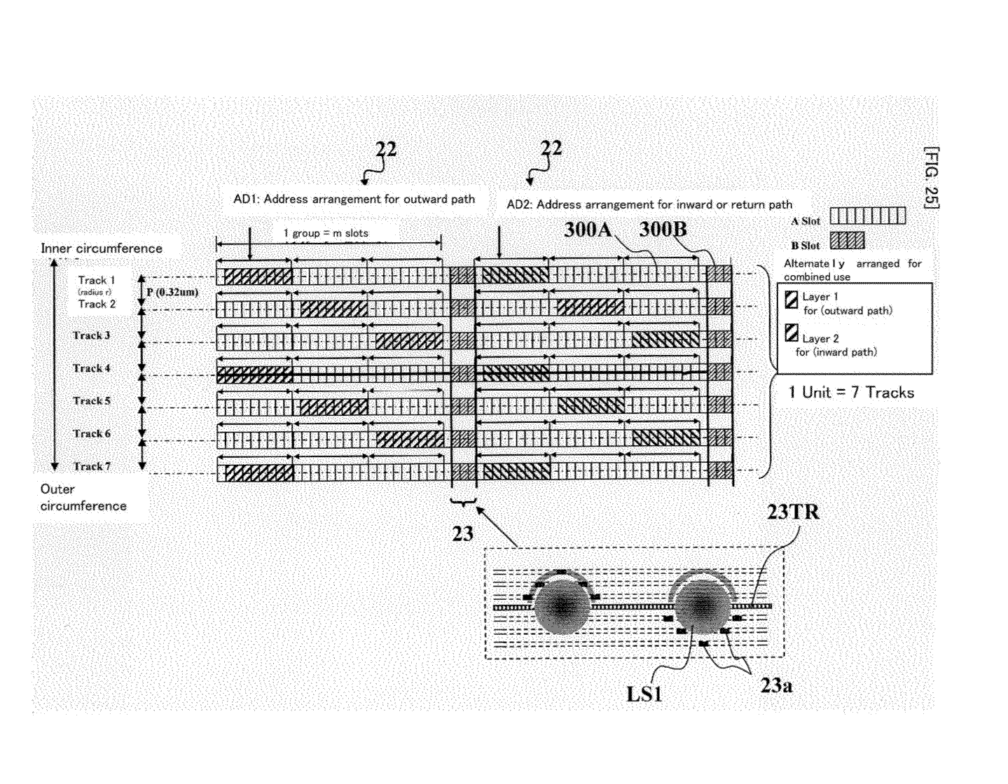

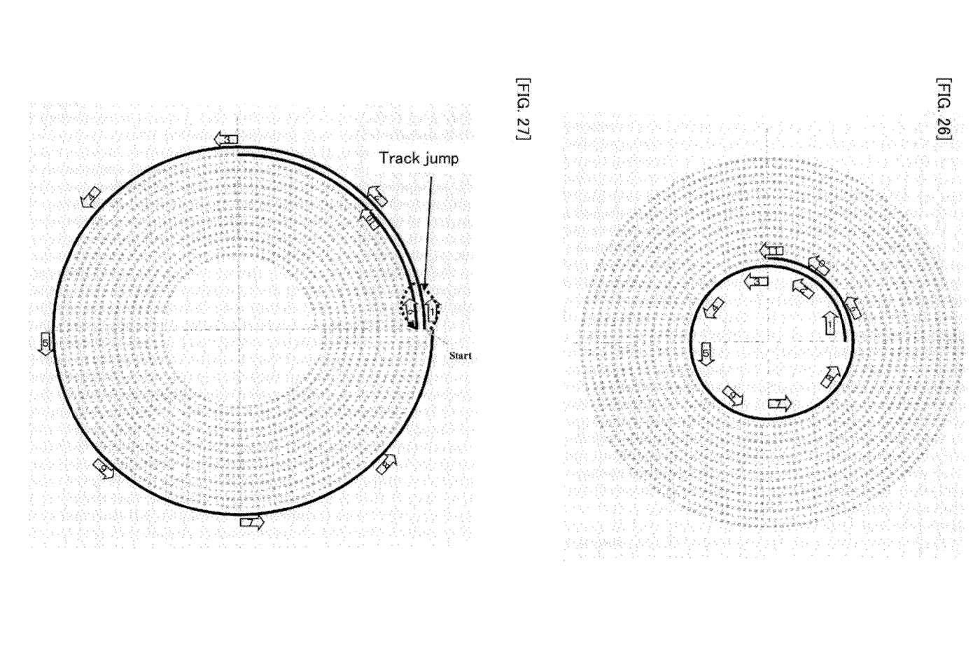

Firstly, with reference to FIG. 26 and FIG. 27, consideration will be given to the occurrence of the track jump and a reciprocating recording operation in the case where the tracks TR in the zone CAV method in the guide layer 12 are concentric.

In FIG. 26, it is assumed that the reciprocating recording operation is started from the innermost circumference of the concentric tracks TR and that the tracking by the first light beam is performed from a “Start” point in the drawing as illustrated by “arrow 1”, “arrow 2”, . . . , and “arrow 8”. At this time, if a track jump TJ is performed toward the track TR on the outer circumferential side, the subsequent tracking by the first light beam is performed on a slightly outer circumferential side as illustrated by “arrow 9”, “arrow 10”, and so on. If the recording is performed from the inner circumference to the outer circumference as described above, the track jump TJ is performed without any problem.

In FIG. 27, it is assumed that the reciprocating recording operation is started from the outermost circumference of the concentric tracks TR and that the tracking by the first light beam is performed from a “Start” point in the drawing as illustrated by “arrow 1”, “arrow 2”, . . . , and “arrow 8”. At this time, if the track jump TJ is performed toward the track TR on the inner circumferential side, the subsequent tracking by the first light beam is performed on a slightly inner circumferential side as illustrated by “arrow 9”, “arrow 10”, and so on.

As described above, even on the premise of the concentric tracks TR, if the recording is performed from the inner circumference to the outer circumference and if the recording is performed from the outer circumference to the inner circumference, the track jump TJ allows the reciprocating recording operation to be performed without any problem.

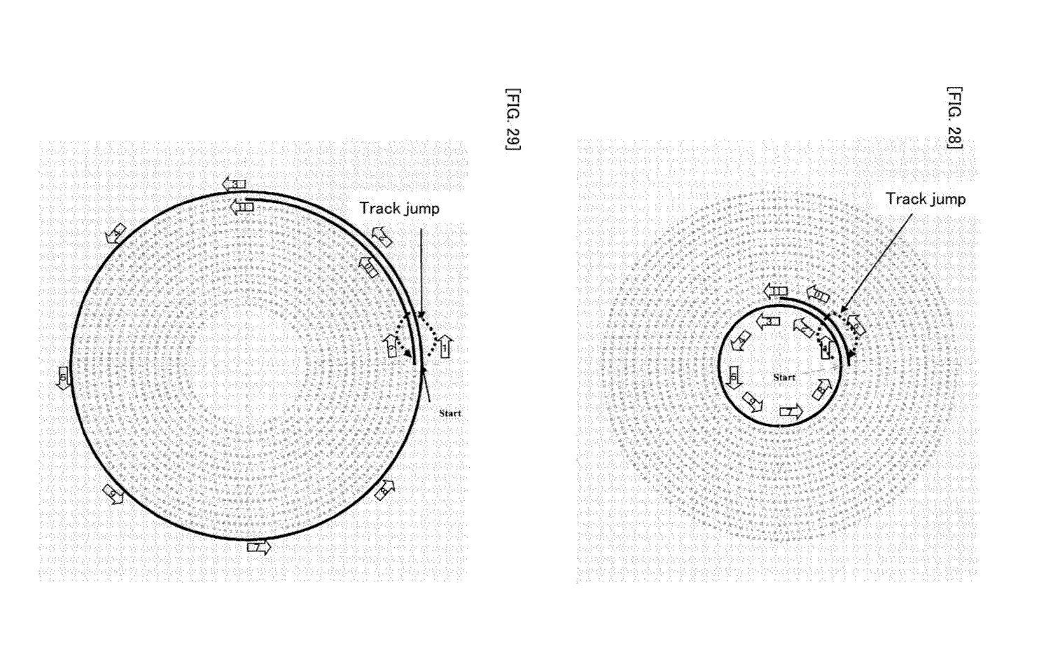

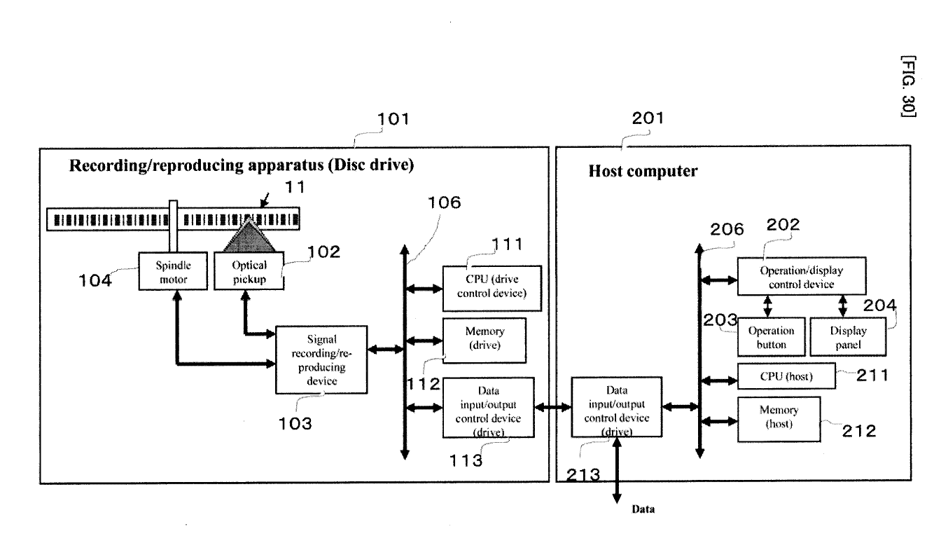

Next, with reference to FIG. 28 and FIG. 29, consideration will be given to the occurrence of the track jump and the reciprocating recording operation in the case where the track TR in the zone CAV method in the guide layer 12 is spiral.

In FIG. 28, it is assumed that the reciprocating recording operation is started from the innermost circumference of the spiral track TR and that the tracking by the first light beam is performed as illustrated by “arrow 1”, “arrow 2”, . . . , and “arrow 8”. At this time, even if the track jump TJ is not performed, the tracking by the first light beam can be moved to the outer side as illustrated by “arrow 9”, “arrow 10”, and so on, on the slightly outer circumferential side. If the recording is performed from the inner circumference to the outer circumference as described above, there is no problem even without the track jump TJ.

In FIG. 29, it is assumed that the reciprocating recording operation is started from the outermost circumference of the spiral track TR and that the tracking by the first light beam is performed from a “Start” point in the drawing as illustrated by “arrow 1”, “arrow 2”, . . . , and “arrow 8”. At this time, if the track jump TJ is performed toward the track TR on a two-track inner circumferential side, the subsequent tracking by the first light beam is performed on a slightly inner circumferential side as illustrated by “arrow 9”, “arrow 10”, and so on.

As described above, even on the premise of the spiral track TR, if the recording is performed from the inner circumference to the outer circumference and if the recording is performed from the outer circumference to the inner circumference, the track jump TJ allows the reciprocating recording operation to be performed without any problem.

Incidentally, using only the three areas illustrated in FIG. 20 to FIG. 29 excluding the specific area 24 (refer to FIG. 9 to FIG. 19) does not enable the tracking servo pull-in or the track jump to be appropriately performed, as already explained with reference to FIG. 14 and the like. This is because the desired tracking error signal cannot be obtained on the track that is a target jump destination, in many cases. For this, as a means for recognizing that the servo area 22 is disposed on the adjacent track, for example, position data can be embedded in advance in the pre-format information; however, there is a major disadvantage, such as reduced information use efficiency.

In the example, however, by providing the specific area 24 as explained with reference to FIG. 9 to FIG. 19, there is such a practical major advantage that the tracking servo pull-in or the track jump can be appropriately performed.

### Example of Information Recording/Reproducing Apparatus and Method

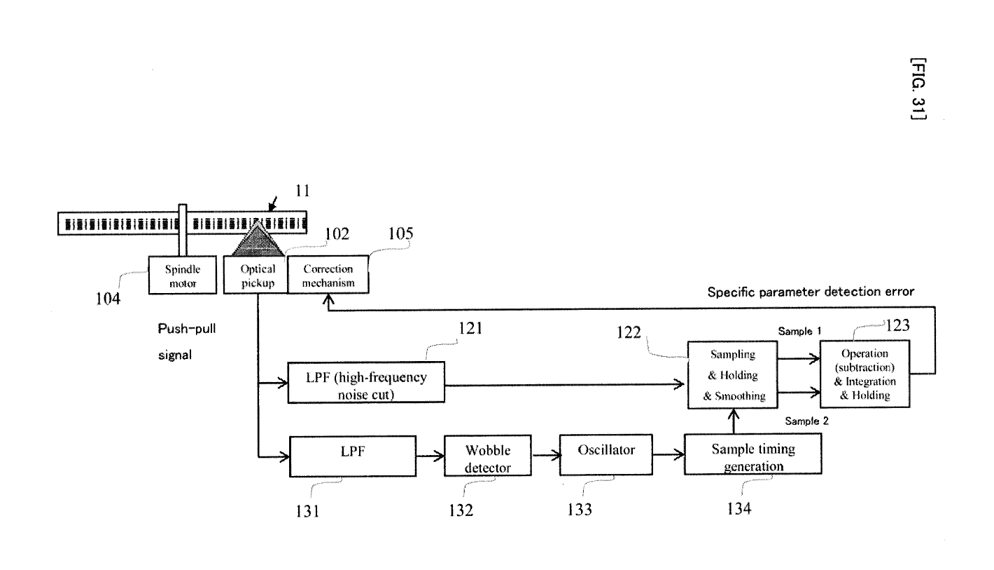

Next, with reference to FIG. 30 to FIG. 35, an example of the information recording/reproducing apparatus and method of the present invention will be explained.

In FIG. 30, a recording/reproducing apparatus 101 is configured as a disc drive as one example of the “information recording apparatus” and the “information reproducing apparatus” of the present invention, and it is connected to a host computer 201.

The recording/reproducing apparatus 10 is provided with: an optical pickup 102; a signal recording/reproducing unit 103; a spindle motor 104; a bus 106; a CPU (drive control unit) 111; a memory 112; and a data input/output control unit 113. In the recording, the first beam LB1 and the second beam LB2 are irradiated via the objective lens 102L (refer to FIG. 2) provided for the optical pickup 102. In the reproduction, only the second beam LB2 which also serves as a light beam for tracking, or both the first beam LB1 and the second beam LB2 are irradiated via the objective lens 102L in the same manner.

The host computer 201 is provided with: an operation/display control unit 202; an operation button 202; a display panel 204; a bus 206; a CPU 211; a memory 212; and a data input/output control unit 213. In the recording, the data to be recorded is inputted from the data input/output control unit 213. In the reproduction, reproduced data is outputted from the data input/output control unit 213.

The optical pickup 102 is provided with: a red semiconductor laser for emitting the first beam LB1; a blue semiconductor laser for emitting the second beam LB2; and a synthesis/separation optical system provided with a prism, a mirror, or the like including the objective lens 102L. The optical pickup 102 is configured to irradiate the first beam LB1 and the second beam LB2 via the common objective lens 102L, coaxially and with different focuses (refer to FIG. 1 and FIG. 2).

Moreover, the optical pickup 102 includes: a light receiving element such as a two-division or four-division CCD for receiving reflected light from the optical disc 11 caused by the first beam LB1 via the objective lens 102L; and a light receiving element such as a two-division or four-division CCD for receiving reflected light from the optical disc 11 caused by the second beam LB2 via the objective lens 102L. The optical pickup 102 can modulate the second beam LB2 at recording intensity which is relatively high in the recording and can set the second beam LB2 at reproduction intensity which is relatively low in the reproduction.

The optical pickup 102 and the signal recording/reproducing unit 103 are configured to generate the tracking error signal, for example, by a push-pull method or differential phase detection (DPD), and to further reproduce the pre-pit signal or the address information, by using a light receiving signal from the light receiving element for receiving the reflected light from the guide layer 12, at least in the recording.

The optical pickup 102 and the signal recording/reproducing unit 103 are configured to generate the tracking error signal, for example, by the push-pull method or differential phase detection, and to generate, for example, a data signal as a signal corresponding to the entire quantity of light, by using a light receiving signal from the light receiving element for receiving the reflected light from the recording layer 13, at least in the reproduction.

Alternatively, the optical pickup 102 and the signal recording/reproducing unit 103 are configured to generate the tracking error signal by using the light receiving signal from the light receiving element for receiving the reflected light from the guide layer 12 and to generate the data signal by using the light receiving signal from the light receiving element for receiving the reflected light from the recording layer 13, in the reproduction.

The memory 112 and the memory 212 are used as occasion demands to temporarily or permanently hold (i) a computer program for controlling each element such as the CPU 111 of the recording/reproducing apparatus 101 and each element such as the CPU 211 of the host computer 201 so as to perform a recording/reproducing operation explained below and (ii) various data such as control data, processing data, and processed data, required for the recording/reproducing operation, via the bus 106, the bus 206, or the like.

Particularly in the example, the recording/reproducing apparatus 101 is further provided with a correction mechanism 105. The correction mechanism 105 is one example of the “processing device” of the present invention and is typically a tilt correction mechanism. The correction mechanism 105 may be various correction mechanisms, such as a mechanism for eccentricity correction of the optical disc 11, a mechanism for inclination correction of a disc surface, a mechanism for aberration correction of an optical system, a mechanism for phase difference correction of a light beam, a mechanism for distortion correction, a mechanism for light absorption correction, and a mechanism for setting of a strategy, in addition or instead of the tilt correction mechanism. By the correction mechanism 105, a particular type of processing (typically, the tilt correction) is performed on the optical pickup 102, on the basis of the pattern signal (typically, the tilt detection signal) detected from the guide layer 12. For example, in the case of the tilt correction, it is performed every time the tilt detection signal is detected, and the tilt servo is locked in a period until the next tilt detection signal is detected.

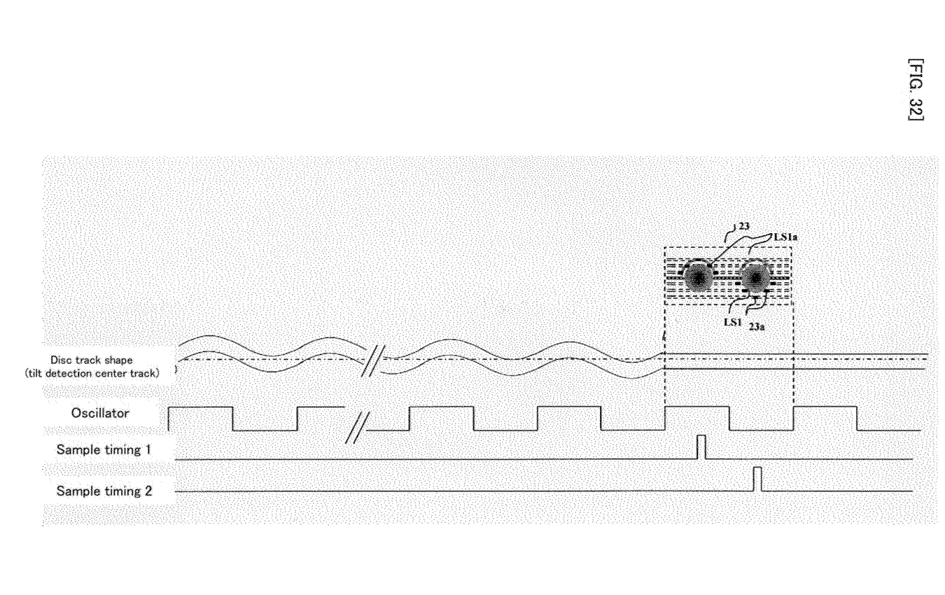

Now, with reference to FIG. 31 and FIG. 32, out of the recording/reproducing apparatus 101, the details of a part associated with the correction performed on the correction mechanism 105 will be explained.

In FIG. 31, the correction mechanism is provided with a low pass filter (LPF) 121, a sampling & holding & smoothing circuit 122, an operation (subtraction) & integration & holding circuit 123, a LPF 131, a wobble detector 132, an oscillator 133, and a sample timing generation circuit 134.

Firstly, the push-pull signal from the light receiving element of the optical pickup 102 is inputted to each of the LPF 121 and the LPF 131, and a high-frequency noise is cut.

Then, on one hand, an output signal with the high-frequency noise cut on the LPF 131 is subject to wobble detection by the wobble detector 132, and oscillation is performed on the oscillator 133 at a frequency corresponding to the detected wobble.

As illustrated in FIG. 32, here, a rectangular wave corresponding to the wobble in a disc track shape is outputted from the oscillator 133.

In FIG. 31, in accordance with the oscillation output, a sample timing signal is generated by the sample timing generation circuit 134. As illustrated in FIG. 32, the sampling timing signal is a rectangular pulse for closing a sampling switch located in the center of the output pulse from the oscillator 133.

On the other hand, an output signal with the high-frequency noise cut on the LPF 121 is sampled, held, and further smoothed by the sampling & holding & smoothing circuit 122. At this time, the timing of the sampling is based on the sample timing signal generated by the sample timing generation circuit 134. As illustrated in FIG. 32, in accordance with the sample timing signal, the pattern signal (e.g. the tilt detection signal) can be detected in good timing from the pattern area 23.

Output signals, which are a sample 1 and a sample 2 from the sampling & holding & smoothing circuit 122, are subtracted, integrated, and further held by the operation (subtraction) & integration & holding circuit 123. As a result, a specific parameter error signal is generated, for example, as the pattern signal which makes one pattern by covering the seven tracks, or on the basis of the pattern signal obtained in this manner.

If the specific parameter error signal is inputted to the correction mechanism 105, a driving operation on the correction mechanism 105 is performed in accordance with characteristics, such as a value of the signal, a positive or negative sign, or the degree of modulation. For example, in the case of the tilt correction, the driving is performed so as to reduce a tilt error by using an actuator for the tilt correction.

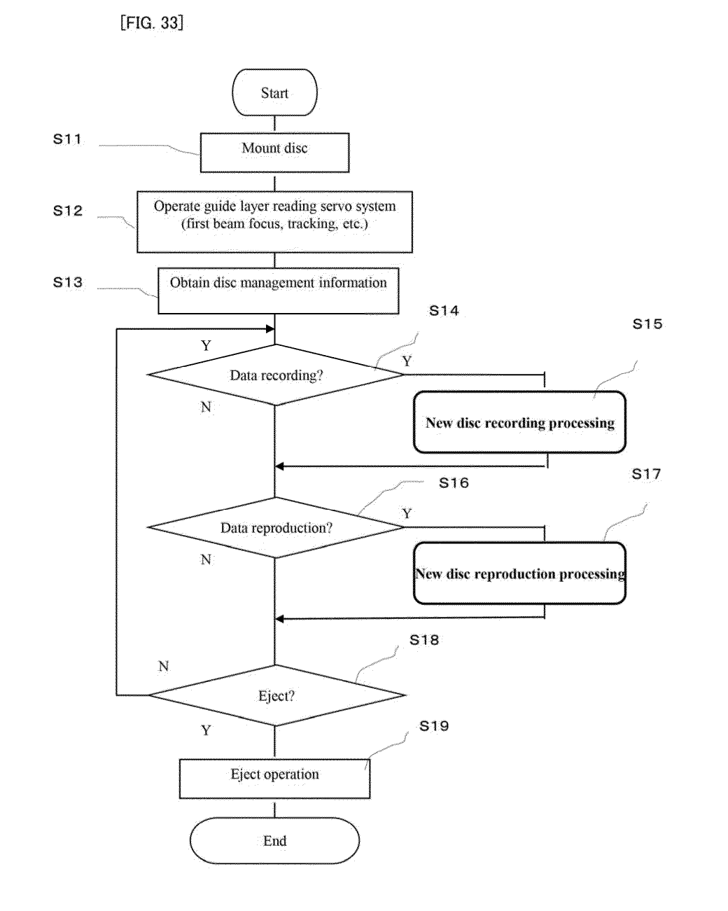

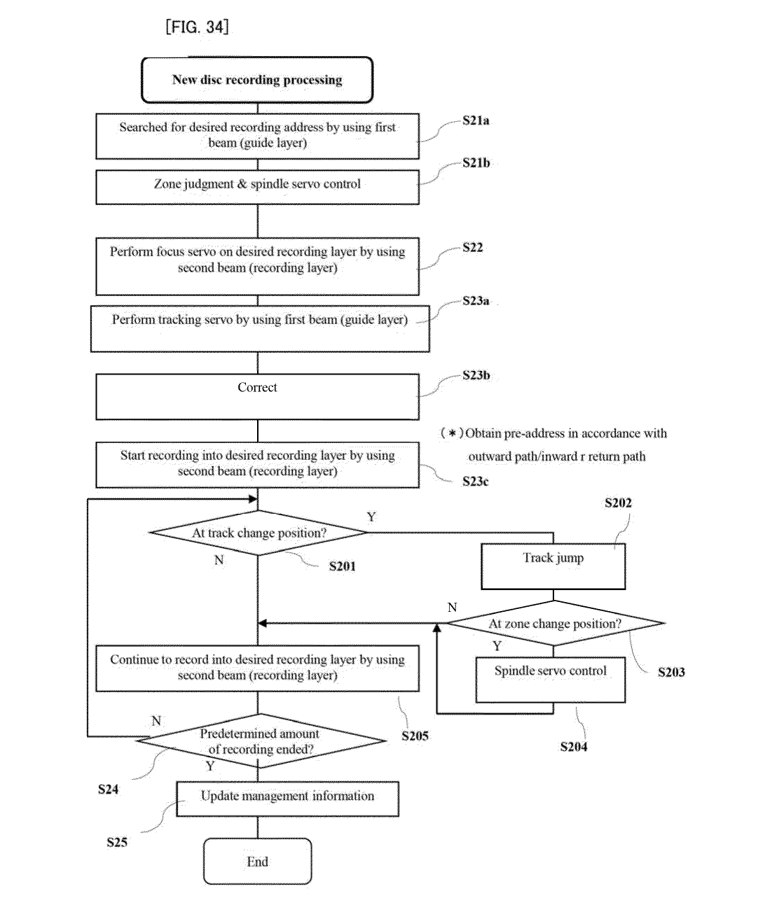

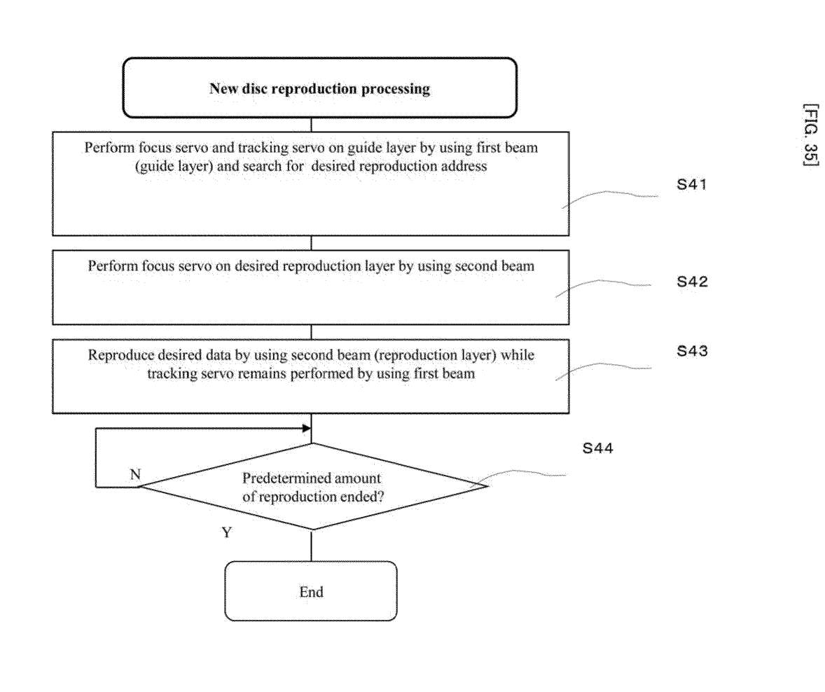

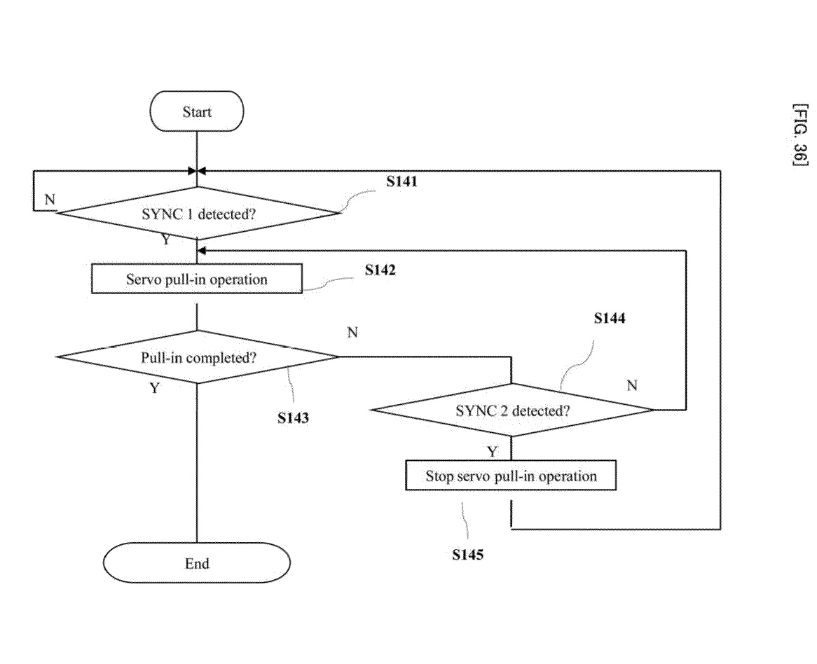

Hereinafter, with reference to FIG. 33 to FIG. 35 in addition to FIG. 30, the configuration and operation of each constituent of the recording/reproducing apparatus 101 in the example will be explained, with the entire operation of the recording/reproducing apparatus 101. FIG. 33 illustrates the recording/reproducing operation of the recording/reproducing apparatus 101. FIG. 34 illustrates the details of one example of the recording operation. FIG. 35 illustrates one example of the reproducing operation.

In FIG. 33, firstly, the optical disc 11 in the format according to the example described above is mounted on the recording/reproducing apparatus 101 by mechanical or manual operation by a user (step S11).

Then, an operation start command according to operation performed on the operation button 203 by the user while watching the display panel 204 is issued by the operation/display control unit 202 and the CPU 111 on the drive side and the CPU 211 on the host side or the like. In response to the operation start command, under the control by the signal recording/reproducing unit 103, the rotation of the optical disc 11 is started by the spindle motor 104. Before or after this, under the control by the signal recording/reproducing unit 103, light irradiation by the optical pickup 102 is started. Moreover, a reading servo system for the guide layer 12 is operated. In other words, the first beam LB1 is irradiated and focused on the guide layer 12, by which the tracking operation is started (step S12).

Incidentally, the transfer of various commands including the operation start command and the various data including user data and control data is performed via the bus 206 and the data input/output control unit 213 on the host side and the bus 106 and the data input/output control unit 113 on the drive side.

Then, the irradiation onto the tracks TR by the first beam LB1 is kept on the guide layer 12, and the wobble signal and the pre-pit signal (moreover, the tracking error signal obtained from at least one of these signals by the push-pull method or DPD) are detected from the servo area 22. Moreover, disc management information recorded in advance as at least one of these signals is obtained by the CPU 111 on the drive side or the CPU 211 on the host side or the like.

Incidentally, the disc management information may be collectively recorded and read in a lead-in area, a table-of-content (TOC) area, and the like which are located on the innermost circumferential side of the guide layer 12. The content may comply with the disc management information of the existing DVD, BR disc, or the like. Management information may be recorded in advance or separately previously, in the lead-in area, the TOC area, and the like which are specially provided for the recording layers, and this may be read at this time point or an arbitrary time point.

Then, it is judged whether or not operation required by the CPU 111 on the drive side or the CPU 211 on the host side or the like is data recording (step S14). If it is the data recording (the step S14: Yes), recording processing for a new optical disc 11 is performed (step S15). The recording processing will be detailed later (refer to FIG. 34).

On the other hand, if it is not the data recording in the judgment in the step S14 (the step S14: No), or if the recording processing for the new optical disc 11 is completed in the step S15, it is judged whether or not the operation required by the CPU 111 on the drive side or the CPU 211 on the host side or the like is data reproduction (step S16). Here, if it is the data reproduction (the step S16: Yes), reproduction processing for the new optical disc 11 is performed (step S17). The reproduction processing will be detailed later (refer to FIG. 35).

If it is not the data reproduction in the judgment in the step S16 (the step S16: No), or if the reproduction processing for the new optical disc 11 is completed in the step S17, it is judged whether or not ejection, i.e. tray ejection or the like, is required via the operation button 203 or the like (step S18). Here, if the ejection is not required (the step S18: No), the operational flow returns to the step S14, and the subsequent steps are performed again.

On the other hand, if the ejection is required in the judgment in the step S18 (the step S18: No), the ejection operation is performed (step S19), and a series of recording/reproducing processing for the optical disc 11 is completed.

Next, with reference to FIG. 34, one example of the recording processing for the new optical disc 11 (the step S15 in FIG. 35) will be explained.

In FIG. 34, if the recording processing is started, firstly, the wobble signal and the pre-pit signal are detected from the servo area 22 while the irradiation onto the tracks TR by the first beam LB1 is kept (i.e. while the tracking operation remains performed) on the guide layer 12, under the control by the CPU 111 and the signal recording/reproducing unit 103. By this, the address information on the tracks TR is obtained by the CPU 111 or the like. By referring to the address information, a desired recording address specified as an address to start the data recording is searched for by the CPU 211 or the like. In other words, the first beam LB1 is moved to the address position. By this search operation, the second beam LB2 which shares the optical system such as the objective lens 102L in the optical pickup 102 with the first beam LB1 (refer to FIG. 1 and FIG. 2) is also moved to a planar position in the recording surface corresponding to the searched recording address on the recording layer 13 (step S21a).

Then, a zone of the optical disc 11 in the zone CAV method is judged, and spindle servo control is performed in accordance with the judged zone to set a rotational speed suitable for the zone (step S21b).

Then, under the control by the CPU 111 and the signal recording/reproducing unit 103, focus servo by the second beam LB2 is performed by the optical pickup 102 on the desired recording layer 13 to record the data therein (step S22).

Then, the tracking servo for the tracks TR by the first beam LB1 is kept in a state in which the focus servo by the second beam LB2 is closed, by the optical pickup 102. In other words, the tracking servo for the desired recording layer 13 is performed indirectly by the tracking servo for the guide layer 12 (step S23a).

Then, correction is performed on the correction mechanism 105 on the basis of a specific parameter detection result (refer to FIG. 31 and FIG. 32). The correction is performed intermittently, regularly, or irregularly, in accordance with the detection of the pattern signal, such as the tilt detection signal. For example, in the case of the tilt correction, the tilt correction is performed in accordance with the tilt error signal, the tilt servo is locked after the correction, and the next correction opportunity is waited for (step S23b).

The correction in the step S23b may be performed, at least partially, in a process of recording the data in a next step S23c.

Then, the data recording into the desired recording layer 13 is started by irradiating the second beam LB2 with it modulated in accordance with the value of the data to be recorded (step S23c).

Then, it is judged whether or not the optical pickup 102 reaches a track change position by the CPU 111 or the like (step S201). Here, if the optical pickup 102 reaches the track change position (the step S201: Yes), the track jump is performed (step S202).

Then, it is judged whether or not the optical pickup 102 reaches a zone change position by the CPU 111 or the like (step S203). Here, if the optical pickup 102 reaches the zone change position (the step S203: Yes), the spindle servo control is performed to set a rotational speed corresponding to a new zone, and the rotational speed suitable for the zone is set (step S204).

After the step S204, or if the optical pickup 102 does not reach the zone change position in the judgment in the step S203 (the step S203: No), or if the optical pickup 102 does not reaches the track change position in the judgment in the step S201 (the step S201: No), then, the recording of the data into the recording layer 13 is continued (step S205).

Then, it is monitored whether or not a predetermined amount of recording is ended by the CPU 111 or the like (step S24). Here, unless the recording is ended, the data recording into the recording layer 13 is continued (the step S24: No).

Here, if the recording is ended (the step S24: Yes), the management information is updated in accordance with the recorded data (step S25). The management information may be collectively recorded in the lead-in area, the TOC area, or the like which is provided for at least one of the plurality of recording layers 13. The position may be on the inner circumferential side, but may be on the outer circumferential side or in the middle, or may be recorded in a somewhat dispersed form. In addition to or instead of this, management information provided for the memory 112, the memory 212, or the like and linked to the optical disc 11 may be updated.

This is the completion of the series of recording processing for the new optical disc 11 (the step S15 in FIG. 33).

Next, with reference to FIG. 35, one example of the reproduction processing for the new optical disc 11 (the step S17 in FIG. 33) will be explained. This example is an example in which the first beam LB is used for the tracking or the like not only in the recording processing but also in the reproduction processing.

In FIG. 35, the focus servo by the first beam LB1 is performed on the guide layer 12 by the optical pickup 102, under the control by the CPU 111 and the signal recording/reproducing unit 103, and before or after this or in parallel with this, the tracking servo by the first beam LB1 is performed on the tracks TR. Moreover, the address information is obtained from the wobbles and the pre-pits on the tracks TR by the CPU 111 or the like. A desired reproduction address, which is specified as an address to start the reproduction of the data, is searched for by the CPU 211 or the like, by referring to the address information. In other words, the first beam LB1 is moved to the address position. By this search operation, the second beam LB2, which shares the optical system such as the objective lens 102L in the optical pickup 102 with the first beam LB1 (refer to FIG. 1 and FIG. 2), is also displaced to a plane position in the recording surface corresponding to the searched recording address (step S41).

Then, the focus servo by the second beam LB2 is performed on the desired recording layer 13 to reproduce the data therefrom by the optical pickup 102, under the control by the CPU 111 and the signal recording/reproducing unit 103, while the tracking servo remains performed (step S42).

Then, the data reproduction from the desired recording layer 13 is started by receiving the reflected light caused by the second beam LB2 via the objective lens 102L, in a state in which the tracking servo by the first beam LB1 is closed and the focus servo by the second beam LB2 is closed, by the optical pickup 102 (step S43).

Then, it is monitored whether or not a predetermined amount of reproduction is ended by the CPU 111 or the like (step S44). Here, unless the reproduction is ended, the data reproduction from the recording layer 13 is kept (the step S43: No).

Here, if the reproduction is ended (the step S44: Yes), the series of reproduction processing for the new optical disc 11 (the step S17 in FIG. 33) is completed.

Incidentally, as a modified example of the reproduction processing illustrated in FIG. 35, the first beam LB1 is not used for the tracking or the like in the reproduction processing. In other words, in the case of the modified example, the second beam LB2 is used also for the tracking, as opposed to the recording processing. According to the modified example, however, it is hardly possible to perform the tracking servo pull-in and the track using the specific area 24 (refer to FIG. 9, etc.) as explained below, in the reproduction. Thus, in the case of the modified example, the tracking servo pull-in and the track jump are separately performed, by using the recorded information tracks recorded in the recording layer 13.

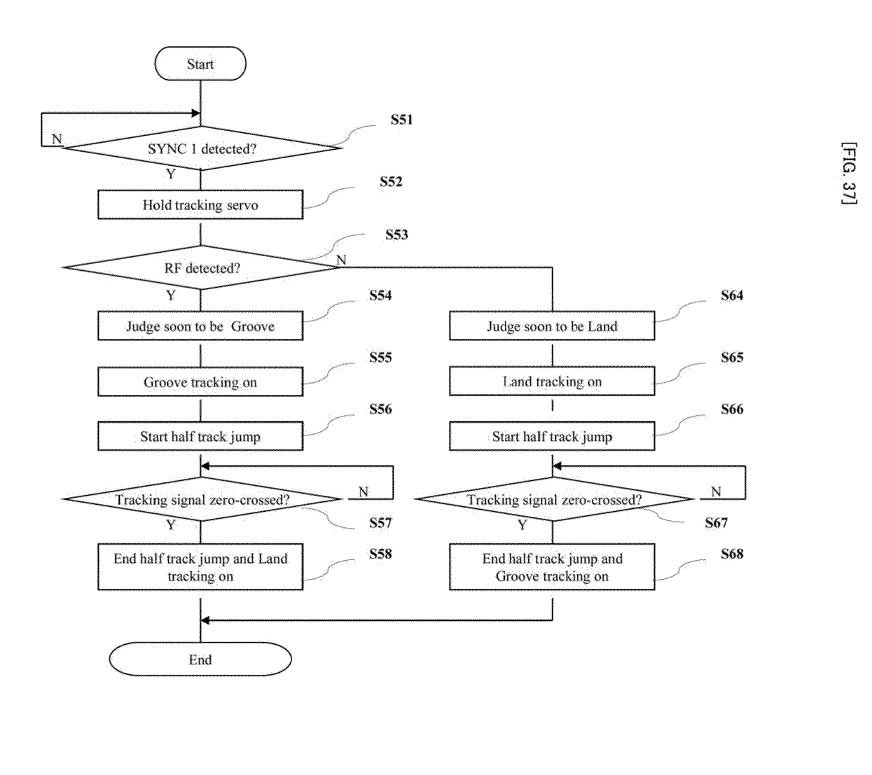

Next, tracking servo pull-in processing will be explained with reference to a flowchart in FIG. 36. The processing is performed, as occasion demands, during the information recording or during the information reproduction, as described above.

In FIG. 36, firstly, as an initial state of the processing, the tracking servo is open.

Firstly, during the recording or during the reproduction, it is monitored whether or not a first SYNC signal “SYNC1” from the first SYNC pattern area 24-1 (refer to FIG. 10, etc.) is detected (step S141: NO). If the first SYNC signal is detected (the step S141: YES), the servo pull-in operation is started (step S142). Here, the pattern in the body area 24-2 (refer to FIG. 10, etc.) is detected, and a zero cross signal having a sufficient amplitude is obtained.

Then, it is monitored whether or not the tracking servo pull-in is completed (step S143).

Here, while the pull-in is not completed (the step S143: NO), it is monitored whether or not a second SYNC signal “SYNC2” from the second SYNC pattern area 24-3 (refer to FIG. 10, etc.) is detected (step S144). Here, the detection of the second SYNC signal (the step S144: YES) means that the specific area 24 in a current cycle ends (refer to FIG. 11 to FIG. 13). Thus, the servo pull-in operation is stopped once, and the operational flow returns to the step S141 again; namely, it is tried to use the specific area 24 in a next cycle. Alternatively, the operation can be also changed to the pull-in operation that can be performed in the servo area 22.

In other words, there is no problem if the servo pull-in operation is completed before the second SYNC signal “SYNC2” is detected; however, even if the servo pull-in operation is not completed, the end of the specific area 24 can be recognized by detecting the second SYNC signal “SYNC2”. Thus, the current servo pull-in operation using the specific area 24 is forcibly terminated, and another option can be performed without a delay, including performing the servo pull-in operation again in the next cycle.

On the other hand, while the second SYNC signal is not detected (the step S144: NO), the operational flow returns to the step S142, and the servo pull-in operation is continued.

In the judgment in the step S143, if it is confirmed that the pull-in is completed (the step S143: YES), the pull-in is regarded as being safely completed, and a series of processing regarding the tracking servo pull-in is ended. By this, the tracking servo for a target track is closed, and the subsequent tracking operation and the like in the recording and the reproduction are continued.

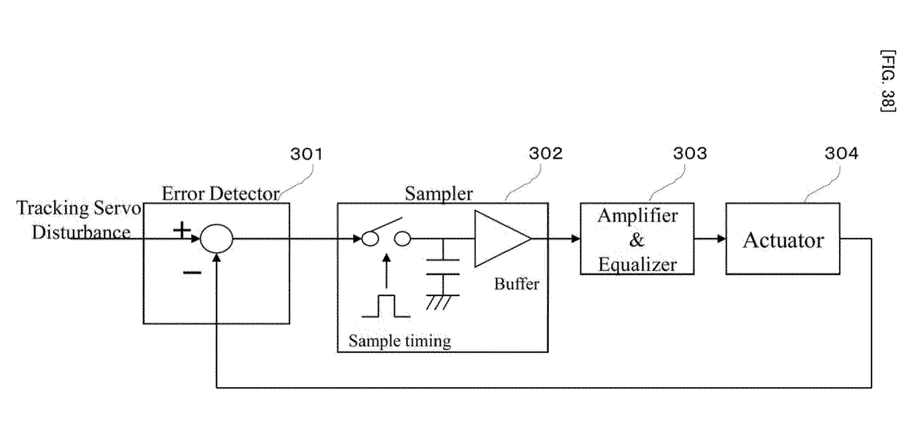

Next, track jump processing will be explained with reference to a flowchart in FIG. 37. The processing is performed, as occasion demands, during the information recording or during the information reproduction, as described above.

In FIG. 37, firstly, as an initial state of the processing, the tracking servo is servo-closed.

In FIG. 37, firstly, during the recording or during the reproduction, it is monitored whether or not the first SYNC signal “SYNC1” from the first SYNC pattern area 24-1 (refer to FIG. 10, etc.) is detected (step S51: NO). If the first SYNC signal is detected (the step S51: YES), the tracking servo is held (step S52).

Then, by the judgment of the RF signal (sum signal) corresponding to the pattern from the first SYNC pattern area 24-1 to the body area 24-2 (refer to FIG. 10, etc.) (step S53), it is judged “soon to be the groove” (step S54) or “soon to be the land” (step S64).

Here, if it is judged “soon to be the groove” (the step S54), the groove tracking is turned on (step S55), and a half track jump is started (step S56).

Then, the pattern in the body area 24-2 (refer to FIG. 10, etc.) is detected, and it is monitored whether or not the tracking error signal (refer to FIG. 15) is zero-crossed (step S57: NO).

If the zero-cross is confirmed (the step S57: YES), the half track jump is ended, and land tracking is turned on (step S58).

Alternatively, if it is judged “soon to be the land” (the step S64), the land tracking is turned on (step S65), and the half track jump is started (step S66).

Then, the pattern in the body area 24-2 (refer to FIG. 10, etc.) is detected, and it is monitored whether or not the tracking error signal (refer to FIG. 15) is zero-crossed (step S67: NO).

If the zero-cross is confirmed (the step S67: YES), the half track jump is ended, and the groove tracking is turned on (step S68).

As described above, a series of processing regarding the track jump is ended. By this, the tracking servo for the target track is closed, and the subsequent tracking operation and the like in the recording and the reproduction are continued.

As explained in detail with reference to FIG. 30 to FIG. 37, the tracking servo pull-in and the track jump can be appropriately performed, in the information recording and the information reproduction.

In particular, in the example, by providing the specific area 24 immediately before a portion in which the arrangement of ECCs of the data to be recorded into the recording layer 13 is aligned in the radial direction, it is possible to recognize the specific area 24 and obtain timing to perform the track jump in either case of recording from the inner circumference to the outer circumference or from the outer circumference to the inner circumference.

Incidentally, in the body portion of the specific area 24, the alternate configuration of the grooves and the lands is adopted, and thus, the jump to the adjacent track can be performed easily in any position.

Moreover, in the first SYNC pattern area 24-1, there is disposed the unique pattern that can be detected even in the state in which the tracking servo is open. Thus, the start of the specific area 24 can be detected in the pull-in, in the state in which the tracking servo is open. Moreover, more preferably, by providing a distance between the grooves in the alternate configuration of the grooves and the lands disposed in the body area 24-2, it is possible to certainly obtain a signal crossing the tracks and to facilitate the servo pull-in.

In addition, in the second SYNC pattern area 24-3, there is disposed the unique pattern that can be detected even in the state in which the tracking servo is open. Thus, even in a state in which the tracking servo pull-in is not performed, it is possible to recognize the end position of the specific area 24, and to change to the servo pull-in method according to the following area.

Moreover, the pattern area is disposed, with the plurality of tracks as one group GR. Thus, free or arbitrary arrangement is possible in the integrated (grouped) tracks, and the degree of freedom can be ensured in the arrangement of specific parameter detection points, such as tilt error detection points, which can be detected by the recording/reproducing apparatus 101. One pattern area 23 and another adjacent pattern area 23 are independent of each other. Thus, it is possible to dispose the specific parameter detection patterns, such as the tilt detection patterns, independently of each other, and arrangement with the degree of freedom is possible throughout the entire surface of the optical pickup 11 as a whole.

As the guide layer 12, the arrangement in this format can realize easy-reading and extremely advantageous arrangement for the recording/reproducing apparatus 101 which simultaneously reads the plurality of tracks TR which are densified, because the pattern area 23 is disposed with the simultaneously read plurality of tracks TR as one group GR.

Moreover, the servo area 22 is formed by wobbling the grooves in the guide layer 12. Thus, the recording/reproducing apparatus 101 can recognize the accurate position of the pattern area 23 (refer to FIG. 31 and FIG. 32) by using the wobble signal detected in the servo area 22, and the recording/reproducing apparatus 101 can easily generate the sample timing of the detected error signal. Particularly at this time, the cycle of the wobbles of the servo area 22 and the section of the pattern area 23 are set to have a predetermined integral ratio (refer to FIG. 8), and it is thus possible to easily generate the sample timing.

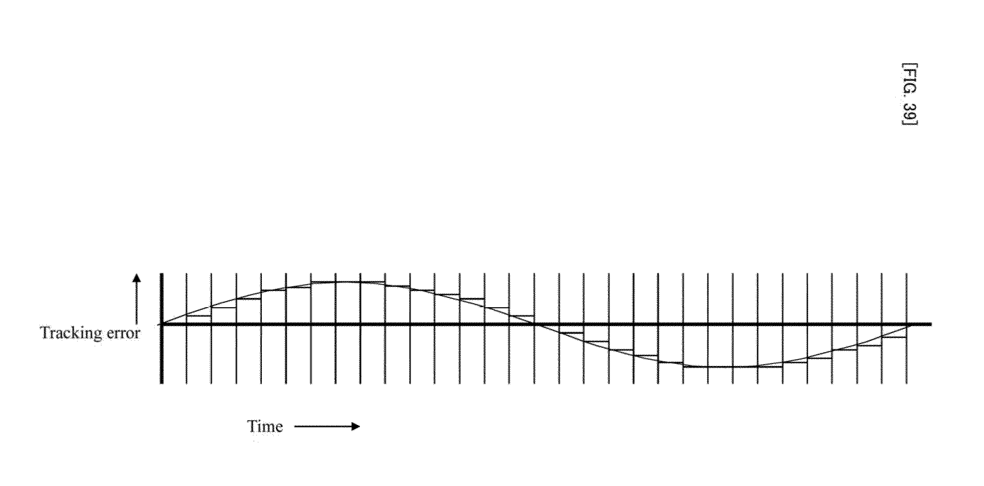

Next, with reference to FIG. 38 to FIG. 41, an explanation will be given to a method of determining the arrangement interval or the longest arrangement interval (i.e. one example of the “predetermined distance” of the present invention) of the servo areas 22 discretely arranged in the track direction by which the tracking servo can operate in the predetermined frequency band, together with a tracking servo system.

As illustrated in FIG. 38, the tracking servo system includes: an error detector 301 including a subtractor; a sampler 302 including a sampling switch, a capacitor, and a buffer; an amplifier and equalizer 303; and an actuator 304.

In the error detector 301, a disturbance for the tracking servo is inputted, and a feedback signal from the actuator 304 is subtracted (minus added), and a subtracted signal is outputted. The subtracted signal from the error detector 301 is inputted to the sampler 302.

The sampler 302 is configured as a so-called “zero-order hold circuit” for holding a sample value. Specifically, there are provided: the sampling switch which is configured to close at sampling timing; the capacitor for holing it; and the buffer. In the sampler 302, the subtracted signal is sampled by the sampling switch at sampling timing according to a frequency band for operating the tracking serve, is further held by the capacitor, and is buffered by the buffer. The sampling timing is generated by a mark signal, such as, for example, the wobble signal and the pre-pit signal, detected by the light receiving element for receiving the first beam LB1. Incidentally, a method of generating the sampling timing is not limited to this, and the sampling timing may be generated in accordance with a medium configuration in a modified example or the like described later. Moreover, the configuration of the sampler 302 is also not limited to this and may be a “first-order hold circuit” or the like.

The buffer output from the sampler 302 as sampled above is amplified and equalized by the amplifier and equalizer 303 and is further inputted to the actuator 304.

In accordance with the inputted amplified signal, the irradiation position of the first beam LB1 on the guide layer 12 (therefore, the irradiation position of the second beam LB2 on one recording layer 13) provided in the optical pickup 102 is moved in the radial direction by the actuator 304. From the actuator 304, the feedback signal according to the variation thereof is fed back to the error detector 301.

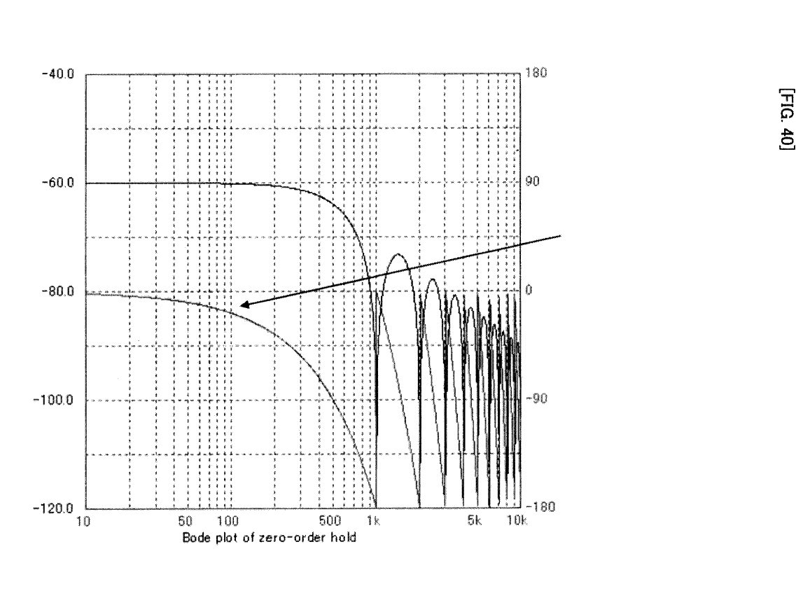

Now, in particular, with reference to FIG. 39 to FIG. 41, consideration is given to the sampling timing of the sampler 302.

FIG. 39 schematically illustrated the operation output of the sampler 302 in cases where the eccentric component changes, which is the maximum disturbance element inputted to the error detector 301. From FIG. 39, it is seen that the tracking error waves from a plus side to a minus side at a substantially constant frequency with respect to time.

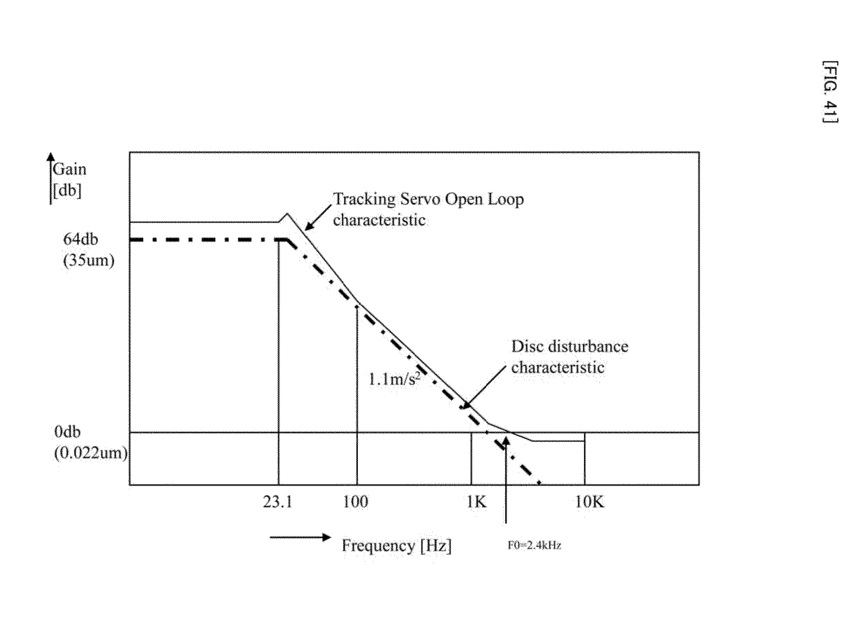

FIG. 40 illustrates a Bode line map of transfer function in cases where “zero-order hold” is performed by the sampler 302, i.e. illustrates Bode Plot of zero-order hold. In other words, here, frequency characteristics of the zero-order hold are illustrated, and in particular, a gain characteristic (a characteristic curve on the upper side) and phase (a characteristic curve on the lower side) are illustrated together in the Bode plot. In this example, the case of sampling at 1 ms; however, in reality, the sampling is performed at much shorted intervals.

From FIG. 40, regarding the phase characteristic, it is seen that in the case of 1 KHz sampling, the phase rotates by several degrees, as illustrated in a characteristic curve portion 1001 in the phase, in the signal at 100 Hz. On the other hand, it can be also said that if a band in which the phase rotation can be ignored is 100 Hz, a sample interval of about 10 times (1 KHz) or more is required (i.e. the sampling at a higher frequency than 1 KHz is required).

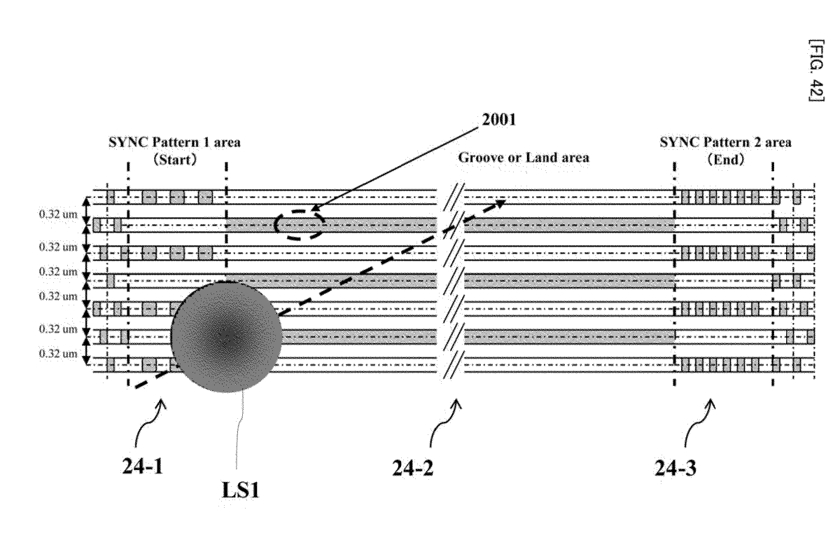

FIG. 41 illustrates an example of a disc disturbance characteristic and a tracking servo open loop characteristic, regarding the tracking servo. In this example, the “disc (i.e. optical disc 11) disturbance characteristic” has an eccentric component of 35 μm on one side until a frequency of 23.1 Hz and is 1.1 m/S² in an acceleration region. In other words, the disc disturbance is almost flat at 64 db corresponding to 35 μm in the characteristic diagram until the frequency of 23.1 Hz and decreases with a slope of 1.1 m/S² to 0 dB corresponding to 0.022 μm on a higher frequency side than the frequency of 23.1 Hz. The tracking servo open loop characteristic is illustrated as a characteristic example capable of suppressing the disc disturbance as described above. In other words, in the characteristic diagram, it is set such that the open loop characteristic is on a higher gain side at any frequency, which makes it possible to suppress the disturbance in any frequency band. Incidentally, this example is illustrated with f0 (cutoff band)=2.4 KHz.

In the case of this example explained with reference to FIG. 39 to FIG. 41, the “predetermined distance” is determined as follows.

That is, if a tracking servo band is set to, for example, 2.4 KHz, a time interval T is obtained as T=1/(24×10³)=46.7 [μsec] corresponding to 24 kHz which is about 10 times in order to ignore an influence by the sampler 302 realized as the hold circuit described above. From a relation between the time interval T and a rotational linear velocity by the spindle motor 104, the longest distance required as the arrangement interval or the arrangement pitch (refer to FIG. 9) of the two servo areas 22 discretely arranged in tandem in the track direction, i.e. one example of the “predetermined distance” of the present invention, is determined.

For example, if a linear velocity v is set to 4.917 m/sec, a predetermined distance L is obtained as L=v×T≈230 [μsec]. In other words, if one servo area 22 is put in five slots along the track TR, a slot configuration is determined such that the length of the five slots is shorter than 230 [μm], or how many slots are used to put one servo area 22 is determined.

Incidentally, the method of determining the arrangement interval (i.e. arrangement pitch) of the servo areas 22 is not limited to this example, and the arrangement interval may be determined in view of the servo band required as illustrated in FIG. 40 and FIG. 41, the linear velocity in the zone CAV method of the optical disc 11, or the like.

### Various Modified Examples

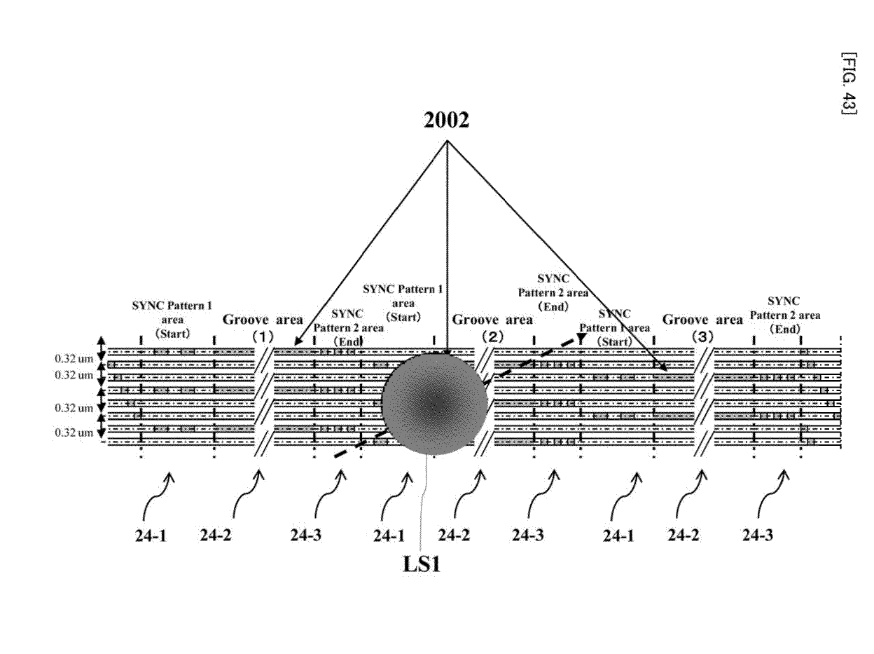

Hereinafter, various modified examples of the example will be explained with reference to FIG. 42 to FIG. 47.

FIG. 42 illustrates a modified example of the specific area 24 of the optical disc 11 in the example described above. FIG. 42 is a schematic perspective view having the same concept as in FIG. 10 illustrating the specific area 24 in the modified example.

In FIG. 42, the modified example adopts a configuration in which there is a land area between the first SYNC pattern area 24-1 and the second SYNC pattern area 24-3. The modified example also adopts a configuration in which a groove area (a portion 2001, etc. in the drawing) on the tracks in which neither the first SYNC pattern area 24-1 nor the second SYNC pattern area 24-3 does not exist.

According to the modified example, firstly, if the first SYNC pattern is detected in the state in which the tracking servo is closed, the following area is expected to be the land area. Thus, in order to perform the tracking servo on the lands, polarity of the tracking servo may be reversed in comparison with the case of the example described above (refer to FIG. 10). At this time, if the first SYNC pattern is detected by using the push-pull signal and the mirror surface is detected by using the RF signal, the following area is expected to be the groove area. Thus, in order to perform the tracking servo on the grooves, in the same manner, the polarity of the tracking servo may be reversed in comparison with the case of the example described above (refer to FIG. 10).

Next, if the tracking servo is open, as in the case of the example described above (refer to FIG. 10), the track cross signal can be detected.

As described above, even in the modified example, basically, the same effect as in the case of the example described above (refer to FIG. 10) can be obtained.

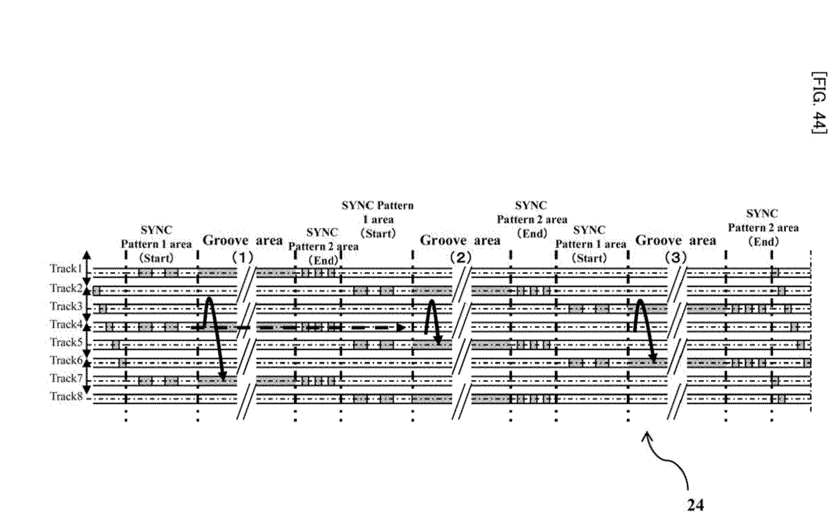

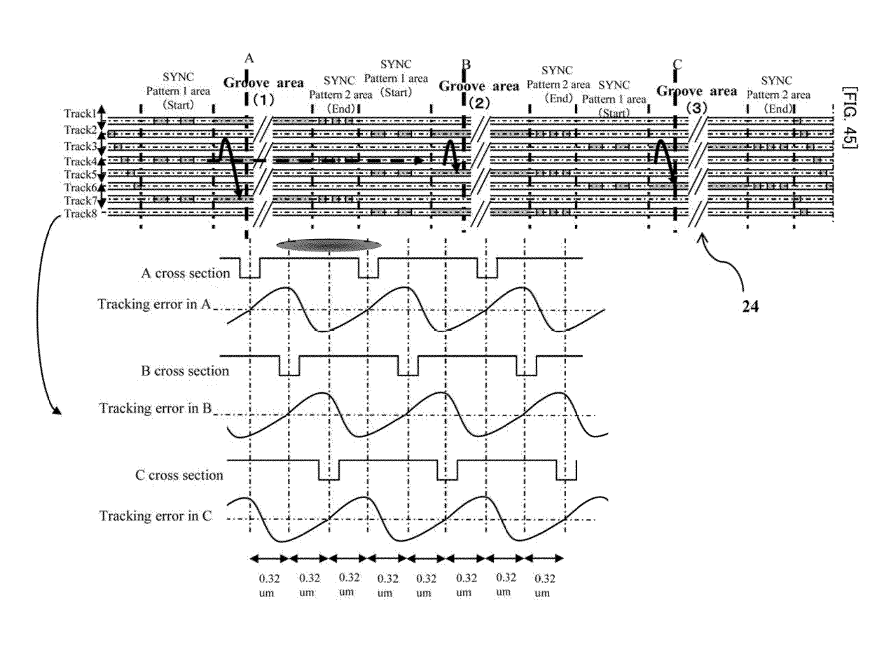

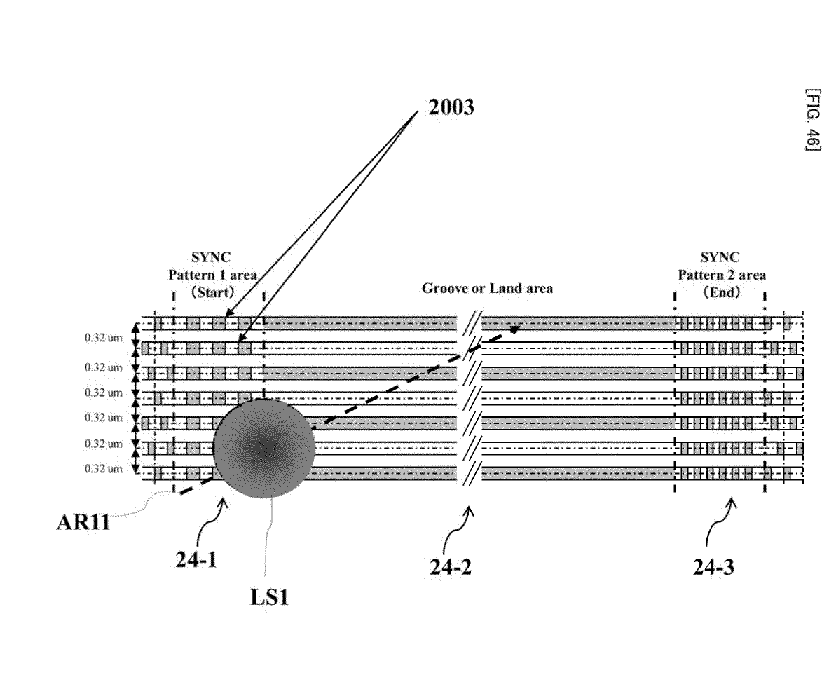

FIG. 43 illustrates a modified example of the specific area 24 of the optical disc 11 in the example described above. FIG. 43 is a schematic perspective view having the same concept as in FIG. 10 illustrating the specific area 24 in the modified example. FIG. 44 is a schematic diagram illustrating the track jump performed in the modified example by using thick arrows. FIG. 45 is a schematic characteristic diagram illustrating the tracking error signal in three cross sections (A cross section, B cross section, and C cross section) corresponding to the track jump.

In FIG. 43, the modified example is an example in which the beam size, i.e. the diameter of the light spot LS1, is not changed but the data to be recorded into the recording layer 13 is densified and the track pitch is narrowed.

In FIG. 43, the first SYNC pattern area 24-1, the body area 24-2, and the second SYNC pattern area 24-3 are arranged in every three tracks, and there is provided a land configuration therebetween.

Moreover, the first SYNC pattern area 24-1, the body area 24-2, and the second SYNC pattern area 24-3 are sequentially arranged, not to overlap one another on adjacent three tracks.

According to the modified example, as illustrated in FIG. 44 and FIG. 45, firstly, when the track jump is performed to a desired track in the state in which the tracking servo is closed, if the track jump is performed from a current track “Track 4” to a track “Track 5”, a kick addition and trace operation is performed in a “groove area (2)” as illustrated by the thick arrow in the middle. Alternatively, in the case of a jump to a track “Track 6”, the kick addition and trace operation is performed in a “groove area (3)” as illustrated by the thick arrow on the right side. Alternatively, in the case of a jump to a track “Track 7”, the kick addition and trace operation is performed in a “groove area (1)” as illustrated by the thick arrow on the left side. In any case, as is clear from FIG. 45, the tracking error signal having a suitable amplitude is obtained in the A cross section, the B cross section, and the C cross section, and the kick addition and track operation can be easily performed by using the specific area 24.

Next, if the tracking servo is open, the track cross signal can be detected and the pull-in operation is facilitated, and the purpose can be thus achieved. The track in which the tracking servo can be actually closed is slightly restricted or limited in comparison with the example; however, there is no practical problem.

As described above, even in the modified example, basically, the same effect as in the case of the example described above (refer to FIG. 10) can be obtained. In particular, regarding the track jump, it is possible to ensure an area which allows an easy jump to the desired track.

FIG. 46 illustrates a modified example of the specific area 24 of the optical disc 11 in the example described above. FIG. 42 is a schematic perspective view having the same concept as in FIG. 10 illustrating the specific area 24 in the modified example.

In FIG. 42, the modified example is an example in which the first SYNC pattern area 24-1 and the second SYNC pattern area 24-3 are provided in all the tracks in phase.

According to the modified example, substantially, in addition to the same effect as in the case of the example described above (refer to FIG. 10), there is obtained such an advantage that a signal to noise (S/N) ratio improves when the first SYNC pattern and the second SYNC pattern are detected. In this case, however, as illustrated by arrows 2003, it is hardly possible to recognize whether the track that is being followed or tracked is followed by the groove or the land after the first SYNC pattern area 24-1.

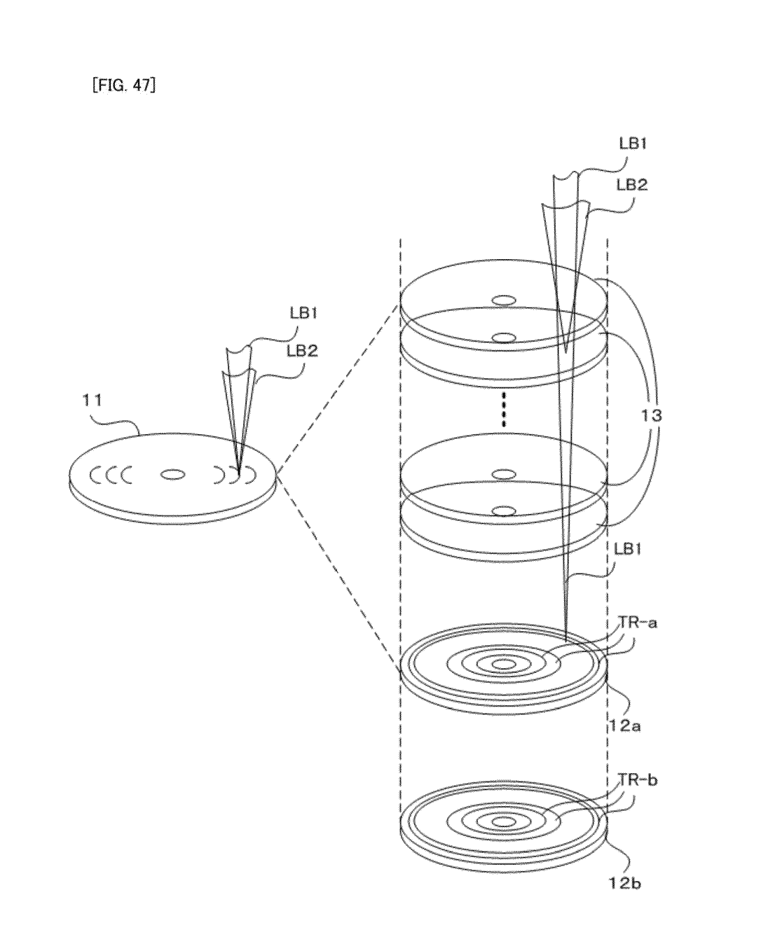

Next, FIG. 47 illustrates a modified example of the basic layer configuration of the optical disc in the example described above (refer to FIG. 1 and FIG. 2). FIG. 47 is a schematic perspective view having the same concept as in FIG. 1 illustrating the optical disc in the modified example.

In FIG. 47, in the modified example of the optical disc 11, two guide layers 12a and 12b are provided. For example, a track TR-a of the guide layer 12a is configured to carry first address information for indicating an address position directed from the inner circumference to the outer circumference. A track TR-b of the guide layer 12b is configured to carry second address information for indicating an address position directed from the outer circumference to the inner circumference. In this case, moreover, even the recording layers 13 are properly used as a first recording layer recorded in accordance with the first address information and a second recording layer recorded in accordance with the second address information, and guidance for the first recording layer is performed by using the guide layer 12a and guidance for the second recording layer is performed by using the guide layer 12b. By virtue of such a configuration, it is possible to make efficient or easy operation of recording information from the inner circumference to the outer circumference in one or a plurality of first recording layers and of recording information from the outer circumference to the inner circumference in one or a plurality of second recording layers. Moreover, reliability and stability of the recording operation can be significantly increased by properly using the two types of address information. Thus, it is possible to realize the optical disc 11 which allows the recording continuously bi-directionally, or arbitrarily or independently bi-directionally.

For example, if it is set to perform the recording and reproduction from the inner circumference to the outer circumference in the first layer of the recording layers and to perform the recording and reproduction from the outer circumference to the inner circumference in the second layer of the recording layers, then, a time to change the recording and reproduction between the two layers is almost a time to perform a layer jump. Thus, it is extremely useful in the recording and reproduction which are continuously performed by straddling the plurality of recording layers. In other words, it is possible to obtain the same effect as that of so-called “opposite recording” or “opposite reproduction” in a dual-layer disc. That is, if the data that is continuous in real time such as video data is recorded as the data to be recorded, by using the optical disc 11 in the modified example, then, it takes the time for the layer jump, to reach from the end of the first recording layer to the start of the second recording layer, in the reproduction. This is extremely useful in view of the layer jump and a time for returning the position of the optical pickup 102 from the outer circumference to the inner circumference, which is further added in the case of the example illustrated in FIG. 1. In the case of the example illustrated in FIG. 1, in order to seamlessly reproduce the data, the recording/reproducing apparatus 101 may be provided with a large amount of memory.

As described above, by using the modified example in FIG. 47 at the same time, continuous reproduction becomes possible on the reproducing apparatus, inexpensively and easily.

As explained above in detail, according to the example and the modified examples, the arrangement interval (arrangement pitch) of the servo areas 22 along the tracks TR is set to be less than or equal to the predetermined distance, and moreover, the servo areas 22 are (discretely) arranged on the entire surface of the optical disc 11. Thus, the continuous tracking signal can be obtained by the sampling at any position from the inner circumference to the outer circumference of the optical disc 11 in the guide layer 12.

In addition, one cycle of wobble WB and the constituent unit of the data format in one recording layer 13 have an integral multiple relation, and the slots are configured as an integral multiple of the one cycle of wobble WB, and the servo area 22 corresponds to this section. This facilitates the appropriate arrangement not to overlap the servo areas 22 on the adjacent tracks TR (i.e. not to cause the crosstalk in the wobble signal and the pre-pit signal). The wobble signal obtained in this manner can be used as the generation of a timing reference signal excellent in robust, or the generation of a timing signal at the start of the recording, via a phase locked loop (PLL) circuit.

Moreover, the present invention is not limited to the aforementioned embodiment, but various changes may be made, if desired, without departing from the essence or spirit of the invention which can be read from the claims and the entire specification. An information recording medium, an information recording apparatus and method, and an information reproducing apparatus and method, which involve such changes, are also intended to be within the technical scope of the present invention.

### DESCRIPTION OF REFERENCE CODES

11 optical disc
12 guide layer
13 recording layer
21 mirror-surface area
22 servo area (mark area)
23 pattern area
24 specific area
24-1 first SYNC pattern area
24-2 body area
24-3 second SYNC pattern area
TR track
WB wobble
LLP1 land pre-pit
LB1 first beam
LB2 second beam
102 optical pickup
102L objective lens
101 recording/reproducing apparatus
201 host computer

1. An information recording medium comprising:
a guide layer in which concentric or spiral tracks are formed in advance; and
a plurality of recording layers laminated on said guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open.

2. The information recording medium according to claim 1, wherein the predetermined pattern is physically formed in said guide layer by combining grooves and lands in a predetermined rule.

3. The information recording medium according to claim 2, wherein the predetermined pattern has at least one of a wobble and pre-pit structure and a wobble and partial notch structure.

4. The information recording medium according to claim 2, wherein the predetermined pattern comprises (i) a first SYNC pattern, (ii) a body portion having a combination of the grooves and the lands according to the predetermined rule, and (iii) a second SYNC pattern which is different from the first SYNC pattern, which are arranged along the track direction.

5. The information recording medium according to claim 4, wherein
the first SYNC pattern is defined to detect a presence of the body portion in response to detection of the first SYNC pattern, and
the second SYNC pattern is defined to detect an end of the body portion in response to detection of the second SYNC pattern.

6. The information recording medium according to claim 1, wherein
said information recording medium adopts a zone CAV method, and
the tracks are concentric or spiral.

7. The information recording medium according to claim 1, wherein each of the plurality of specific areas is disposed at a position corresponding to immediately before a portion in which arrangement of ECCs of data to be recorded into each of said recording layers is aligned in the radial direction.

8. The information recording medium according to claim 1, wherein the guide information includes at least one of first recording address information directed from an inner circumference to an outer circumference in the track direction, and second recording address information directed from the outer circumference to the inner circumference.

9. The information recording medium according to claim 1, wherein
the tracks are guide tracks for tracking servo,
the physical structure allows generation of a signal for the tracking servo which constitutes at least one portion of the guide information,
each of the plurality of guide areas is a servo area for generating the signal for the tracking servo,
the predetermined distance is set in advance to a distance in which the tracking servo can operate in a predetermined band, and
the plurality of servo areas are arranged such that the plurality of servo areas are shifted between the plurality of tracks so as not to be irradiated with a light beam simultaneously, on the basis of a diameter of the light beam for the tracking servo.

10. An information recording apparatus for recording data onto an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information recording apparatus comprising:
a light irradiating device capable of irradiating and focusing a first light beam for tracking on the guide layer and capable of irradiating and focusing a second light beam for data recording on one recording layer out of the plurality of recording layers;
an information obtaining device for receiving first light based on the irradiated and focused first light beam from the guide layer, and detecting the predetermined pattern and obtaining the carried guide information on the basis of the received first light;
a first pull-in controlling device for controlling start or continuation of a pull-in operation of pulling in the tracking servo on the basis of one type of the detected predetermined pattern in the plurality of specific areas in the state in which the tracking servo is open;
a second pull-in controlling device for controlling continuation or end of the pull-in operation on the basis of another type of the detected predetermined pattern in the plurality of specific areas in the state in which the tracking servo is open or is being pulled in;
a tracking servo device for controlling said light irradiating device to perform the tracking servo on a desired track out of the plurality of tracks on the basis of the obtained guide information; and
a data recording control device for controlling said light irradiating device to record the data by irradiating and focusing the second light beam on the one recording layer in a servo-closed state in which the tracking servo is performed.

11. An information recording apparatus for recording data onto an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information recording apparatus comprising:
a light irradiating device capable of irradiating and focusing a first light beam for tracking on the guide layer and capable of irradiating and focusing a second light beam for data recording on one recording layer out of the plurality of recording layers;
an information obtaining device for receiving first light based on the irradiated and focused first light beam from the guide layer, and detecting the predetermined pattern and obtaining the carried guide information on the basis of the received first light;
a jump controlling device for controlling a track jump associated with the tracks on the basis of one type of the detected predetermined pattern in the plurality of specific areas in a servo-closed state in which the tracking servo is performed; and
a data recording control device for controlling said light irradiating device to record the data by searching for a desired position on the plurality of tracks on the basis of the obtained guide information when the track jump is performed and by irradiating and focusing the second light beam on the one recording layer in the servo-closed state.

12. An information recording method of recording data onto an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information recording method recording the data by using a light irradiating device capable of irradiating and focusing a first light beam for tracking on the guide layer and capable of irradiating and focusing a second light beam for data recording on one recording layer out of the plurality of recording layers,
said information recording method comprising:
an information obtaining process of receiving first light based on the irradiated and focused first light beam from the guide layer, and detecting the predetermined pattern and obtaining the carried guide information on the basis of the received first light;
a first pull-in controlling process of controlling start or continuation of a pull-in operation of pulling in the tracking servo on the basis of one type of the detected predetermined pattern in the plurality of specific areas in the state in which the tracking servo is open;
a second pull-in controlling process of controlling continuation or end of the pull-in operation on the basis of another type of the detected predetermined pattern in the plurality of specific areas in the state in which the tracking servo is open or is being pulled in;
a tracking servo process of controlling said light irradiating device to perform the tracking servo on a desired track out of the plurality of tracks on the basis of the obtained guide information; and
a data recording control process of controlling said light irradiating device to record the data by irradiating and focusing the second light beam on the one recording layer in a servo-closed state in which the tracking servo is performed.

13. An information recording method of recording data onto an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
the information recording method recording the data by using a light irradiating device capable of irradiating and focusing a first light beam for tracking on the guide layer and capable of irradiating and focusing a second light beam for data recording on one recording layer out of the plurality of recording layers,
said information recording method comprising:
an information obtaining process of receiving first light based on the irradiated and focused first light beam from the guide layer, and detecting the predetermined pattern and obtaining the carried guide information on the basis of the received first light;
a jump controlling process of controlling a track jump associated with the tracks on the basis of one type of the detected predetermined pattern in the plurality of specific areas in a servo-closed state in which the tracking servo is performed; and
a data recording control process of controlling said light irradiating device to record the data by searching for a desired position on the plurality of tracks on the basis of the obtained guide information when the track jump is performed and by irradiating and focusing the second light beam on the one recording layer in the servo-closed state.

14. An information reproducing apparatus for reproducing data from an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information reproducing apparatus comprising:
a light irradiating device capable of irradiating and focusing a first light beam for tracking on the guide layer and capable of irradiating and focusing a second light beam for data reproduction on one recording layer out of the plurality of recording layers;
an information obtaining device for receiving first light based on the irradiated and focused first light beam from the guide layer, and detecting the predetermined pattern and obtaining the carried guide information on the basis of the received first light;
a first pull-in controlling device for controlling start or continuation of a pull-in operation of pulling in the tracking servo on the basis of one type of the detected predetermined pattern in the plurality of specific areas in the state in which the tracking servo is open;
a second pull-in controlling device for controlling continuation or end of the pull-in operation on the basis of another type of the detected predetermined pattern in the plurality of specific areas in the state in which the tracking servo is open or is being pulled in;
a tracking servo device for controlling said light irradiating device to perform the tracking servo on a desired track out of the plurality of tracks on the basis of the obtained guide information; and
a data obtaining device for receiving second light based on the irradiated and focused second light beam from the one recording layer and obtaining the data on the basis of the received second light in a servo-closed state in which the tracking servo is performed.

15. An information reproducing apparatus for reproducing data from an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information reproducing apparatus comprising:
a light irradiating device capable of irradiating and focusing a first light beam for tracking on the guide layer and capable of irradiating and focusing a second light beam for data reproduction on one recording layer out of the plurality of recording layers;
an information obtaining device for receiving first light based on the irradiated and focused first light beam from the guide layer, and detecting the predetermined pattern and obtaining the carried guide information on the basis of the received first light;
a jump controlling device for controlling a track jump associated with the tracks on the basis of one type of the detected predetermined pattern in the plurality of specific areas in a servo-closed state in which the tracking servo is performed; and
a data obtaining device for searching for a desired position on the plurality of tracks on the basis of the obtained guide information when the track jump is performed, receiving second light based on the irradiated and focused second light beam from the one recording layer, and obtaining the data on the basis of the received second light in the servo-closed state.

16. An information reproducing method of reproducing data from an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information reproducing method reproducing the data by using a light irradiating device capable of irradiating and focusing a first light beam for tracking on the guide layer and capable of irradiating and focusing a second light beam for data reproduction on one recording layer out of the plurality of recording layers,
said information reproducing method comprising:
an information obtaining process of receiving first light based on the irradiated and focused first light beam from the guide layer, and detecting the predetermined pattern and obtaining the carried guide information on the basis of the received first light;
a first pull-in controlling process of controlling start or continuation of a pull-in operation of pulling in the tracking servo on the basis of one type of the detected predetermined pattern in the plurality of specific areas in the state in which the tracking servo is open;
a second pull-in controlling process of controlling continuation or end of the pull-in operation on the basis of another type of the detected predetermined pattern in the plurality of specific areas in the state in which the tracking servo is open or is being pulled in;
a tracking servo process of controlling said light irradiating device to perform the tracking servo on a desired track out of the plurality of tracks on the basis of the obtained guide information; and
a data obtaining process of receiving second light based on the irradiated and focused second light beam from the one recording layer and obtaining the data on the basis of the received second light in a servo-closed state in which the tracking servo is performed.

17. An information reproducing method of reproducing data from an information recording medium,
the information recording medium comprising:
a guide layer in which concentric or spiral tracks are formed in advance; and
a plurality of recording layers laminated on the guide layer, wherein
on the tracks, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and (ii) a plurality of specific areas, each of which has a predetermined pattern, are respectively arranged in a same phase from an inner circumference to an outer circumference in the radial direction such that the predetermined pattern can be detected in a state in which tracking servo is open,
said information reproducing method reproducing the data by using a light irradiating device capable of irradiating and focusing a first light beam for tracking on the guide layer and capable of irradiating and focusing a second light beam for data reproduction on one recording layer out of the plurality of recording layers,
said information reproducing method comprising:
an information obtaining process of receiving first light based on the irradiated and focused first light beam from the guide layer, and detecting the predetermined pattern and obtaining the carried guide information on the basis of the received first light;
a jump controlling process of controlling a track jump associated with the tracks on the basis of one type of the detected predetermined pattern in the plurality of specific areas in a servo-closed state in which the tracking servo is performed; and
a data obtaining process of searching for a desired position on the plurality of tracks on the basis of the obtained guide information when the track jump is performed, receiving second light based on the irradiated and focused second light beam from the one recording layer, and obtaining the data on the basis of the received second light in the servo-closed state.
